(19) United States
(12) Patent Application Publication
(10) Pub. No.: US 2025/0173755 A1
(43) Pub. Date: May 29, 2025

(54) SYSTEM AND METHOD OF ASSOCIATING AN OBJECT TO A SPECIFIC PRODUCT TO PROVIDE A BENEFIT TO A FIRST BUYER

(71) Applicant: Grapevine Codes LLC, Huntingtown, MD (US)

(72) Inventors: Thomas M. ISAACSON, Huntingtown, MD (US); Joshua Lyman ISAACSON, Huntingtown, MD (US); Mason Tate ISAACSON, Huntingtown, MD (US); Lucas Thomas ISAACSON, Huntingtown, MD (US)

(21) Appl. No.: 18/963,370

(22) Filed: Nov. 27, 2024

Related U.S. Application Data
(60) Provisional application No. 63/603,703, filed on Nov. 29, 2023.

(51) Int. Cl. G06Q 30/0238; G06Q 20/20; G06Q 20/32

(52) U.S. Cl. CPC G06Q 30/0238; G06Q 20/209; G06Q 20/3276; G06Q 20/3278; G06Q 2220/00

(57) ABSTRACT

A device may receive an identification of a product via a first device of a first user. A device may receive, via a biometric recognition model, an identification of a second user associated with the product. A device may determine whether a record exists in a database that determines that the second user previously purchased the product to yield a determination. When the determination indicates that the second user previously purchased the product, then the device may: offer a new product associated with the product to the first user for purchase and provide a benefit to the second user when the first user purchases the new product. A device may, when the determination does not indicate that the second user previously purchased the product, then: offer the new product to the first user for purchase without providing a benefit to the second user.

### PRIORITY CLAIM

The present application claims priority to U.S. Provisional Application No. 63/603,703, filed Nov. 29, 2023, U.S. Provisional Application No. 63/618,515, filed Jan. 8, 2024, and U.S. Provisional Application No. 63/696,039, filed Sep. 18, 2024, the contents of which are incorporated herein by reference in their entirety.

### FIELD OF THE INVENTION

The disclosure introduces a new approach to sharing and purchasing products that people love. In general, a purchasing service is used as part of an ecosystem where each product can be marked with a unique code (via a near field communication tag or a visual object like a quick response code (QR code)) and the code is used to associate the individual first buyer with a first product so marked. Then, a friend can scan the marking or code of the first product with their mobile device and buy (as a second buyer) their own product (a second product) with a benefit being provided to the first buyer automatically for encouraging the purchase of a second product by their friend.

### BACKGROUND

In the general economy, people buy products online or in person in stores. Typically, the buyer will take the product home and enjoy the product. In some cases, a friend or family member may see that same product and desire one for themselves. In that case, the friend or family member will either purchase the same product online by going to Amazon.com or a merchant website or application or go to a store and buy one for themselves.

### BRIEF SUMMARY

The present disclosure addresses weaknesses in the core aspect of our economy. Mainly, when a buyer buys a product and then later when a friend or family member (FOFM) or other person wants to buy the same product, there is no easy mechanism to give the original buyer a benefit for contributing to the second purchase of the product. This disclosure introduces an entirely new ecosystem in which products can be marked with an object that is scannable such that when the first product is purchased, the first buyer of the product is associated with the first product and the object (which can have an individual code associated with the first product). When the object is scanned by a mobile phone of a friend who can be a second buyer. The second buyer can buy their own version of the product (a second product purchased by a second buyer). Because the ecosystem stores the association between the first buyer and the first product via the object, the first buyer can automatically get a benefit such as a discount on another purchase or any type of benefit such as a rebate.

The approach can be broadened to encompass any mechanism of storing in a database a connection between the first buyer of the first product. The connection can be made at the point-of-sale, through an existing record of a transaction such as via Amazon.com, or after the sale manually by a user adding their name and identification of the product and/or their purchase of the product to a database. Later, in general, the first product can be identified via a device of a second buyer, and in some manner, the identity of the first buyer can be obtained (such as through facial recognition, a confirmation text, a scan of a visual object, or other mechanisms) and a database can be checked for whether the first buyer did buy the first product. Then the second buyer can buy a second product for themselves and based on the connection recorded in the database of the first buyer purchase of the first product, the first buyer gets some kind of benefit.

In some aspects, the techniques described herein relate to a method including: identifying a first product being purchased by a first buyer; storing an association of the first product and the first buyer in a database; receiving an identification of the first product from a second buyer device; processing a purchase of a second product by a second buyer based on the identification; and providing a benefit to the first buyer based on the purchase of the second product.

In some aspects, the techniques described herein relate to a system including: a processor; and a computer-readable memory storing instructions which, when executed by the processor, cause the processor to perform operations including: identifying a first product being purchased by a first buyer; storing an association of the first product and the first buyer in a database; receiving an identification of the first product from a second buyer device; processing a purchase of a second product by a second buyer based on the identification; and providing a benefit to the first buyer based on the purchase of the second product.

In some aspects, the techniques described herein relate to a method including: identifying a first product being purchased by a first buyer; identifying an object (e.g., a graphical object or a scannable object such as an NFC tag) specific to the first product; storing an association of the first product, the first buyer and the graphical object in a database; receiving an indication that a second buyer has received the graphical object onto a second buyer device; processing a purchase of a second product by the second buyer based on the indication; and providing a benefit to the first buyer based on the purchase of the second product.

In some aspects, the techniques described herein relate to a method including: generating a group of products wherein each respective product in the group of products is made with a respective object unique to the respective product; at a purchase of the respective product, identifying a first buyer and the respective object and storing data in a database associating the first buyer and the respective object; receiving an identification of the respective object from a second buyer device associated with a second buyer; accessing, based on the identification of the respective object from the second buyer device, the data to identify the respective product and the first buyer; processing a sale of a second product associated with the respective product to the second buyer; and automatically providing a benefit to the first buyer based on the sale of the second product.

In some aspects, the techniques described herein relate to a point-of-sale device including: a storage compartment for a set of stickers; a dispensing mechanism for dispensing stickers from the set of stickers; a printer; a processor; a computer-readable memory storing instructions which, when executed by the processor, cause the processor to perform operations including: receiving information about graphical object to be printed, the graphical object including data about a product being purchased, a buyer of the product, and data to enable automatic access to a purchasing service; printing, via the printer, the graphical object on a sticker from the set of stickers to generate a printed sticker; and dispensing, via the dispensing mechanism, the printed sticker.

In some aspects, the techniques described herein relate to a system including: a processor; and a computer-readable memory storing instructions which, when executed by the processor, cause the processor to perform operations including: identifying a first product being purchased by a first buyer; identifying an object specific to the first product; storing an association of the first product, the first buyer and the object in a database; receiving an indication that a second buyer has received the object onto a second buyer device; processing a purchase of a second product by the second buyer based on the indication; and providing a benefit to the first buyer based on the purchase of the second product.

In some aspects, the techniques described herein relate to a point-of-sale system including: a processor; a computer-readable memory storing instructions which, when executed by the processor, cause the processor to perform operations including: identifying a first buyer and a first product from a scan of an object associated with the first product to generate first buyer/first product data; transmitting the first buyer/first product data to a purchasing system to store the first buyer/product data in a database, wherein the purchasing system: receives an identification of the object from a second buyer device associated with a second buyer; accesses, based on the identification of the object from the second buyer device, the first buyer/first product data; processes a sale of a second product associated with the first product to the second buyer; and automatically provides a benefit to the first buyer based on the sale of the second product to the second buyer.

In some aspects, the techniques described herein relate to a purchasing system including: a processor; and a computer-readable memory storing instructions which, when executed by the processor, cause the processor to perform operations including: identifying an object that associates a first buyer and a first product to generate first buyer/first product data; receiving an identification of the object from a second buyer device associated with a second buyer; accessing, based on the identification of the object from the second buyer device, the first buyer/first product data; initiating a sale of a second product associated with the first product to the second buyer; and providing a benefit to the first buyer based on the sale of the second product to the second buyer.

In some aspects, the techniques described herein relate to a method including: providing via a wireless link, from a point-of-sale device and to a mobile device data identifying a merchant, wherein the data identifying the merchant is associated with an initiation of a payment process for a transaction of purchasing a product; receiving, from the mobile device and over the wireless link, payment data to pay for the product and discount data to be applied to purchasing the product, wherein the payment data and the discount data are both received over the wireless link; and applying the discount data to the transaction to generate a remainder amount for the transaction; and processing a payment of the remainder amount, if any, using the payment data.

In some aspects, the techniques described herein relate to a device including: a processor; a computer-readable memory storing instructions which, when executed by the processor, cause the processor to perform operations including: providing via a wireless link, to a mobile device data identifying a merchant, wherein the data identifying the merchant is associated with an initiation of a payment process for a transaction of purchasing a product; receiving, from the mobile device and over the wireless link, payment data to pay for the product and discount data to be applied to purchasing the product, wherein the payment data and the discount data are both received over the wireless link; and applying the discount data to the transaction to generate a remainder amount for the transaction; and processing a payment of the remainder amount, if any, using the payment data.

In some aspects, the techniques described herein relate to a method including: receiving, at a user device, an identification of a merchant via a wireless link with a point-of-sale device and in connection with an initiation of a payment over of a wireless link for a product; determining whether a discount is available for the merchant; and when a discount is available, coordinating payment data and discount data in a virtual wallet or between applications on the user device to cause final payment data sent over the wireless link to reflect the discount when paying for the product.

In some aspects, the techniques described herein relate to a method including: receiving an identification of a product via a first device of a first user; receiving, via a biometric recognition model, an identification of a second user associated with the product; determining whether a record exists in a database that determines that the second user previously purchased the product to yield a determination; when the determination indicates that the second user previously purchased the product, then: offering a new product associated with the product to the first user for purchase; providing a benefit to the second user when the first user purchases the new product; when the determination does not indicate that the second user previously purchased the product, then: offering the new product to the first user for purchase without providing a benefit to the second user.

In some aspects, the techniques described herein relate to a system including: at least one processor; and a computer-readable storage device storing instructions which, when executed by the at least one processor, cause the system to be configured to: receive an identification of a product via a first device of a first user; receive, via a biometric recognition model, an identification of a second user associated with the product; determine whether a record exists in a database that determines that the second user previously purchased the product to yield a determination; when the determination indicates that the second user previously purchased the product, then: offer a new product associated with the product to the first user for purchase; provide a benefit to the second user when the first user purchases the new product; when the determination does not indicate that the second user previously purchased the product, then: offer the new product to the first user for purchase without providing a benefit to the second user.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE SEVERAL VIEWS OF THE DRAWINGS

The accompanying drawings are presented to aid in the description of various aspects of the disclosure and are provided solely for illustration of the aspects and not limitation thereof.

FIG. 1 illustrates an ecosystem for managing purchases of products from a product initially bought by another person, in accordance with some aspects of this disclosure;

FIG. 2 illustrates a point-of-sale device, in accordance with some aspects of this disclosure;

FIG. 3 illustrates the use of a purchasing service, in accordance with some aspects of this disclosure;

FIG. 4 illustrates a product manufacturing operation, in accordance with some aspects of this disclosure;

FIG. 5A illustrates a wallet or application for managing purchases, in accordance with some aspects of this disclosure;

FIG. 5B illustrates a method of processing product purchases, in accordance with some aspects of this disclosure;

FIG. 5C illustrates redeeming a benefit at a time of a purchase, in accordance with some aspects of this disclosure;

FIG. 5D illustrates the use of a product wallet, in accordance with some aspects of this disclosure;

FIG. 5E illustrates a user interface to use at a point-of-sale, in accordance with some aspects of this disclosure;

FIG. 6A illustrates a method of providing a benefit to a first buyer, in accordance with some aspects of this disclosure;

FIG. 6B illustrates a method of providing a benefit to a buyer of a product, in accordance with some aspects of this disclosure;

FIG. 6C illustrates a method of sending objects to a first buyer device based on a purchase of a product, in accordance with some aspects of this disclosure;

FIG. 6D illustrates a method of granting a benefit to a buyer of a product, in accordance with some aspects of this disclosure;

FIG. 6E illustrates a method of transmitting a payment token to a merchant server, in accordance with some aspects of this disclosure;

FIG. 7A illustrates an ecosystem of businesses and services, in accordance with some aspects of this disclosure;

FIG. 7B illustrates a method for providing a benefit to a buyer of a product, in accordance with some aspects of this disclosure;

FIG. 7C illustrates a method of using a code management service, in accordance with some aspects of this disclosure;

FIG. 7D illustrates aa method of providing a buyer of a product on a social media platform a benefit, in accordance with some aspects of this disclosure;

FIG. 8A illustrates a method of providing a benefit to a buyer of a product, in accordance with some aspects of this disclosure;

FIG. 8B illustrates a method of providing a benefit to a buyer of a product, in accordance with some aspects of this disclosure;

FIG. 8C illustrates a method of providing a benefit to a buyer, in accordance with some aspects of this disclosure;

FIG. 8D illustrates another method of providing a benefit to a buyer, in accordance with some aspects of this disclosure;

FIG. 9A illustrates a method of monitoring purchases for a buyer who has received a benefit, in accordance with some aspects of this disclosure;

FIG. 9B illustrates a method of using facial recognition to recognize the first buyer;

FIG. 10A illustrates a checkout flow, according to aspects of the disclosure;

FIG. 10B illustrates a checkout flow, according to aspects of the disclosure;

FIG. 10C illustrates a checkout flow with user feedback, according to aspects of the disclosure;

FIG. 10D illustrates a method of jumping out of and back into a checkout flow with user feedback, according to aspects of the disclosure;

FIG. 10E illustrates a method of providing a checkout flow, according to aspects of the disclosure;

FIG. 10F illustrates another method of providing a checkout flow, according to aspects of the disclosure;

FIG. 10G illustrates another method of providing a checkout flow, according to aspects of the disclosure;

FIG. 10H illustrates a method of providing a service based on a service request, according to some aspects of this disclosure; and

FIG. 11 illustrates a computing system, in accordance with some aspects of this disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

What is needed in the art is an entirely new infrastructure that encourages each person who buys a product to turn around and be a salesman for that product. The infrastructure disclosed herein achieves that goal and introduces a new incentive for each person who loves a particular product to be granted a benefit if a friend or family member (FOFM) buys the same product based on their influence. There are a number of different examples of how to first establish and record in a database a connection between the first buyer of a product and then later to identify the first product, and the first buyer and confirm in the database that there is a record of the purchase of the first product by the first buyer, and then to enable a second buyer to buy their own product (the second product) and provide a benefit to the first buyer because they were the means by which the second buyer bought the second product. Any example or any embodiment can have one of more features that can be mixed with any other one or more features of any other example or embodiment. It is contemplated that any individual feature is available for use in connection with any other feature no matter which example discusses a respective feature.

Various examples can include or be claimed as devices, applications configured on a mobile device or on a point-of-sale device, a desktop computer or any other computing device. For example, the processes disclosed here as performed by an application on a mobile device can be claimed. Separately, processed performed by a website, or a payment service, or a merchant device at a point of sale or a combination of different merchant devices (like a POS device for Apple Pay, and a QR code scanner, and/or another merchant device) can be the subject of separate claims for their respective operations. Methods, systems and computer-readable media can each be the subject of a claim. In some cases, where a method is described as being performed by a mobile device, for example, a complementary method is considered disclosed as being performed by another device in wireless communication with the mobile device. The first example discussed next relates to the use of a scannable code to establish the connection between a buyer and a product.

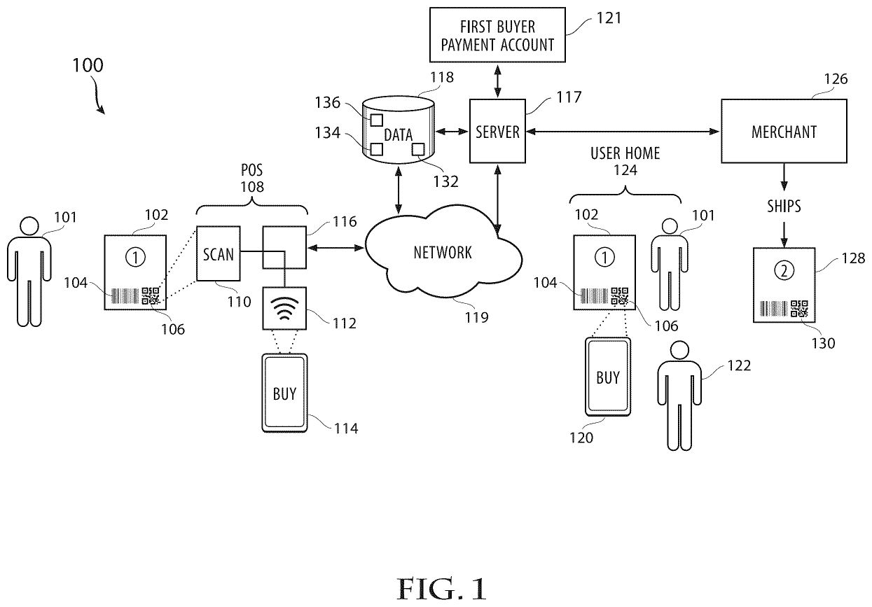

FIG. 1 illustrates an influencer benefit system 100 that includes a point-of-sale 108 where a first buyer 101 buys a first product 102 that has a universal product code (UPC) symbol 104 and an object 106. When the user 101 buys the product, they can use a credit/debit car, Apple Pay, Google Pay, Samsung Pay or any other payment mechanism (such as a digital wallet or cryptocurrency) using a first buyer device 114 at a point-of-sale device 112. A salesperson or the first buyer 101 scans the UPC symbol 104 using a point-of-sale scanner 110 at a point-of-sale location or POS 108. The POS 108 can represent any one or more devices used at the point-of-sale to grant discounts through quick response code (QR code) scanning, or receiving payments through near-field communication links, etc. The point-of-sale scanner 110 can scan both the UPC symbol 104 and the object 106. In another aspect, a point-of-sale system can include on near-field communication (NFC) device that is used to receive payments for Apple Pay or Google Pay, etc., which can be configured to be in a state to scan a near field communication tag or chip associated with a product. The POS 108 can also include a visual scanner that can also be placed in a state of scanning a visual object. These existing point-of-sale devices can be reprogrammed to accomplish the association of the first buyer 101 with the first product 102 at the POS 108.

In some cases, just by using a payment process or merchant such as Amazon, a purchase such as pair of shoes by Joe can be connected in the database 118 to the shoes. This can occur without a specialized visual code on the product but can simply occur at the time of sale where the product is connected to the buyer in a database. As outlined herein, the database can then be coordinated with social media network of a second buyer when the second buyer might perform a scan of the product or even select the product say on Amazon (which can also occur because their friend previously bought the first product 102) independent of a visual scan of a code or a product. The connection between the first buyer 102, the first product 102 can therefore occur through a number of different ways after the first product 102 is purchased as long as the database record in the database 118 is established. Later, when the first product 102 is chosen (like on Amazon), or scanned by a second buyer's phone 120, then an API call or other access to the database 118 can occur to determine the connection. Then, when the purchase is made, the first buyer 101 receives a benefit for their support or help in the second buyer 122 buying their own version of the first product 102.

As noted above for Amazon, they already know who has purchased the product given their account for each Amazon user. Thus, Amazon's existing data that links purchasers to the products they have purchased could include an extension of that database to the concepts disclosed herein where whether via a physical object, biometric or facial recognition, visual scanning of the product purchased by the first buyer, or other means, once the user's name is identified, a database access could occur in which an Amazon account could be checked to see if that person bought the product scanned and if so, then the second purchaser, buying their own product, can cause a benefit to be given to the first purchaser for their next Amazon purchase or for a purchase from the same merchant or manufacturer of the first product.

In one aspect, an updated UPC symbol 104 can include data that indicates or causes the POS 108, upon scanning the UPC symbol 104, to initiate a “product association process” or one or more steps needs to be taken to scan the object (electronically or visually) associated with the first product 102 to establish the association with the first buyer 101. For example, an NFC device can be placed in a state to receive a scan of an NFC tag on a product as instructed via a user interface for a clerk or person at a self check-out stand. Then the NFC device may be returned or placed in a later state to receive a payment via interaction with the first buyer device 121. Similarly, a scanner can be placed in a state to scan a visual object on the first product 102 and then later placed in a state to scan for a discount code.

If the user uses cash, then a graphical interface can be presented to a salesperson to enter in their personal information if desired. Data can also be inputted automatically using software stored on 114 such as an app or asset in the digital wallet, the information can be automatically inputted at the POS 108. By scanning the object 106 and obtaining payment data for the user, a database record can be made by a store server 116 that can be transmitted via a network 119 to a database 118 and/or a purchasing service 117 operating on a network-based server. The purchasing service 117 manages the association between the first buyer 101 and the first product 102 in the context of later purchases of the product by other buyers. Note that other buyers will not literally buy the very same product as the first buyer 101 but will typically buy their own product or a similar product prompted by their experience with the first product 102.

In one example, the first buyer 101 will register a payment account to yield a registered payment account 136 stored in the database 118 of the purchasing service 117 which identifies a first buyer payment account 121 in order to enable the processes disclosed herein. For example, once the purchasing service 117 has the record of the first buyer payment account 121, then the purchasing service 117 can monitor purchases of the first buyer 101 using that first buyer payment account 121 to grant (where applicable) the benefit such as a discount the next time the user makes a purchase at the merchant. In some aspects, the purchasing service 117 can establish a “policy” in which the first buyer 101, the merchant and any other data can be established for automatic monitoring of the first buyer 101 purchases such that when the first buyer 101 makes a purchase at the same merchant that sold the first product 101, a discount or some benefit is provided, such as a rebate back to their account or some other benefit.

Note that as used herein, the object 106 can also be broad to encompass a graphical object such as a UPC symbol, an NFC tag, a QR code or similar type of code or any object that can transmit or transfer data to the second buyer device 120. For example, a near field communication (NFC) chip or tag on the product could be scanned when near the second buyer device 120 that can transfer the necessary data as disclosed herein to enable the second buyer 122 to purchase the second product 128.

There are a number of different ways in which the association of the first buyer 101 and the first product 102 product can be made. For example, the first buyer device 114 can be used to scan the object 106 at the point-of-sale 108 thus identifying the association which can be stored in the database 118. There may need to be some interaction at the point-of-sale to make the connection and the association but there are a number of different ways in which the association can be identified.

The first buyer 101 is thus identified as the person buying the first product 102. With the object 106 fixed on the first product 102, the first buyer 101 can go home 124 or to any other location with the first product 102. The first buyer 101 can then become a promoter of that product to their friends. When the FOFM decides they like the product, they can easily buy one for themselves and the first buyer 101 can get an automatic benefit. A second buyer 122 can use a second buyer device 120 to scan (using a camera on the second buyer device 120) the object 106 on the first product 102. For example, if the first product 102 is a lamp, the first buyer 101 can have the lamp at home and the second buyer 122 can desire to have the same lamp. The second buyer 122 when they scan the object 106 retrieves the information in the object 106. The information causes the second buyer device 120 to access a purchasing service 117 that can include a database 118 from which the association between the first buyer 101 and the first product 102 is retrieved. With the information about the first product 102 and the first buyer 101 available, the purchasing service 117 can enable a number of different actions.

For example, the purchasing service 117 can process a purchase and delivery of a second product 128 to the second buyer 122. Such a process can be done while remaining on the purchasing service 117 site or application or can be coordinated with a merchant server 126. The merchant server 126 for example might receive a transition automatically from the purchasing service 117 to a shopping cart where the second buyer 122 is ready to “one click” purchase the lamp for themselves. The lamp the second buyer 122 buys would be the second first product 102. The purchasing service 117 also processes a benefit to the first buyer 101 based on their influence in causes the purchase of the second first product 102 by the second buyer 122. For example, the first buyer 101 might receive money into a bank account, or a credit for a later purchase that the first buyer 101 might make, or a discount on another lamp purchased by the merchant, or a coupon designating those credits and or rewards may be stored on a digital wallet on the first buyer device 114 and so forth. In this regard, the payment account (typically an open-loop account, but this disclosure is not limited to open-loop accounts) can be tied to or registered with the purchasing service 117 such that the benefit can be provided. The result of the registration process is a registered payment account 136 stored in the database 118 of the purchasing service 117 for later use in connection with the principles disclosed herein. The purchasing service 117 can be connected to or have access to a first buyer payment account 121 of the first buyer 101. The first buyer 101 may register their first buyer payment account 121 with the purchasing service 117 (the registered payment account 136) to enable the purchasing service 117 to provide the benefit to the first buyer 101. There may be different accounts or mechanisms of providing the benefit to the first buyer 101 but in general one or more accounts can be registered with the purchasing service 117 by the first buyer 101 to enable the receipt of the benefit associated with a later sale.

In some aspects, a payment account of the first buyer 101 at their bank or credit card company, or a digital wallet holding cryptocurrency, or some other value holding account can be credited or tied to the purchasing service 117 such that the benefit can be granted. For example, a credit for the merchant who sold the first product 102 can be provided to the first buyer 101 such that the next time they make a purchase of another product, they receive a discount or rebate, or some other benefit associated with the later purchase.

The user experience is important in transactions like those disclosed. In some aspects, the second buyer 122 has already decided that they desire to buy the lamp. They may not want to shop for similar lamps, but they may just want to quickly buy one. The second buyer 122 experience can be that once they scan the object 106 with the second buyer device 120, they land on a checkout page served from the merchant server 126 populated with the lamp and configured for a purchasing process that they are capable of using. They may be able to simply purchase using Apple Pay or Google Pay given the configuration of their second buyer device 120 (who made it), their browser, or any other approach. If they have none of these payment processes, they can add their payment information in a traditional manner and make the purchase. The purchasing service 117 can manage or cause the transition to occur so that the second buyer 122 has a seamless experience.

While the second buyer 122 is being transitioned to the merchant server 126, the first buyer 101 can have the benefit provided via the purchasing service 117 based on the data in the database 118. Again, the benefit can be any number of different types of benefits including access to a venue, a discount, a free product or accessory, and so forth.

The first buyer 101 can have an application or registration with the purchasing service 117 that maintains all of their benefits. The user can for example, go to the merchant server 126 via the Internet 119 and purchase another lamp or product and their discount can be added at a point-of-sale for the first buyer 101 to realize the benefit. The first buyer 101 may receive a physical or virtual gift card or credit card with credit already applied as well.

In one aspect, the first buyer 101 can also buy the first product 102 again and a special treatment can occur because the first buyer 101 purchases another lamp or another game. In that case, a specific discount or other benefit which might be different from a different later FOFM buyer.

In one aspect, the purchasing service 117 can cause the second buyer 122 to land in a “state” like at amazon.com in a purchasing context to be able to “one-click” purchase the second first product 102. In one aspect, the user interface can be configured to enable the second buyer 122 to alter the product they buy. They may want to pick different color, or to pick a different size (shoes) or to continue shopping in a similar vein. The benefit provided to the first buyer 101 can be maintained or adjusted depending on what the ultimate second product 128 is. The manner in which the second buyer 122 lands in a checkout page with different types of options may be configurable based on the product and other offerings. A merchant maybe able to establish from a set of templates or configurable user interfaces to enable the second buyer 122 to just buy the same product again. Or, if it is clothing or shoes where the second buyer 122 needs to make color, or size, or shape or other types of decisions, then those options can be presented in the landing user interface for the second buyer 122. The second buyer 122 may also be presented with accessory options or alternate options like users do when they are close to a purchase on Amazon.com for example.

In some aspects, the second buyer 122 can also get a benefit for purchasing the product from an interaction with the object 106. The second buyer 122 may get a discount while the first buyer 101 gets a free accessory, for example. The purchasing service 117 may cause another item to automatically be shipped to the first buyer 101 upon the second buyer 122 purchasing the second product 128.

In some aspects, the second buyer 122 is transitioned to a merchant website served by the merchant server 126 in a state in which the second buyer 122 can easily purchase the second product 128. The second product 128 is usually going to be the same as the first product 102. However, the second buyer 122 may want to browse and buy something similar but not the exact same color, size, shape or have some other characteristic. The user interface can be configured to present options in this regard related to the characteristic of the second product 128 relative to the first product 102. In some respects, the purchasing service 117 may reduce the benefit for the first buyer 101 as the second product 128 becomes more different than the first product 102.

In some aspects, if the first product 102 is a lamp, and the second product 128 that the second buyer 122 purchases is a computer, then the benefit to the first buyer 101 might be reduced by a certain amount because of the substantial differences in the two products.

Another option at POS 108 is instead of a graphical object that requires a camera application to scan, an NFC chip could be incorporated into the product 102 that only requires the second first buyer device 114 to be brought into proximity. Specifically, products like clothes or fabrics that have a graphical object imprinted thereon would diminish the value or would be hard to place and access from a second buyer 122. Upon scanning the NFC chip as the object 106, the purchase information, product designation would be pulled up in an App Clip delivered from the merchant server 126 or website or “one-click” purchase state, where the buyer wouldn't need to open or download a separate application or open a browser. An App Clip is a feature offered by Apple (r) in which a portion of an application is provided to user device for the purpose of achieving a task such as completing a purchase. The user does not have to download the whole application but just the user interface necessary to perform the basic task. Users can then download the full application but the App Clip is just a portion of the application needed to finalize the task. The data that could be displayed is the product information and options to tailor it specifically to second buyer 122 such as size, color, etc. Also, the benefits that would be provided to the first buyer 101 or the second buyer 122 and the order of purchase 102 such as NFT identifier/receipt can be maintained.

In one aspect, the benefit might be implemented at the merchant discretion, or it may be made conditional on some other factors. For example, a discount may be provided but for products purchased that are over $100 in value. There might be a timing requirement such as a purchase being made during a time window or on a holiday or before the holidays. The benefit in some aspects may not be for the merchant that sold the first product 102 but might be at a different merchant or for a service from a service provider. In this manner, merchants can coordinate campaigns which can be mutually beneficial such as where merchants might be adjacent to each other in a mall.

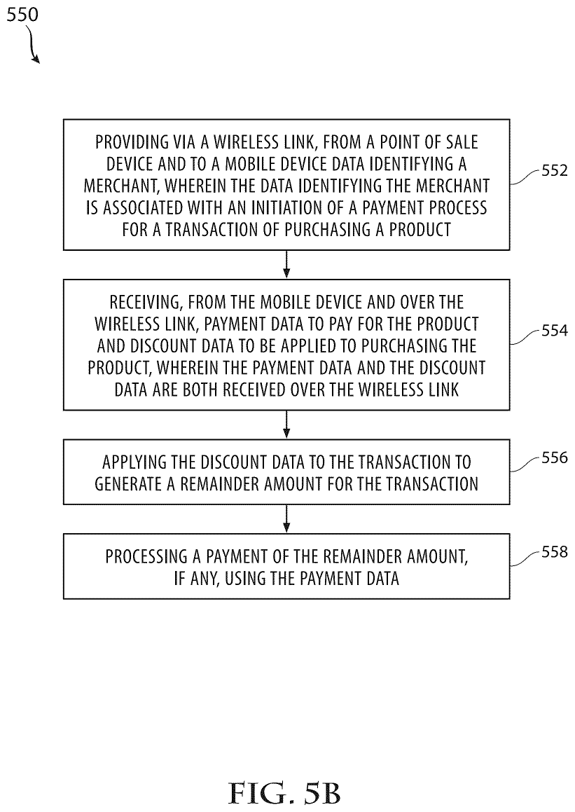

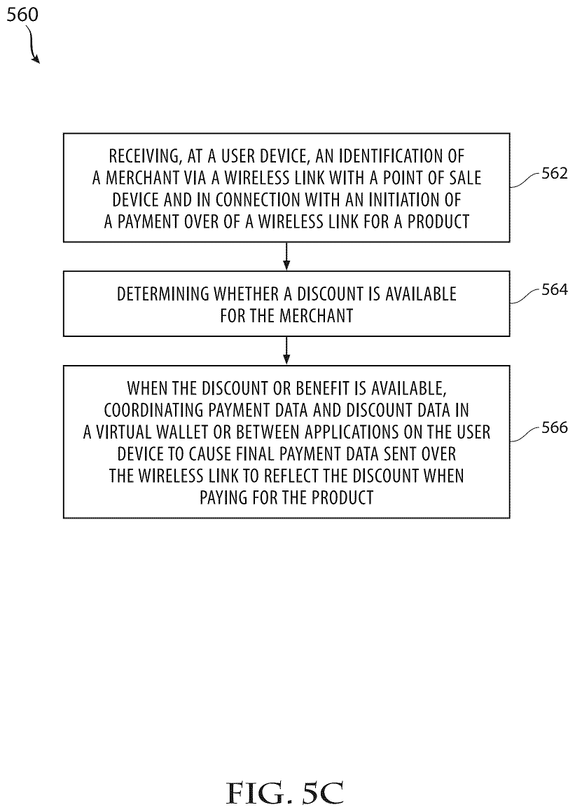

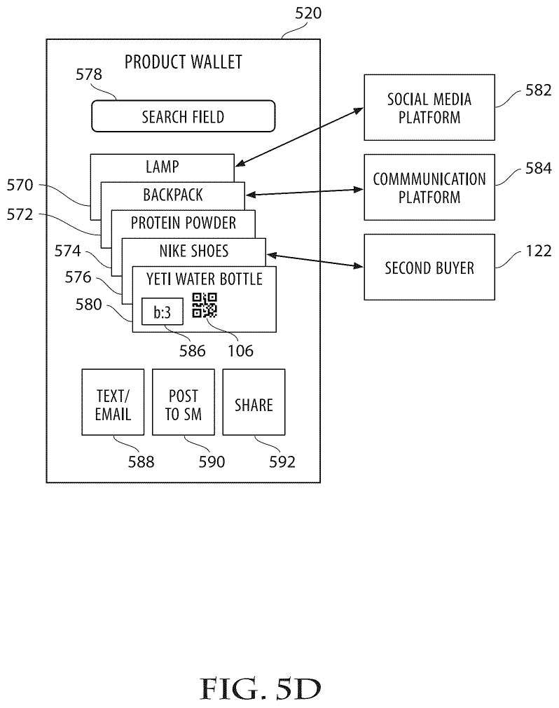

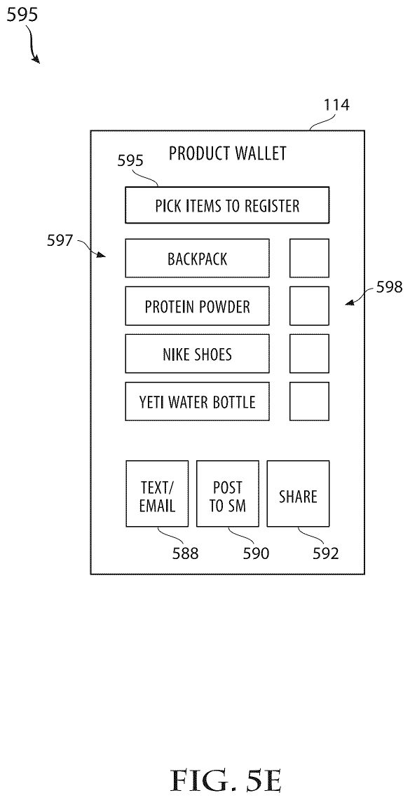

In one aspect, resellers like Amazon.com might provide a code as well independent of the merchant. For example, if a person buys a Samsung TV on Amazon.com, they may receive the physical TV with an object 106 configured on the side or available for display on the TV for scanning by a second buyer 122. Amazon.com might also provide an object 106 as well that could be stored in a virtual wallet (e.g., virtual wallet 502 in FIG. 5) which could grant a separate benefit for using Amazon.com again, such as free shipping or a discount on a next purchase over a certain threshold amount of money. In some aspect, the purchasing service 117 could generate a combined object 106 which, when scanned by the second buyer device 120, causes a first benefit for later purchases or activities associated with a reseller like Amazon.com as well as a benefit from buying another product from the merchant such as Samsung even if it is from a different merchant or distribution facility from Amazon.com. Storing payment accounts and product information for the first buyer 101 and the second buyer 122 and having the ability to track purchases on a merchant level as well as on a product level enables such combined benefits.

In one aspect, when the second buyer 122 scans or interacts with an object 106 via the second buyer device 120, the second buyer 122 may be given an option to purchase a second product 128 immediately or the second buyer 122 may want to store the object 106 or data associated with the object 106 (i.e., data about first buyer 101 and the first product 102) for later reference. For example, the second buyer 122 may store the data in a wallet or application such that later, when the second buyer 122 decides to buy the product, the stored data can be referenced to confirm that the second product 128 was purchased and thus the benefit can accrue to the first buyer 101. The second buyer 122 can be a FOFM.

In one aspect, the benefit to the first buyer 101 can be flexibly applied. For example, when the second buyer device 120 scans the object 106 and is brought to a checkout page on the merchant server 126 who sold the first product 102, the purchasing service 117 will receive the initial indication that the object 106 has been scanned. The purchasing service 117 can immediately send a notice such as a text to the first buyer device 114 that a benefit is on the way to the first buyer 101 because the second buyer 122 is about to buy the second product 128. The first buyer 101 can choose to store the benefit in a virtual wallet or in an application or may choose to give the benefit (say it is a 3% discount on a purchase) to the second buyer 122 for that very transaction to purchase the second product 128. The process here may be applicable because the first buyer 101 may have no intention of buying another purse or may have moved away or is not interested in another lamp from the store. Thus, one aspect of this disclosure relates to the fungibility of the benefits provided to the first buyer 101 both dynamically at the time of the purchasing the second product 128 (before or even after the purchase), as well as later on a secondary market or through giving the benefit to a friend via email, text, social media sharing and so forth. The benefits can even be sold on secondary market as described in more detail below.

Each communication between the purchasing service 117 and other components such as a point-of-sale 108 or a merchant server 126 can be achieved through an application programming interface (API). User browsers (Chrome, Safari, Edge, etc.) can be programmed with API capability and calls. Similarly, the purchasing service 117 and the merchant server 126 as well as one or more of the points of sale 108 devices can be programmed to make or receive API calls to achieve the processes disclosed herein. For example, the point-of-sale 108 devices can combine data about the object 106 connected with the first product 102 and can receive data about the first buyer 101 (such as through Apple Pay) and generate an API call to transmit the data to the purchasing service 117 to store the association in the database 118. Where payment processes like Apple Pay, Samsung Pay and Google Pay utilize APIs for application or web-based payments, those APIs can also be modified to include the data about the first product 102. For example, when the user makes a payment using a payment token for Apple Pay, the payment token and/or the API data transmitted can add data about the object 106 and/or the product. Thus, Apple or Google or Samsung could be positioned to manage the purchasing service 117 at their networks. The use of APIs can simplify the services offered by the purchasing service 117 such that it is easy for companies to implement the concepts disclosed herein for their products. The purchasing service 117 can coordinate (via various APIs) between merchants, payment services, companies like Apple and Google that provide their payment services, and so forth, to enable the concepts disclosed herein.

In another aspect, the first buyer 101 can choose to buy the first product 102 having the object 106 configured thereon or to receive the object 106 electronically. For example, the first buyer 101 may be given the option online to pay an extra $1 to buy the coat with the NFC chip as the object 106 configured on a sleeve. The first product 102 costs more to make with the object 106 but the first buyer 101 may be confident and that they would like to share the first product 102 and have friends or family buy a second product 128 and thus give them a greater benefit than the small extra cost of the first product 102. For example, the first buyer 101 might, while in an online checkout page, have an option to click a box or interact with an online button to have the product sent with the object 106 and to associate the person with the object 106.

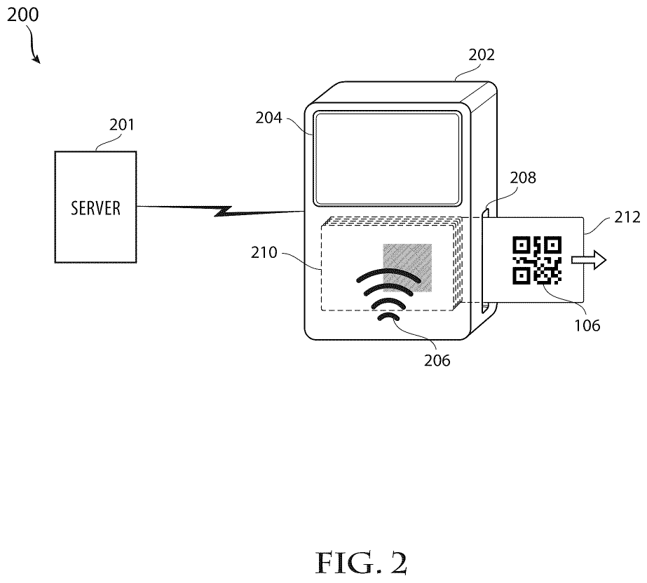

FIG. 2 illustrates a point-of-sale device infrastructure 200 that includes a server 201 and a dispensing point-of-sale device 202. The dispensing point-of-sale device 202 is different from other point-of-sale devices in the following ways. The dispensing point-of-sale device 202 can include a display 204, a near field communication component 206 that enables a second buyer device 120 to pay with Apple Pay or Google Pay or other payment mechanism, and a storage compartment for storing a set of stickers 210. The set of stickers 210 can be configured in connection with a printer (not shown) that can print the object 106 on a printed sticker 212 when appropriate. In some aspects, it might be expensive or not feasible to produce products with respective unique object 106. In such a scenario, the server 201 may determine that an object 106 should be associated with the first product 102 being purchased. A scan of the UPC symbol 104 on the first product 102 may identify that there is no object 106 on the first product 102. In this case, the dispensing point-of-sale device 202 or other interactive device may ask the first buyer 101 if they desire to register or have the first product 102 be active in a program where a second buyer 122 can buy the product and they can receive benefits. There may be options presented to the first buyer 101 about what kind of features associated with a registration they may want.

In some aspects, the first buyer 101 may choose to have one or more stickers printed by the dispensing point-of-sale device 202. The printed sticker 212 can have the object 106 that is recorded in the database 118 as connecting the first product 102 and the first buyer 101. The flexibility of this approach is that the first buyer 101 can then simply stick the printed sticker 212 on the first product 102 as they desire.

The system can also provide the object 106 to a virtual storage location for the user on the first buyer device 114. In this manner, the actual first product 102 does not need to have an object 106 printed on the first product 102 or a box associated with the first product 102 but the first buyer 101 can pull up via a virtual wallet or other storage application the object 106 that can be used by the second buyer 122 to scan via a second buyer device 120 to make a similar purchase.

In another aspect, where the first buyer 101 has the object 106 stored virtually or accessible via an application, they could also print out stickers at a home printer (not shown) if needed. For example, if a sticker on a product gets damaged and is no longer readable, the user could print another sticker at home and attach it to the product for easy scanning later. Or the user could pull up the object 106 on their mobile device to have their friend scan to purchase the product.

The first buyer 101 may also have the option to pause or discontinue their specific object 106 via the application (i.e., a user interface to the purchasing service 117) and reinstate their object 106 when they want the second buyer 122 to scan, thus saving the reward benefit system for a desired friend. Otherwise, object 106 will always be available for scan. The approach here might be applicable where the benefit is limited. For example, the first buyer 101 might be able to receive two or three “benefits” such as discounts for having friends purchase a second product 128. But beyond that, there might be no more discounts or benefits available. The first buyer 101 can control when the benefits apply and when they don't. The option for the first buyer 101 might be applicable where their friend might want to buy three sets of shoes or three of the lamps which might enable the benefit to be greater for the first buyer 101 than if a friend bought one pair of shoes or one lamp.

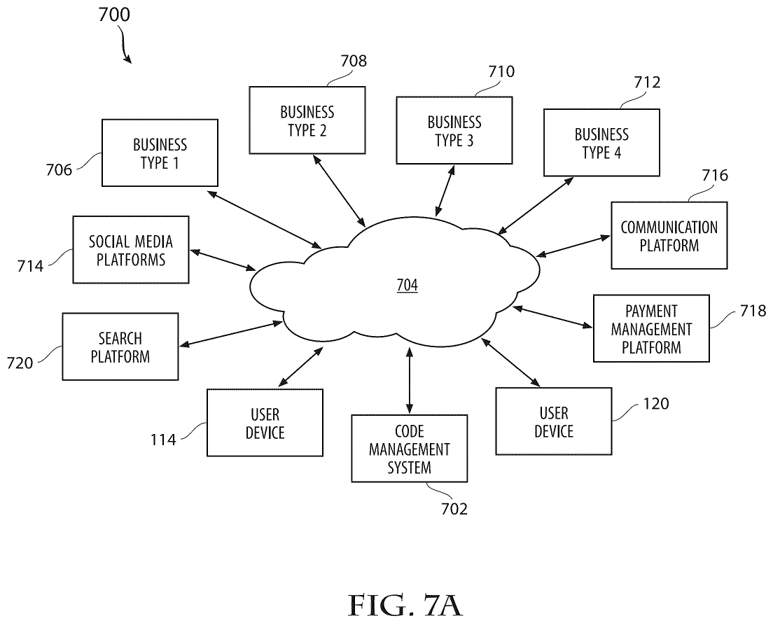

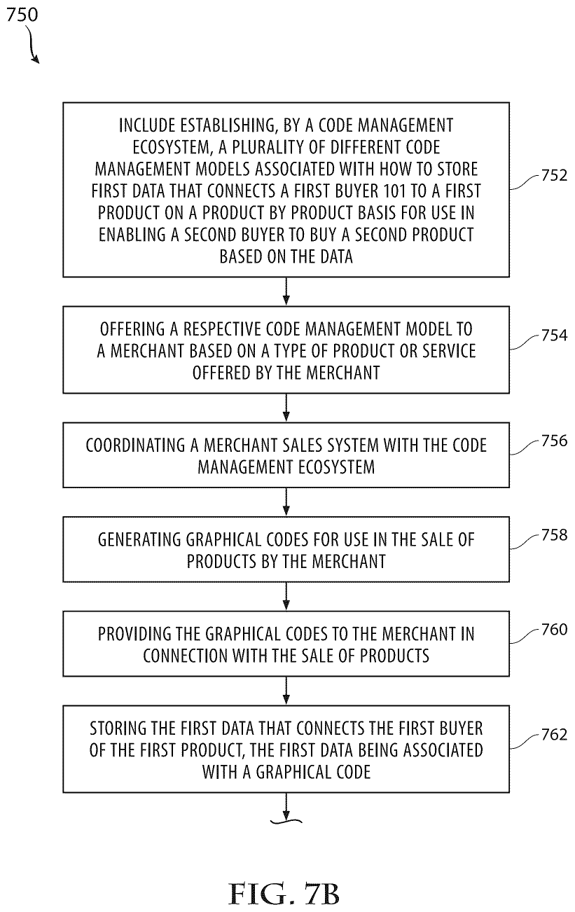

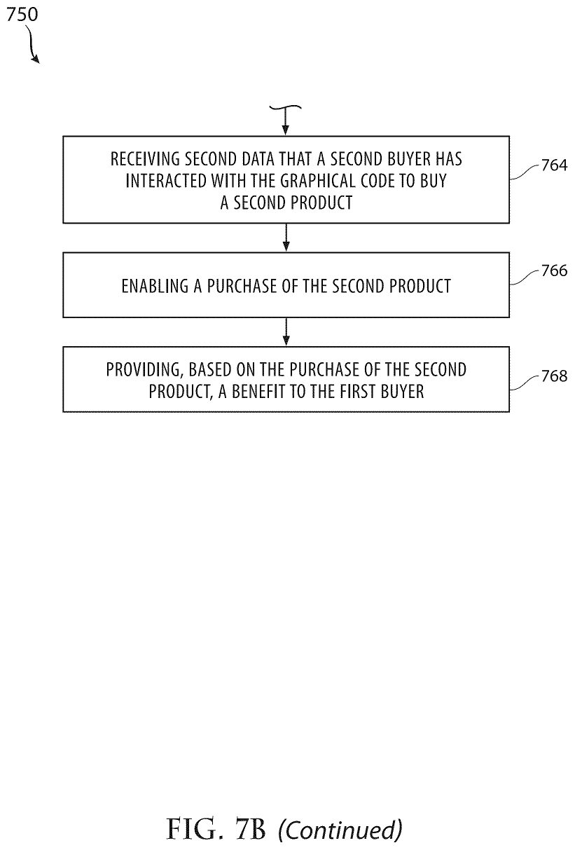

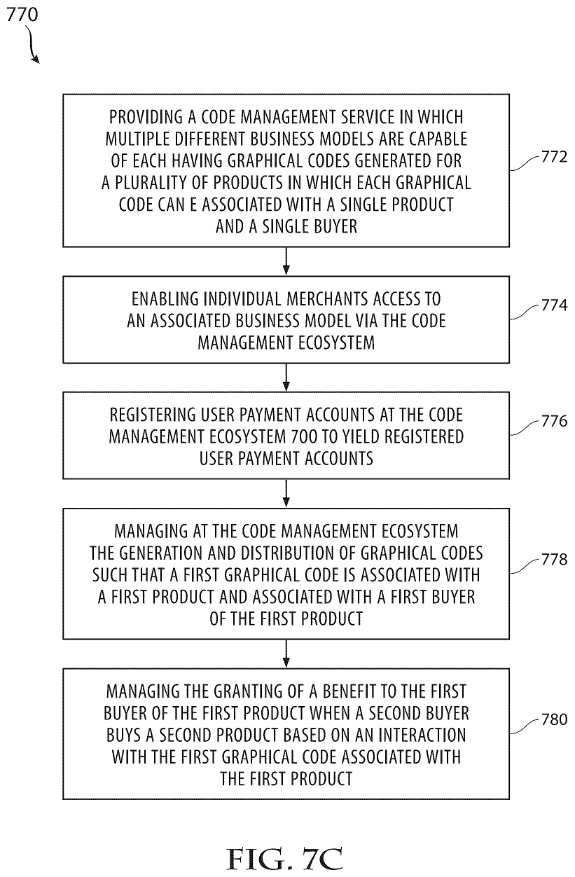

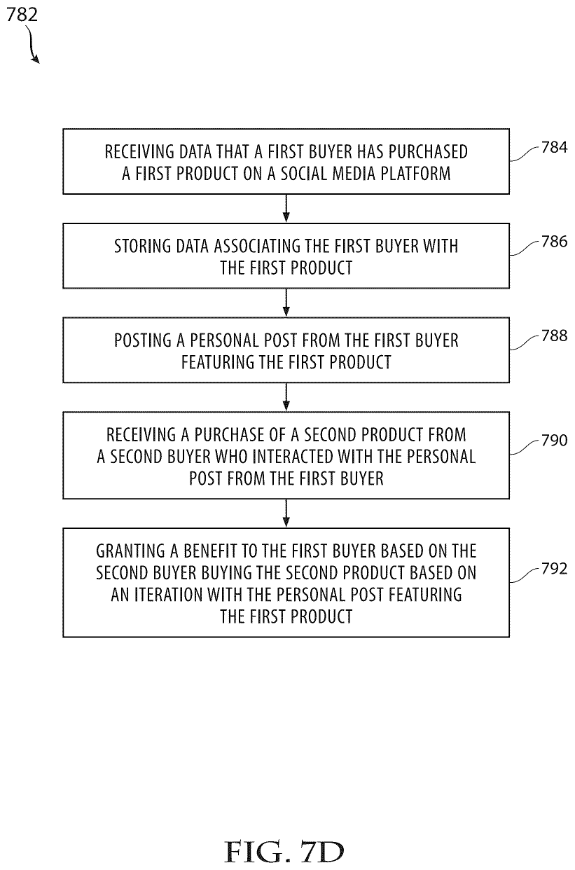

The dispensing point-of-sale device 202 can include any computer components shown in the computing device 700 disclosed in FIG. 7. The dispensing point-of-sale device 202 can include a storage compartment for a set of stickers 210, a dispensing mechanism for dispensing stickers from the set of stickers, a printer, a processor and a computer-readable memory storing instructions which, when executed by the processor, cause the processor to perform operations including one or more of receiving information about graphical object to be printed, the graphical object comprising data about a product being purchased, a buyer of the product, and data to enable automatic access to a purchasing service; printing, via the printer, the graphical object on a sticker from the set of stickers to generate a printed sticker; and dispensing, via the dispensing mechanism, the printed sticker and/or sending the object 106 in a digital form to a wallet or other storage device associated with the first buyer 101. Note that a server 201 may perform some of the above operations and just send a graphical object to the dispensing point-of-sale device 202 for printing. The dispensing point-of-sale device 202 is shown as being an integrated device with set of stickers 210, storage, printing and dispensing infrastructure combined with the near field communication component 206. In another example, a separate sticker dispensing device could be available at a point-of-sale 108 which can be instructed by a server 201 to generate a printed sticker 212 that includes the object 106. The user can then stick the printed sticker 212 on the product for later scanning.

The first buyer 101 may opt into the opportunity to register their first buyer payment account 121 with the purchasing service 117 to obtain benefits from later sales or may pay for the right to receive further benefits. At the time the relationship is established between the first product 102 and the first buyer 101, there can be a user profile established which sets forth the governing policies for that relationship going forward such as defining benefits for a first-generation purchase, a second-generation purchase (from the influence of the second buyer 122) and so forth. The first buyer 101 may be able to adjust user profile settings associated with managing their benefits as later purchases are made of products that they influence. They might be able to upsell or purchase a higher value benefit or adjust timelines or other parameters. For example, the user profile may manage benefits of purchases within 6 months of the original purchase of the first product 102 and different benefits for purchases after 6 months. Users may be additional or enhanced benefits for purchases prior to holidays such as Christmas.

In one aspect, the object 106 printed as shown in FIG. 2 might be on a receipt that the first buyer 101 can then scan with their phone which will trigger a confirmation to “add object to wallet”. The object in this case might be a first object that enables the first buyer 101 to easily add a second object to a wallet to confirm the purchase and connect the first buyer with the purchase. In this regard, the object 106 may not necessarily be stuck physically to the product, but the first object 106 (or another graphical object for this particular purpose), when scanned by the first buyer 101 phone, can initiate the storage of the second object 106 which is later to be scanned by the second buyer device 120 or which can be sent to the second buyer device 120 by text, email or other communication.

In one aspect, a person (an influencer) does not even have to buy the first product 102. The user may go to an application or website and download an object 106 to store in a user wallet or application. The benefit available to an influencer who has not purchased the first product 102 may be adjusted relative to a first buyer 101 of the first product 102. But the influencer may still desire to promote a product that they like. This disclosure includes the concept of a person receiving an object 106 and being associated with a product even without buying the product.

In another aspect, a point-of-sale could just have a stack of individual, unique objects 106 on stickers. Rather than printing each one using the dispensing point-of-sale device 202, the clerk or the person could just take one sticker from the stack and stick it on their product or on the box whatever is applicable. Then the user can scan that object 106 and the first time you scan the object 106 can enable the user to be connected to the product. Data from the receipt of the purchase or data from scanning a UPC symbol 104 on the product by the first user device 114 can be used, or manual entry of information about the product, can be provided. The user may scan a receipt for example. Then the first buyer 101 has their data registered in the purchasing service 117 ready for use and there is an object 106 printed on a sticker that is attached to the product. After registering the first user, the second buyer 122 when they scan the object 106 is processed differently since the system records that the first scan was by the first buyer 101. The second buyer 122 can then buy their own second product 128 and the benefit can be granted to the first buyer 101 as described herein. As can be appreciated, there are many ways to connect the first buyer 101 to the first product 102 and the object 106.

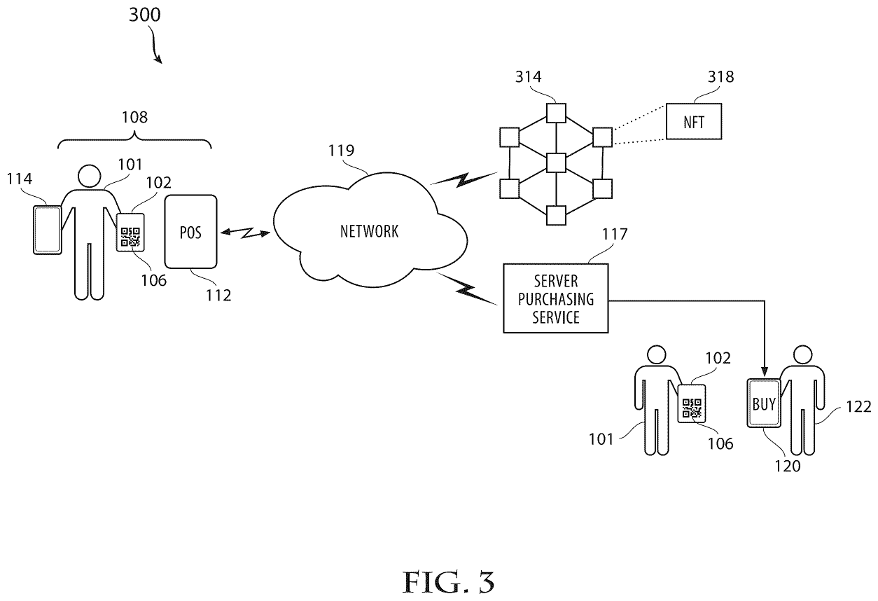

FIG. 3 illustrates an example blockchain-based system 300 in which the first buyer 101 uses their first buyer device 114 to buy the first product 102 which has an object 106 either printed on it or associated with it at the time of purchase or in another manner. The system transmits through the Internet 119 data associated with the purchase. The purchasing service 117 can receive and store the data and cause information about the transaction to be recorded on a blockchain network 314. For example, a non-fungible token or NFT 318 can be created or recorded in a block of a blockchain network 314 that can confirm immutably that the first buyer 101 purchased the first product 102. The information about the purchase and the creation of the NFT 318 can enable a number of benefits or features with the overall process.

With this approach, where products have their own unique number or code assigned to them, one can take advantage of this in ways not previous possible. For example, there is huge value in owning the first Model-T Ford that rolled off the assembly line. It's a famous vehicle. With the principles disclosed herein, one can announce a new baby stroller or new backpack and since each product is numbered, one can provide benefits for those who buy the first one or the first ten. Sales can be divided up from in-store sales to online sales. For example, the merchant can announce that products 1-100 are in stores tomorrow and products 101-1000 will be available online the following Monday. Benefits and tailored experiences can be provided for specifically numbered products. The buyers of the first ten in store and the first forty online can get an extra discount or benefit or be able to customize the experience of their friends that buy the products based on scanning the unique object on their products. The first buyer 101 can have a picture taken of them with the product and a non-fungible token (blockchain recorded record of the image) made in connection with that picture. That NFT can then be owned by that user. The would-be great value of an NFT for the image of the first Model-T owner buying that car. The disclosed approach enables confirmation of purchasing transactions for such new products. For example, this could occur for the first Tesla for sale or the first Tesla truck.

In one aspect, a package of services and experiences can follow any transaction from the first buyer 101, to the second buyer 122, and so on. For example, the first buyer 101 can take a picture with their phone as part of Apple Pay at the point-of-sale or even virtually if they want and can submit through an app or other means the photo for creating an NFT of that moment. A second buyer 122 might want to confirm that they purchased their product from the first buyer 101 or a famous person like Tom Cruise and get a picture taken that can be from the same device that they scanned the graphical object from, and that picture can be made into an NFT which confirms their experience and their identity as the second buyer 122. Note that there is the famous episode on Seinfeld where George Costanza thinks he bought the actor Jon Voight's car. It turns out that he bought a dentist's car. The dentist also was named John Voight. The disclosed approach can enable confirmation of the chain of ownership from owner to owner which can enhance the value and intrigue around any product.

These NFTs can be held by the buyer(s) or sold in a marketplace. Furthermore, the blockchain technology involves each block in the blockchain being connected to a previous block through a hash, time stamp and transaction data. The blocks are connected. In a similar way, each transaction from the first buyer of a product to subsequent generations of buyers, can be recorded on a blockchain such that there is an immutable and confirmed record of the connection of members of the “family tree” of buyers from the original buyer or first buyer 101.

Tracking the family tree of purchases back to an original purchase can enhance the experience of buying any specific product. For example, if one knows that they friend purchased a pair of shoes from a scan of the object 106 associated with the shoes of Tom Cruise (who was the first buyer 101), then they might more likely want to purchase those shoes not just in general but from their friend (which is the second buyer 122) because of the direct connection to someone famous. The approach to purchasing products disclosed herein creates a social media-type of connection to the purchasing experience and the specific product that previous does not exist in the marketplace.

Social influencers can use the object 106 or code on their Facebook page or postings or on any social media posting or messaging. Once the first buyer 101 purchases the first product 102, there can be a transaction record or NFT 318 generated that is “registered” on the blockchain network 314. Then, the first buyer 101 can receive a set of services associated with that purchase. Social media networks, companies like Shopify and BigCommerce, can have accounts to help monetize further interactions based on the first purchase of the first product 102. For example, the first buyer 101 can register with a chosen service (i.e., the purchasing service 117) and then use the object 106 or code in online in posts, on stickers, or anywhere to obtain benefits when people scan and buy the second product 128 for themselves. Different benefit structures can be provided to the first buyer 101 or subsequent buyers based on a differentiation between activities like a bigger benefit for in-person physical sales or online posting from social media sales.

A blockchain network 314 typically includes: (1) a physically distributed group of compute nodes; (2) a respective instance of a consensus algorithm that is loaded on to each compute node of the group of compute nodes such that, when a consensus is gained from the instances of the consensus algorithm for a transaction, the transaction is recorded on a distributed ledger, and (3) a respective instances of the distributed ledger is loaded on each of the distributed compute nodes such that the transaction is immutably recorded on the distributed ledger.

The purpose of the blockchain network 314 is to record a transaction in an immutable way that cannot be changed absent an action by the distributed consensus algorithm. Thus, data associated with a transaction, transitions from one state (being in one memory location and capable of being deleted or changeable in general) to being in an “immutable” state (being stored in a blockchain structure across multiple nodes on a distributed ledger of a blockchain network) in which it can only be changed (or spent or transferred or burned) based on another result of the consensus algorithm.

Achieving an immutable state for data is the goal of the blockchain network 314. The blockchain network 314 solves the double-spend problem, which is a problem of being able to spend the same money (or cryptocurrency) twice. A block in the blockchain network 314 is linked to a previous block using cryptography in that each block contains a cryptographic hash of the previous block, a timestamp, and the transaction data. This linking of blocks (thus the name blockchain) protects the data from being changed in ways that are not applicable when data is simply stored in memory on a generic computer. The structure of the transactions recorded in blocks on a blockchain network 314, and how the blocks are linked together in a chain, prevents a second transaction or a double-spend of the cryptocurrency. Thus, the data associated with the transaction and that is recorded on the distributed ledger is literally “a transformation or reduction of a particular article [the transaction data in a first state of being changeable] to a different state [i.e., a second or different state of becoming stored in a blockchain structure on the distributed ledger in an immutable way or in an immutable state] or thing.”

In another aspect, at the point-of-sale, the UPC symbol 104 may be modified to include an indicator that for this particular product, an object 106 should be generated. In this regard, At the point-of-sale 108, an identification of the product through the UPC symbol 104 is received, if a trigger or marker on the UPC symbol 104 (or through a user input or an employee input at the point-of-sale 108) is received, the marker can cause a series of steps to occur. Data identifying the first product once purchased by the first buyer 101 can be transmitted to the purchasing service 117 along with an identification of the first buyer 101. At a first such purchase, the first buyer 101 can be asked if they would like to register their first buyer payment account 121 with the service to receive the object 106, download an application (such as application 508 shown in FIG. 5), establish a virtual wallet (such as virtual 502 in FIG. 5), and be registered to be able to enable friends such as the second buyer 122 to purchase the second product 128. The first time the user buys such a product that is in the system, the clerk at the store, may ask if they would join the service or become registered, and if so, then the information may be sent to the purchasing service 117 for processing. Then, a notification is sent to the user to either download the application, or a text might be received with the object 106 that they can add for example to their Apple Wallet or that is used to create a product wallet (see product wallet 520 in FIG. 5A). Once registered, later products that quality with a market can automatically have object 106 generated tying the user to the product. A picture of the product could be provided with the object 106 such that the user's product wallet can be searched for a picture of the desired product that a friend might want to scan and buy the second product 128.

Further, the transaction in this case has occurred that identifies the first product 102 and the first buyer 101 and thus, if the user registers their payment account or is registered and thus an object 106 is created, the object 106 can be recorded on the blockchain network 314 to confirm that the user bought that product.

As noted elsewhere as well, the user can also transmit via email, text, social media, or other means the object 106 such that a friend can click on the object 106 received on their mobile device or computer and be brought to the vendor website or to a checkout page featuring the first product 102 and configured to enable the second buyer 122 to purchase the second product 128 while granting the benefit to the first buyer 101. In this regard, the second buyer 122 is not scanning a graphical object like a QR code but is rather interacting with an object they received from the first buyer 101 that is coded to initiate the transition to the merchant website or application for purchasing the product.

In another aspect, the UPC symbol 104 can include a bit or other data indicating to a point-of-sale device 112 that the product has an object 106 associated with it. The clerk or self-checkout in this case could instruct the person to scan the object 106 via an NFC point-of-sale device or visually scan the object 106 via a visual scanning point-of-sale device. The devices can be placed in a “state” of scanning the object 106 (instead of scanning for payment data or a discount QR code). After the point-of-sale 108 obtains the data from the object 106, the point-of-sale 108 can return to its normal state or another state when ready to receive payment data or a discount from a QR code.

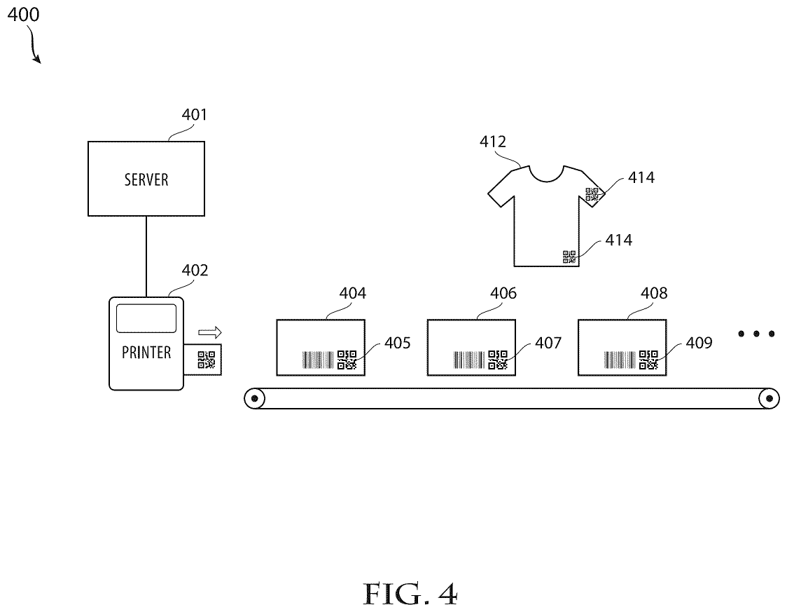

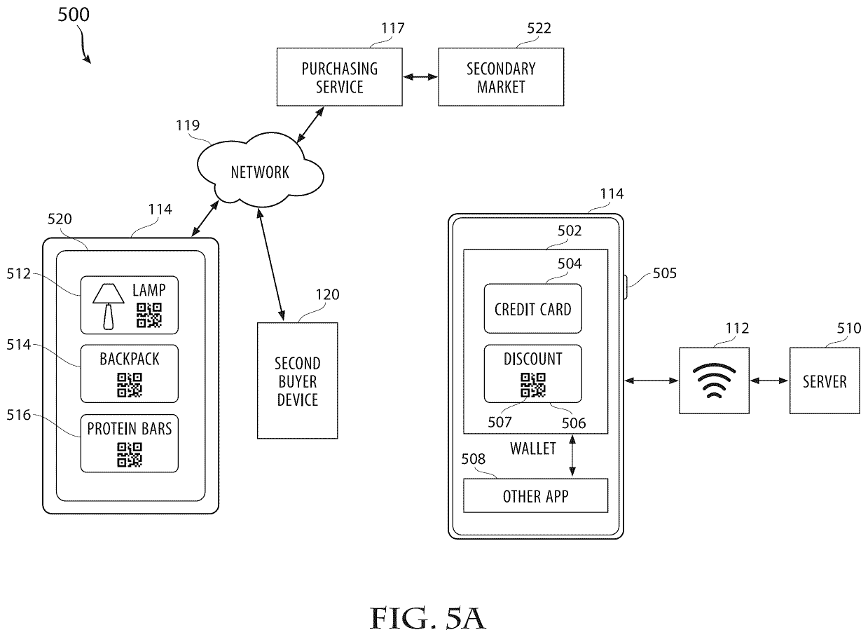

FIG. 4 illustrates a manufacturing facility 400 in which a printer 402 is connected to a server 401 such that the printer 402 causes a unique graphical object to the printed on each product. For example, each respective product of a group of products 404, 406, 408 has a respective graphical object 405, 407, 409. FIG. 4 illustrates how the individual graphical objects 405, 407, 409 can be printed at the time of manufacturing. The graphical objects 405, 407, 409 can be put on boxes (such as a monopoly box or box of playing cards), on labels such as for clothing or shoes, on a door such as in a vehicle, on an underside of a product such as a drone or remote-control truck, or on any location that is convenient to print or etch the graphical object.

At making the product 404, 406, 408, the server 401 can generate unique codes for each product. The generation can be random or can be based on a geographic region so that regional information is also provided. Also, the code can include the country produced in, date produced, the facility it was printed in, details for the item it is intended for, or any sort of relevant non-reprogrammable information. In this example, if a manufacturing facility is structured such that a group of products 404, 406, 408 is known when it is made that it will be delivered to Florida, then the respective graphical object 405, 407, 409 can include regional information. In this manner, if a later second buyer 122 after the first buyer 101 purchases the first product 102 buys another product, the object 106 on the first product 102 can identify location information associated with the first product 102. That information can also be compared to location information gained from the second buyer device 120. If the location of the second buyer device 120 is in Texas, then important business data can be gathered indicating that the first product 102 was sold in Florida (say the lamp), and then was moved to Texas where the object 106 on the lamp was scanned by the second buyer device 120.

An article of clothing 412 like a shirt is shown as being manufactured in which an example clothing object 414 is inserted or printed on the article of clothing 412 on a sleeve or at a bottom portion of the clothing. Various locations upon the article of clothing 412 where the clothing object 414 can be provided are on a tag, on the collar, on a sleeve, on a pocket and so forth. Different articles of clothing 412 may cause different locations because another person must scan or move their second buyer device 120 to the clothing object 414 to make the purchase. Thus, for modesty, the positions on the article of clothing 412 may be carefully chosen. A belt for example may have the clothing object 414 configured on a side portion when the belt is worn. Similar to pants. The location may be on a side portion or knee or other location that would be easy and proper to scan.

The clothing object 414 can be a NFC tag configured in a compartment of the clothing. The compartment can be identified by a logo or visual object that identifies where one would bring their second buyer device 120 to make a purchase. When the article of clothing 412 is scanned at a point-of-sale or online, the UPC symbol or other identification of the product can identify that this clothing has a clothing object 414. A point-of-sale 108 device can be placed in a mode of having the clothing object 414 brought near it for scanning a visual code or for scanning an NFT tag which can then identify uniquely the article of clothing 412 and enable the connection to be made with the user as the user becomes identified by using Apple Pay, Google Pay, or by manual identification. The connection between the article of clothing 412 and the first buyer 101 is thus stored in the database 118 of the purchasing service 117.

When the user buys the article of clothing 412 online, the processing at a warehouse or other location can include a worker or a robot who grabs the article of clothing 412 and scans the clothing object 414 to identify the article of clothing 412. The buyer is already identified as they are buying online. The buyer may also buy the item and have it shipped to their home prior to the connection being made. The buyer may then activate the connection at home by scanning the clothing object 414, the purchasing service 117 can be placed in a state for that purchase of waiting for the initial scan to make the connection. There can be an open item in the purchase history that can give notice to the user that they have not yet registered the product. Once the user connects the product to the buyer, then the purchase history can be updated to reflect that they have established the connection and that the open task is closed. Thus, second buyers 122 can scan the object 106 or clothing object 414 to make the purchase of the second product 128. Thus, part of this disclosure involves the tracking of connection tasks for products in which the connection between the first buyer 101 and the first product 102 are made at home after the product is delivered or purchased. A purchase history like on Amazon.com or in a user app can be the place where a graphical user interface can report and enable the user to track their connection tasks. Once the first buyer 101 scans the object 106 or clothing object 414 to make the connection, the purchasing service 117 can switch to another state where later scans of the object 106 or clothing object 414 are expected to be a second buyer 122.

For example, a user may buy a product which has a scannable object and at the point-of-sale have not connection made or record made of their purchase. For example, perhaps they purchased the object in cash and have a receipt. The user could go home and utilize an application on their mobile device or some other application and identify the product (including scanning a receipt perhaps) and identify themselves as the purchaser and submit the data to a database for enabling them to receive a benefit if a friend or other person buys their own product via interactions with the user. Various approaches to fraud protection can be used such as pinging the user's payment account or confirming a photo of a receipt to insure that the person actually bought the product.

In the example of data such as facility, date, and national location, such information can be used to identify and confirm authenticity of the product made for sale. For instance, some products may have different models made at different times and places. The use of the object 106 in this case will ensure the product has the proper qualities stated (i.e., manufacturing components, materials, hand-made, etc.), and that it is a genuine product. Such a data log will prevent fraud and allow for purchasers to have confirmation as to the authenticity of their product. Such data can be recorded as well on the blockchain network 314 as shown in FIG. 3.

The purchasing service 117 can receive all such information and track the location of products and purchasers of products using this location-based data. Advertisements, manufacturing and distribution schedules and strategies can be adjusted based on the business intelligence gathered as described herein. In this regard, the purchasing service 117 can receive business intelligence data such as locations, timing and individuals who make later purchases based on the first buyer 101 purchasing the first product 102. Such data can be aggregated and reported to merchants to enable them to adjust distributions of products or to pre-stock products in certain areas based on predictions (i.e., machine learning or artificial intelligent model predictions) of future sales of the product or related products and to aid in creating a consumer profile that allows the company to tailor suggested purchases, advertisements, and their marketing mix.

In another aspect, say the product is a car. The first buyer 101 loves their car and lets the second buyer 122 test drive it. The second buyer 122 desires the same car or a similar car. They can scan the object 106 and trigger a series of events beyond just a simple sale. Inventories can be checked, appointments can be made (with references to a dealer calendar and a calendar of the second buyer 122), loan documents can be initiated, and so forth based on the scan of the object 106. Thus, the second buyer 122 can scan the object 106 and know that 35 miles away is a dealer with a similar car with an appointment available tomorrow at 2 PM for a test drive. The user could be presented with a series of options of similar cars within 100 miles of them and then select one or two to go test drive and the appointments can be requested. Or, the second buyer 122 can just purchase the vehicles online as they have already test driven the first buyer's car and the purchase can be made, with a loan structure if needed. In all these scenarios, the series of events is triggered automatically depending on an application programming, data associated with the object 106, back-end network server capabilities, access to information associated with the second buyer 122 (i.e., have they enabled the purchasing service 117 access to their calendar), and so forth.

Note that this approach also enables referrals for different types of services beyond just a product sale. A builder or a dentist could provide an object 106 that enables their clients to have their FOFMs scan the object 106 and get scheduled for a cleaning or a meeting to discuss a project. The “product” here would be some kind of service that is available. The referring person (the first buyer 101) can then receive a benefit if the second buyer 122 purchases the services based on the referral.

In one aspect, each purchase of a user can also be processed in the following way. When the first buyer 101 buys a first product 102 that has a unique graphical code or object 106 associated with it, an alternative approach is to provide an application or website or other approach to providing the user with the graphical object 106. When the first buyer 101 buys a lamp using Apple Pay at the hardware store, the lamp can be “in the system” as a product that the first buyer 101 can get a unique graphical object 106 for. When the transaction occurs and there is an identification of the first product 102 and the first buyer 101, the first buyer 101 can receive in a wallet (i.e., the Apple Wallet or other app) the graphical object 106 and a description of the lamp as the first product 102. Then, 1 year later as a friend or a second buyer 122 desires to buy a similar lamp, the first buyer 101 just needs to pull up their wallet and find the lamp and the object 106 can be displayed on their device screen. The FOFM or second buyer 122 can just scan the object 106 from the first buyer's phone and purchase a lamp for themselves. This aspect eliminates the need to physically print an object 106 on the first product 102.

In yet another aspect, a graphical user interface can be presented when the second buyer 122 scans the object 106 either on the first product 102 or on the first buyer's phone. The interface can enable options to be presented. What if the second buyer 122 wants to buy that very product (i.e., the actual first product 102 or lamp), and not a new one for themselves. In that case, depending on the type of product, the scanning of the object 106 can trigger a purchase of the very item from the first buyer 101 by the second buyer 122. In some ways, this could easily automate the sale of products that need licensing or other transfer requirements like for a car purchase or other purchase where the application can help with paperwork to be signed or registrations to take place. In other words, the type of product can cause a different series of steps to be initiated which can include licensing or other transfer requirements if the second buyer 122 wants to buy the actual first product 102 from the first buyer 101. For example, a gun sale might require some kind of transfer documents which could be triggered based on the scan and easily (and legally) managed. The second buyer 122 and the first buyer 101 can handle the transaction using identity confirmations (fingerprint scans, facial scans, retinal scans, multimodal input, etc.) on their respective phones (i.e., similar to Apple Pay or other payment processes the confirm the identity of the user) and even signing title documents to make the transaction easier.

As identification cards are digitized and added to these wallets as well, further capabilities can be implemented to verify identify and authorize transactions. For example, the state of Maryland allows for a driver's license to be added to Apple Wallets which can then be used at TSA scanners and checkpoints. Such data or applications that relate to user identity can be accessed by the purchasing service 117 to confirm an identity of the first buyer 101 and/or the second buyer 122.

Note that the graphical object 405, 407, 409 may also be replaced with near field communication (NFC) chips where such devices will work with the particular product. For example, clothing or a backpack where an NFC chip can be built or placed into a tag or other location of the backpack for easy scanning is also possible.

FIG. 5A illustrates a variation on the concepts discloses herein. The wallet and point-of-sale system 500 can be configured to improve the payment experience at a point-of-sale when a discount or benefit is provided. In many applications such as at restaurants, users gain points by making purchases. When they have enough points, then they can get a free meal or free pizza for example. To redeem the reward, often a QR code is generated in an application that is scanned at a point-of-sale. There is required in this case at the point-of-sale an optical scanner such as point-of-sale scanner 110 that scans the QR code and a separate point-of-sale device 112. This process requires two different interactions. The following simplifies the payment process into one interaction rather than two.

A driver's license or other form of identification in the wallet can be used to verify identity within higher level transactions such as a gun purchase or vehicle purchase. A user interface can prompt a verification via face id or fingerprint. This data can be stored or linked to a transaction.

What is needed is a coordination between a payment mechanism like a virtual wallet 502 on a first buyer device 114 either internal or externally to generate a package of data that can be transmitted via a near field communication component on a point-of-sale device 112. For example, a virtual wallet 502 can include a credit card 504 or other payment device. The virtual wallet 502 may also hold other items like a scannable discount 506 or airline tickets or other items. Typically, the virtual wallet 502 just holds these items and does not perform any intelligence or operations between such items. However, through the following approach, improvements can be made.

First, when the user is at a store or restaurant, such as Chipotle, the user may have a discount 506 stored in their virtual wallet 502. The discount 506 can, for example, be for a free burrito or free meal. There is a quick response code or QR code 507 that would be first scanned at the point-of-sale 108. In order to combine the processes, however, when the computer server 510 at the point-of-sale initiates the point-of-sale device 112, it can cause via the wireless link information to pass to the first buyer device 114 indicating that the payment to come is at a Chipotle restaurant. The virtual wallet 502 on the first buyer device 114 can receive that information and determine whether there is a discount 506 available for Chipotle. If the discount 506 is available the information passed to the point-of-sale device 112 can not only include a payment token or other payment information as occurs in the Apple Pay and other payment processes, but can also pass along the discount data such that the computer server 510 can identify that the discount should be applied to the purchase. The actual purchase amount processed can then be adjusted to zero or to some other amount based on the discount being passed through the near field communication to the point-of-sale device 112. This eliminates the need for a separate scan operation for the QR code 507.

The user interface presented to the user to accomplish the payment for the product can be altered to indicate or to receive confirmation to use the available discount 506 stored in the virtual wallet 502. Typically, the payment process involves the user moving the first buyer device 114 close to the point-of-sale device 112 which causes an instruction on the user interface to press a side button 505 twice and then provide a facial recognition (or some other biometric authentication or other kind of authentication) to confirm the identity of the user and to make the payment. However, if a discount 506 is identified in the virtual wallet 502 or from another application such as application 508 on the first buyer device 114, then the user interface may indicate that a free meal discount is being applied to this payment. For example, it may state “You will apply your free meal discount at Chipotle in this payment if you press twice”. The process may be adjusted to say, “If you don't want the free meal at Chipotle applied at this time, press the side button 505 three times [or once, or some other number].” In this general manner, the regular payment process can be adjusted to cause or receive an indication to use the normal process or to apply the discount. The user may need to touch a selectable object on a touch-sensitive display to confirm the application of the discount to the current payment process. There are a number of ways that the confirmation could be provided to apply the discount.

In order to implement this process, the application 508 may be enabled to communicate data with the virtual wallet 502. For example, the virtual wallet 502 may have a registration of various discounts earned from different applications. The user may be able to use the application 508 to earn points, scan receipts or use QR codes to obtain benefits, but then can coordinate the status of the benefits with the virtual wallet 502. In this regard, the virtual wallet 502 may know for example that the user has a free pizza at Mod Pizza, and a free meal at Chipotle and when the user makes purchases at either of those locations, the virtual wallet 502 can coordinate the application of the benefit or discount with the payment data from the credit card 504, cryptocurrency, or other payment instrument, and simplify the process of redeeming the discount into one transaction rather than two.

While the near field communication protocol is discussed above, any wireless link or wireless protocol could apply, such as BlueTooth, 5G or Wi-Fi. There is no limitation on the wireless link being near field unless that requirement is specifically claimed.

In yet another aspect, the disclosed approach applies to online sales. For online purchases, a group of products can be produced in which a unique graphical object 106 is configured on each respective product. Using advanced robotics, the location of each product on a shelf in a warehouse for example can be known in advance as they can be staged as product 1, product 2, product 3 and so forth. Each would have its respective unique object 106 configured thereon. Then, as Mary goes online and orders a watch, or lamp, or whatever the product is, a robot could retrieve product number 3 from the shelf, receive identifying information for Mary as the first buyer 101, and the product/buyer data 132 can be stored in the database 118. Then, later, as John (the second buyer 122) scans the unique object 106 with his mobile device or the second buyer 122, the purchasing service 117 can identify the product number 3, access the database to determine that Mary was the first buyer 101, cause a new product or a new lamp (the second product 128) to be delivered to John and charged to John, and provide to Mary the benefit.

Note that John also can have the same benefit provided to him in that when his product (the second prod) is pulled from the shelf, it will have its unique graphical object. Say the second product 128 has a number 213 with its unique object 106. A new product/buyer data 132 is stored at the database 118 with John being associated with product number 213. Then, when John's friend Joe sees John's lamp and wants one, Joe scans the object 106 on the base of John's lamp (or on some other location) and orders a lamp, then John gets a benefit. Note as well that the benefits can be multi-generational in that the system knows that Joe bought one from John and John bought one from Mary. So, Mary could get a little benefit when Joe buys from John as she started the chain of buyers. A “family tree” can be generated which ties together each transaction. The multigenerational transactional data can be stored and integrated into a social media platform or can represent important business intelligence data as well.

Further, when these transactions take place, graphical user interfaces can be provided to one or more of Mary's user device, John's user device and Joe's user device. Adjustments can be made at each stage. For example, when Mary buys the lamp, she can designate a bonus gift to any friend that buys from her. Perhaps it's a Giftya or perhaps it's a discount. Photos can be taken of Mary buying the lamp which data can be stored in the database and used for a social media posting. For example, Venmo requires a note about each transaction and provides a feed of these transactions to friends. There could be a social media feed made up around the history of a particular product. The product (specific product number) could have a social media account generated for it and each time another person buys a product from that initial product, a posting could be made on the feed. In this manner, a particular product could become famous through so many people wanting to make a purchase that is attached to an individual product. The purchasing could spread like virus (in a positive way) as people scramble to be part of the “family” of purchases generated from a famous product.

In one example, say Tom Cruise bought a pair of shoes which are sold and associated to him with a graphical object thereon. A friend Jane buys the shows based on his object 106. As each person buys the shoes based on a respective object 106, the history of the particular product can be provided or confirmed such that they know the “family history” of their respective purchase. People may want to purchase from Jane's shoes knowing that she purchased them from an object 106 associated with the shoes purchased by Tom Cruise. The process can be akin to the excitement of buying Jon Voight's car for George Costanza in Seinfeld. People can feel personally connected to the product. In one aspect, each transaction can be immutably stored on a blockchain network to confirm its authenticity.

In another aspect, the original buyer from the store can opt-in to a social media treatment for the product. For free or for a small fee, the user may select to begin one or more a social media accounts (Instagram, Facebook, Twitter, etc.) dedicated to the specific product. The first buyer 101 can take a picture of themselves with the first product 102. The first buyer 101 could choose handles which are confirmed to be available (“Jane Doe's Great Lamp”). Then, the database entry in the database 118 is generated for the user and the first product 102, the purchasing service 117 can automatically generate a new entity on the one or more social media platforms. Then, as later purchases are made from that original product, a family tree can be generated with later purchasers from that original lamp can be placed in their position in the family tree and the social media accounts can be updated. Later buyers can be asked to give comments as to why they purchased the product, have a picture or video taken, and have that data added to the social media account as a post or other data attached to the account. In other words, social media experiences can be focused around the family history of purchases that started with the first buyer 101 buying the first product 102.

The “product family tree” can be dynamic and changing and perhaps can cause the desire to purchase the product from a product in the family tree more desirable for users. A new kind of viral opportunity exists where people via social media may connect and want to buy the same product from a particular person in the tree or as high up in the tree as they can.

New user groups can become established as members of a group, for example for a Facebook page, can be those who purchased the product as part of the same family. The exclusive group can of course exchange comments and questions in the normal manner on social media.

In one aspect, with a family tree being shown, the social media platform may allow social media commerce abilities to occur where a person in the group or a new person (say Joan) could be allowed to access the family tree and choose a person (say Fred) in the family tree, and then buy the lamp “from” that person. The social media platform can sell the product and deliver it to the buyer and then give the benefit to the particular person selected in the family tree as though the buyer had purchased it from a scan of the graphical object 106 physically. In one example, this approach could occur where in the above example on Fred's feed on his social media account he comments that he bought a Lamp and that posting can be tied to the family tree or the system that manages the processed disclosed herein. A friend Joan may see Fred's posting and desire to purchase the lamp. The posting can be configured such that Joan can buy the lamp from Fred's posting, Fred gets the benefit as outlined here, and Joan gets added to the family tree and gets to join the group for that Lamp.

For privacy reasons, in some cases, buyer data can be anonymized if at the time of purchase the buyer decides not to have their information shared on the social media platform or as part of the tree. A placeholder can be provided to show a purchase, but no identifying information can be included.

In some aspects, also shown in FIG. 5A is the first buyer device 114. The first buyer 101 can receive a product wallet 520 that stores objects 106 associated with purchases. For example, the first product 102 can be a lamp 512, or a backpack 514 or protein bars 516. Each of these products is confirmed to be purchased by the first buyer 101 (including on the blockchain network 314) and can be stored in the product wallet 520. As noted above, data associated with a purchase such as one of the entries in the product wallet 520 can be transmitted to the second buyer 122 on the second buyer device 120. Then, the second buyer 122 can access the purchasing service 117 via the received object 106 (again, by clicking on it rather than by scanning as the second buyer device 120 already has received the object 106.

In other aspects, the discount 506 or benefit provided to the first buyer 101 can store data associated with the second buyer 122. This data can make the experience of redeeming the discount 506 more enjoyable for the first buyer 101. For example, when the first buyer 101 goes back to the merchant to buy another product and has a discount 506 available, when the first buyer 101 uses the discount 506, a notice can be provided in connection with the discount 506 that says something like: “You have 10% off because your friend John bought a lamp like the lamp you bought. Congratulations and thank you for the recommendation!”. In other words, part of this process is integrating data about the second buyer 122 into a purchasing experience for the first buyer 101 of another product from the same merchant that sold the first product 102. The approach could also apply to however or wherever the benefit is applicable whether at the same merchant or not.

The approach shown in FIG. 5A in which the virtual wallet 502 can be used to combine a discount 506 with data from a credit card 504 in communication to a computer server 510 is helpful. For example, the first buyer 101 might have received a benefit for having the second buyer 122 buy the second product 128 by scanning an object 106 on the first product 102. With the benefit (in this case, a discount 506) stored in the virtual wallet 502 of the first buyer 101, when the first buyer 101 returns to the store, when the first buyer 101 makes a purchase of another item, the computer server 510 can query whether there is an available discount 506 and if so, the data associated with the discount 506 can be retrieved and provided to the computer server 510 to redeem the discount 506 (such as reducing the new item cost by 5%) and process the payment. In this case, the exchange of information can occur during an Apple Pay or Google Pay or other payment process which can cause a graphical user interface interaction with the user to ask to apply the discount or not, and then a payment token that is generated per the process can be generated with the proper cost taking into account the benefit. The process can be implemented based on a coordination via the virtual wallet 502 between items held within the wallet or between the virtual wallet 502 and a separate application 508 that perhaps manages the use of objects 106 as disclosed herein.

In yet another aspect, the first buyer 101 who receives a benefit or discount 506 can also share that discount 506 with any other person. For example, if the second buyer 122 purchases the second product 128 based on a scan of the object 106 on the first product 102 bought by the first buyer 101, the first buyer 101 may never return back to that merchant because they have moved or do not need any more lamps. Thus, the first buyer 101 could actually give their benefit such as the discount 506 to the second buyer 122 to enable them to directly receive a discount 506 on the second product 128 that they are buying.

In one aspect, an entire secondary market could be established in which benefits are traded or sold. The purchasing service 117 could include a secondary market 522 that enables people to sell for cash their benefits that they do not think they can redeem. For example, if the first buyer 101 has a 5% discount 506 available for purchase at a furniture store, the value of that discount might be expected to be say $50. Given an expected value, the first buyer 101 might be willing to sell that benefit or discount 506 for $25 thus leaving still one discount or benefit left to a second person who bought that benefit on the market. The discount 506 could then be transferred from a first wallet of the first buyer 101 to a second wallet of the second person, as adjusted to account for the sale, to enable the second person to then take advantage or redeem the benefit. The benefit may remain the same or may be adjusted based on one or more factors such as timing, value, cost of the sale of the benefit in the secondary market 522, and so forth.

The product wallet 520 can also be integrated into a company application or website for the user. In some cases, an “app” can be used for tracking purchases and earning rewards at restaurants or other stores. Such an app can be updated to store the purchasing history of products that have associated objects 106. For stores such as Ethan Allen, or a sporting foods store or furniture store, etc., the user may be able to see their purchases, receive notices of special programs related to their goods and so forth. The purchasing service 117 or code management server 702 can provide such information to the merchant to inclusion in their application options.

FIG. 5B illustrates a method 550 implemented by the wallet and POS system disclosed in FIG. 5A. The method 550 can be practiced from the standpoint of the first buyer device 114 or from the standpoint of the point-of-sale device 112 and associated infrastructure. The method 550 can include providing via a wireless link, from a point-of-sale device and to a mobile device data identifying a merchant, wherein the data identifying the merchant is associated with an initiation of a payment process for a transaction of purchasing a product (552), receiving, from the mobile device and over the wireless link, payment data to pay for the product and discount data to be applied to purchasing the product, wherein the payment data and the discount data are both received over the wireless link (554), applying the discount data to the transaction to generate a remainder amount for the transaction (556) and processing a payment of the remainder amount, if any, using the payment data (558). The discount data can represent any benefit associated with the purchase.

From the standpoint of the mobile device or the first buyer device 114, the process would be mirrored where the first buyer device 114 would receive an identification of the merchant via a wireless link and in connection with the initiation of a payment over of the wireless link for a product. An application, virtual wallet 502 or other component of the first buyer device 114 would determine whether a discount is available for that merchant. If so, a payment process would be modified such that additional information or steps required would be implemented to confirm whether the discount should be applied to the current transaction that has been initiated. If so, then the data that is passed over the wireless link to the point-of-sale device 112 (i.e., not through an optical scan of a QR code but through Apple Pay, Google Pay, Samsung Pay, etc.) is not only the payment data (such as a one-time use payment token), but also the data about the application of the discount. The computer server 510 then processes the discount, applies it, and charges the lower amount for the purchase if there is any amount left to be charged.

The process may be implemented in several steps as well. For example, the point-of-sale device 112 may provide via the wireless link the merchant data and the user interaction discussed above may confirm that the discount should be applied. The computer server 510 may then cause a revised amount to be identified as being associated with a one-time payment token for that amount and then that payment token can be provided over the wireless link to the point-of-sale device 112. In other words, rather than the payment process being initiated in which the point-of-sale device 112 sends data to the first buyer device 114 that a $21 payment token should be transmitted via the wireless link, and the first buyer device 114 transmits that payment token after the user clicks twice on the side button 505 and provides a facial recognition confirmation. In this new scenario, if a discount is available, the payment interactions for the user can be modified to confirm that the discount can be applied, then after the two clicks and facial recognition, the confirmation of the application of the discount is sent to the point-of-sale device 112 and based on the application of the discount, a new amount is transmitted to the first buyer device 114 and a payment token is generated which is configured for the discounted amount. In some cases, the actual user interaction with the mobile device might not change (such as when a notice is provided that by clicking twice and applying facial/motion recognition the payment will be made with the discount applied), but there will be more exchanges of information to confirm the proper amount for payment data transmitted to the point-of-sale device 112. These additional interactions can be transparent to the user experience.

In one example process, the merchant or clerk can initiate a payment process at a register and cause the payment process to begin. This is typically where the user brings the first buyer device 114 near to the point-of-sale device 112 to pass the payment information via a wireless link. In this new case, if the merchant has a discount program, the merchant using the point-of-sale device 112 can initially indicate the identity of the merchant so that the first buyer device 114 can check if there are any discounts for that merchant and perhaps confirm with the user to apply the discount to the current purchase. If so, or if not, that information is passed via the wireless link to the point-of-sale device 112 and the final amount of the purchase, if any, is calculated and transmitted back to the first buyer device 114 for the virtual wallet 502 to generate the payment token or pass the payment information to the point-of-sale device 112. This scenario is applicable where the payment token is generated for one-time use for a specific amount and whether the discount applies or not needs to be determined before sending the payment token.

Again, embodiments can be claimed from the standpoint of a virtual wallet 502, an application 508, a mobile device such as the first buyer device 114, the points of sale device 112, the computer server 510 or any other network-based device or a combination of two or more of these devices.

FIG. 5C illustrates another aspect of this disclosure. A method 560 can include one or more of: receiving, at a user device, an identification of a merchant via a wireless link with a point-of-sale device and in connection with an initiation of a payment over of a wireless link for a product (562); determining whether a discount (or other benefit such as access to a venue, tickets to a show, or a reservation at a restaurant) is available for the merchant (564); and, when the discount or benefit is available, coordinating payment data and discount data in a virtual wallet or between applications on the user device to cause final payment data sent over the wireless link to reflect the discount when paying for the product (566).

Note that the discount data might be for the benefit of the first buyer or might be simply the data about the first buyer 101 in the second buyer wallet. For example, some cases described herein involve the second buyer scanning the object 106 or receiving the object 106 at a first time and not making a purchase at that time. They might want to make the connection to the first buyer 101 as the one who introduced them to the product but wait to make the purchase. The discount 506 in this case may represent a code or object 106 that identifies the product and the first buyer 101 such that when the second buyer 122 at a second, later time, buys the second product 128, the system can coordinate (within the virtual wallet 502 or between the virtual wallet 502 and the application 508) the data contained in the discount 506 and cause the benefit to be provided to the first buyer 101. For example, the process may cause a discount 506 to be deposited in the virtual wallet 502 of the first buyer 101 when the second buyer 122 buys the second product 128 such that when the first buyer 101 goes back to the store, the benefit is stored and available for application in the virtual wallet 502 of the first buyer 101.

FIG. 5D illustrates another aspect of the product wallet 520. In this aspect, the first buyer 101 may purchase may “first products” 102. Each product can have an associated entry in the product wallet 520. The first buyer 101 may buy a lamp 570, a backpack 572, some protein powder 574, a pair of Nike shoes 576, and a YETI Water bottle 580. The first buyer 101 may have many products which are in the purchasing service 117 registration database 118. Because there may be many products in the product wallet 520, the user can be presented with a search field 578 in which the first buyer 101 can search for products to either pull up the object 106 for scanning by another device or to take some other action. From this user interface, the first buyer 101 can select an item and then choose to text/email 588 the item or otherwise send the item via a communication via a communication platform 584 like an email application or texting application. The first buyer 101 can select to post to social media (SM) 590 or to a social media platform 582. The first buyer 101 may also share 592 the item with a second buyer 122. For example, the second buyer 122 may use the second buyer device 120 to scan the object 106 shown in FIG. 5D. The first buyer 101 can then share 592 the benefit embodied in the YETI Water bottle 580 item with the second buyer 122 so that when the second buyer 122 completes the transaction, the second buyer 122 gets the benefit such as a discount on the YETI Water bottle 580 that they want to buy. At that time, the YETI Water bottle 580 entry would disappear from the product wallet 520.

The new functionality disclosed with respect to the product wallet 520 is the ability to store multiple product entries that the user can search through and then choose what to do with each individual entry. The first buyer 101 may just be able to pull up a particular entry for a friend to scan or may be able to take various actions for that entry such as posting on a social media site, social media platforms 582 or to take other actions. When posting on the social media platform 582, note that the connection between the first buyer 101 and the product will remain such that anyone who interacts with the object 106 or buys the product from the first buyer 101 social media posting will cause a benefit to be provided to the first buyer 101.

Each entry in the product wallet 520 can be one of several types of items. For example, the entry such as the backpack 572 may represent or contain an object 106 for scanning by a second device. If the first buyer 101 just purchased the backpack 572, then they will not yet have any benefits from a second buyer 122 purchasing the same backpack 572. But, for YETI Water bottle 580, not that there is an item B:3 586 which can indicate that three people (three second buyers 122) have purchased a YETI Water bottle 580 via a connection with the first buyer 101 such that there are three benefits available to the first buyer 101. Again, one or more of these benefits can be shared with others. The first buyer 101 could share 592 all of these benefits with a second buyer 122 or may select a single benefit (like a 10% discount or a 5% discount) with the second buyer 122 or may send a text/email 588 which can be accepted by a second buyer 122. The second buyer 122 may have their own product wallet 520 that can store the benefit for their use when they make a purchase at the merchant. The benefit may be product-based or merchant-based. It could also be affiliate-based where a partner company that sells complementary products can implement or enable the benefit.

FIG. 5E illustrates a user interface 595 on a first buyer device 114. The user interface 595 can be presented as part of a sales process online or at a physical point-of-sale. The system may receive the items that are being purchased. Say the user bought 10 items at a store. A subgroup of those items is likely available to register with the purchasing service 117. However, the first buyer 101 may not want to register every single item. The user interface 595 provides the opportunity to the first buyer 101 to take some actions at the point-of-sale. The first buyer 101 can Pick items to register 595. A variety of products 597 are listed with boxes 598 to enable the first buyer 101 to select which ones to register at the purchasing service 117.

Other functionality could be included such as the ability to text/email 588 a benefit or an object to a second buyer 122, to post to SM 590 or to share 592 an item with a friend. For example, the user may select the backpack and Nike shoes and post those two purchases to social media 590 or text/email 588 them to a friend.

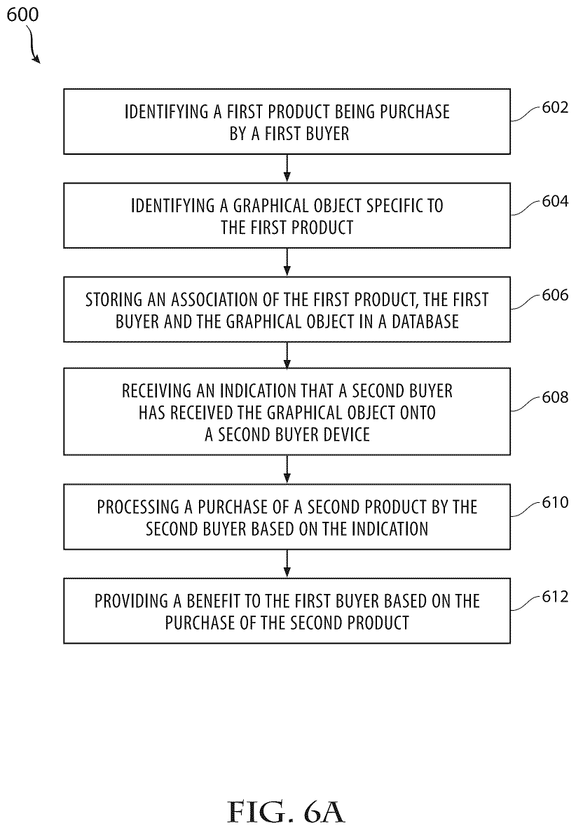

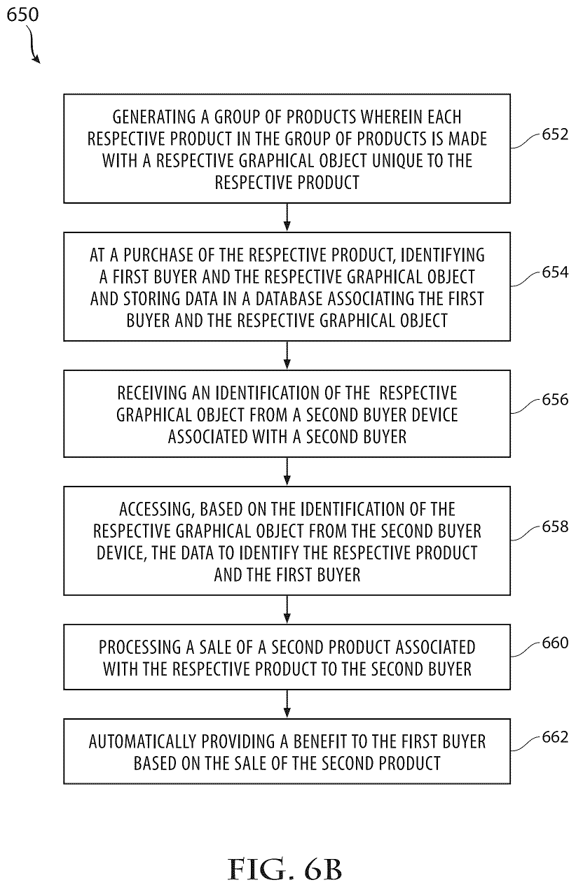

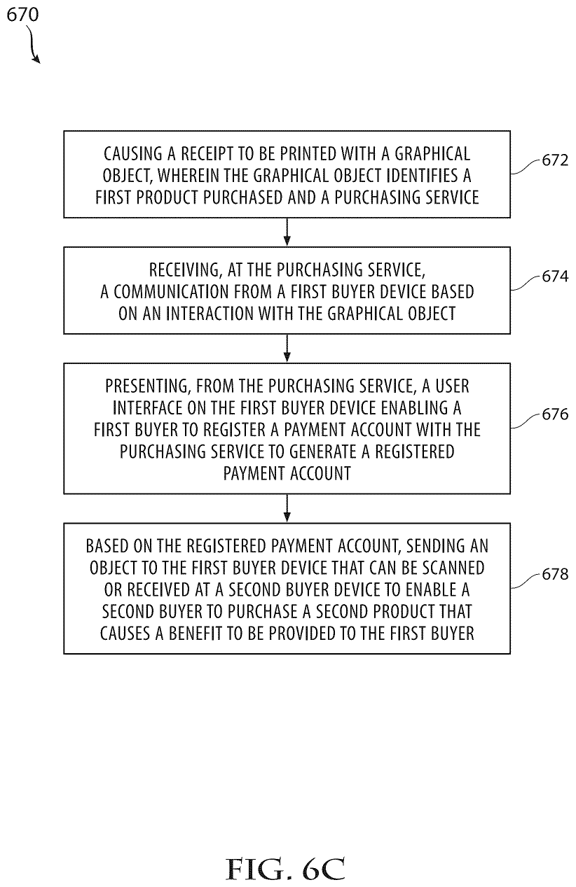

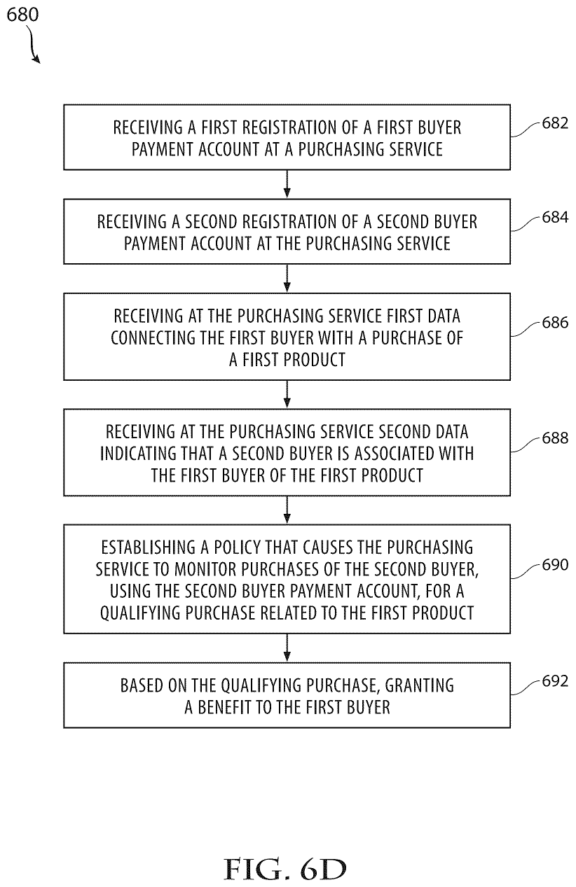

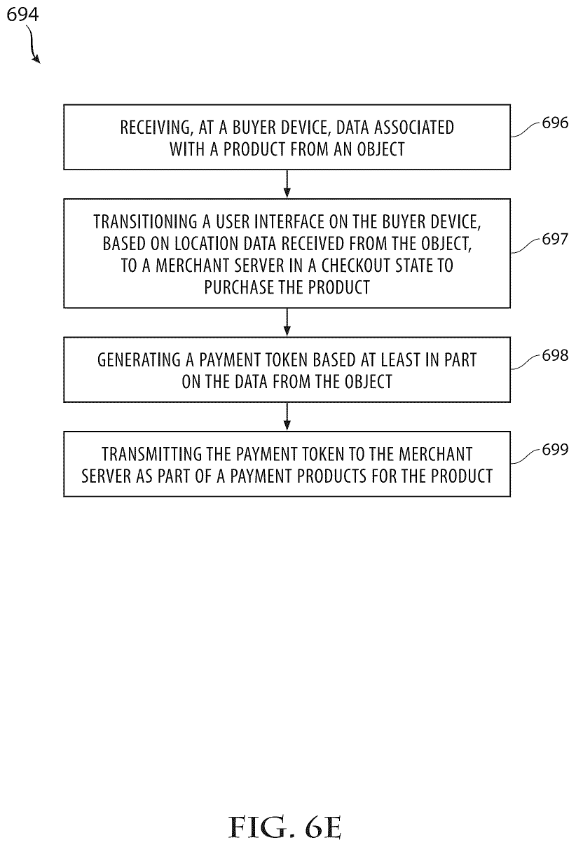

FIG. 6A illustrates a method 600 including one or more of identifying a first product being purchased by a first buyer (602), identifying a graphical object specific to the first product (604), storing an association of the first product, the first buyer and the graphical object in a database as well as linking any relevant data pertaining to the graphical object (606), receiving an indication that a second buyer has received the graphical object onto a second buyer device (608) (e.g., the second buyer has scanned the object 106 and thus obtained the URL and/or other data contained there, or that the second buyer device 120 has been used to receive data from a NFC chip on the product, or has received a communication containing the data, etc.), processing a purchase of a second product by the second buyer based on the indication (610) and providing a benefit to the first buyer based on the purchase of the second product (612).

Again, note that the receiving of the graphical object in the method of FIG. 6A can include receiving data associated with the object whether graphical or via a wireless communication channel or link. There are a number of different ways in which the second buyer device 120 receives the data that is used to initiate the purchase of the second product 128 so that the second buyer 122 can get the second product 128 and the first buyer 101 can get the benefit.

FIG. 6B illustrates a method 650 that includes one or more of generating a group of products wherein each respective product in the group of products is made with a respective graphical object unique to the respective product (652), at a purchase of the respective product, identifying a first buyer and the respective graphical object and storing data in a database associating the first buyer and the respective graphical object (654), receiving an identification of the respective graphical object from a second buyer device associated with a second buyer (656), accessing, based on the identification of the respective graphical object from the second buyer device, the data to identify the respective product and the first buyer (658), processing a sale of a second product associated with the respective product to the second buyer (660) and automatically providing a benefit to the first buyer based on the sale of the second product (662).

FIG. 6C illustrates an example approach. In some cases, a user may not be registered with a code service or purchasing service 117 and get a receipt for a product. The receipt can include a code or a graphical object that can be later scanned by a user's mobile device. The graphical object in this case on the receipt identifies the product that was just purchased and can include data such as a universal resource locator (URL) for a purchasing service 117. Then, later, the user can scan the graphical object on the receipt and be taken to a registration user interface operated by the purchasing service 117. The user can register a credit card 504 or first buyer payment account 121 and thus enable the ability to receive an object 106 (note which is different than the graphical object on the receipt) which can be stored in a product wallet 510 and later scanned by friends to buy the same product for themselves. Or a friend may receive an email or text having the object 106 attached which can be used or interacted with to enable the second buyer 122 to buy the second product 128, while granting a benefit to the first buyer 101.

In this case, the product itself may or may not have an object 106 affixed to it. The user may receive after registration an object 106 that can be stored in a virtual wallet 502 or product wallet 510 or which can be printed on a sticker which can be then affixed to the product. The virtual wallet 502 or product wallet 510 can store many graphical objects 106 associated with various products the user has purchased. A user interface could enable the user to search for products in the virtual wallet (such as backpack or lamp) to find the object 106 which a friend may want to scan.

The product wallet 510 might also include the ability to prune extra objects 106. The user might be able to go through if there are many products each with an object 106 and side swipe or delete certain objects 106 from the product wallet 510.

FIG. 6C illustrates a method 670 that includes one or more steps of causing a receipt to be printed with a graphical object, wherein the graphical object identifies a first product purchased and a purchasing service (672), receiving, at the purchasing service, a communication from a first buyer device based on an interaction with the graphical object (674), presenting, from the purchasing service, a user interface on the first buyer device enabling a first buyer to register a payment account with the purchasing service to generate a registered payment account (676) and, based on the registered payment account, sending an object to the first buyer device that can be scanned or received at a second buyer device to enable a second buyer to purchase a second product that causes a benefit to be provided to the first buyer (678).

Yet another aspect is shown in FIG. 6D and includes the idea of establishing at a first time a connection between the first buyer 101 and the second buyer 122 but without processing a purchase of the second product. For example, the first buyer 101 may have a large item like a couch or a stove. The second buyer 122 may be in the market but not ready to buy. The second buyer could scan an object 106 or otherwise get connected in the purchasing service 117 with the first buyer 101 without buying the particular object. However, assuming both the first buyer 101 and the second buyer 122 are registered with the system, the connection between the two people and the first product 102 can be established in the purchasing service 117. For example, the object 106 may be stored in a product wallet 510 of the first buyer 101 and scanned using the second buyer device 120. The scanning in this example may give the second buyer 122 a chance to make a purchase of the second product 128 or may ask if they want to defer such that later when they use their registered payment account 136 at the merchant that the purchase will apply the benefit to the first buyer 101. A policy 134 can be established at the purchasing service 117 which then is used to monitor the purchases of the second buyer 122 using the registered payment account 136. The second buyer 122 may for example use a VISA card for purchases generally. As the second buyer 122 goes about making purchases using their registered VISA card, finally they may desire a month or two later, that it is time to buy the second product 128. When they do, they can just use their VISA card. The purchasing service 117 monitors their purchases and upon detecting that they made the purchase according to the policy 134, then the purchasing service 117 can automatically provide the benefit (e.g. a refund, money, discount or another policy 134 established for the first buyer 101) to the first buyer 101. In one example, a policy 134 can be established for the first buyer 101 which involves a discount (say 10% off) of their next purchase at the merchant. In that case, the purchasing service 117 monitors the purchases using the first buyer payment account 121 for purchases at the merchant to automatically implement the benefit when a qualifying purchase is made.

All of these transactions can be coordinate with social media accounts, email accounts or text phone numbers such that when any event discussed herein occurs, one or both of the individuals involved gets a notice or reminder or posting related to the event. For example, if the first buyer 101 is George and the second buyer 122 is Fred, when George redeems his discount at the merchant based on Fred buying a lamp based on his relationship with George, a message can be sent to Fred that George just redeemed his discount.

FIG. 6D shows a method 680 that includes one or more of receiving a first registration of a first buyer payment account at a purchasing service (682), receiving a second registration of a second buyer payment account at the purchasing service (684), receiving at the purchasing service first data connecting the first buyer with a purchase of a first product (686), receiving at the purchasing service second data indicating that a second buyer is associated with the first buyer of the first product (688), establishing a policy that causes the purchasing service to monitor purchases of the second buyer, using the second buyer payment account, for a qualifying purchase related to the first product (690), and, based on the qualifying purchase, granting a benefit to the first buyer (692).

The timing of the purchase of the first product, and then the receipt of the second data indicating that the second buyer is to be associated with the first buyer of the first product, and then the actual purchase of the second product by the second buyer, can all be at separate and independent times. For example, the first buyer may buy a lamp on Monday. The second buyer may scan with their mobile device an object or receive a text or email with the object that they interact with. A user interface may enable the second buyer to indicate that they do not want to buy the product now but that they may later. Then, the policy can be established such that when the second buyer simply buys the second product (their own lamp) at the merchant, that the first buyer gets the benefit of the friend referral. Another policy might be established for the first buyer so that when they return to the lamp store, and make another purchase, a discount is automatically applied. The benefit can be of any type such as a discount, access to a venue, a free accessory, a rebate, and so forth.

In another aspect, if an object 106 is stored in a virtual wallet 502 and the first buyer 101 wants to share that product with the second buyer 122, then the virtual wallet 502 or other user interface can be configured such that the object 106 can be emailed, texted, shared over a social media platform (such as social media platform 714 in FIG. 7A) such that the friend can receive the communication and can launch a purchasing process from the communication. The second buyer 122 can be brought after clicking on the email or a link or other interactable object to a checkout page of the merchant with the product preconfigured in a state where the user can easily buy the product and have it delivered to them. The checkout process is further configured upon the purchase being accomplished to grant the benefit to the first buyer 101 who sent the communication. Thus, when the second buyer 122 tells the first buyer 101 that they love those shoes, the first buyer 101 can just send the object 106 to the second buyer 122 via email or text or through any communication channel.

The concept of registering a payment account to generate a registered payment account 136 and enabling the benefit to the first buyer 101 by monitoring purchases using the registered payment account 136 can be achieved using concepts disclosed in U.S. Pat. No. 11,416,846, issued Aug. 16, 2022, incorporated herein by reference.

FIG. 6E illustrates another aspect. Normally, when Apple Pay or Google Pay is used via an API build into a browser, via an app, or at a point-of-sale device 112, the merchant will send some data such as via a “payment request” about the merchant and the amount of money to be paid. Then a payment token is created that is transmitted to an e-commerce back-end system that decrypts the token and submits it to a payment processor. In the approach disclosed herein, the object 106 or other feature such as a near field communication (NFC) chip on the product, can have the same information provided. For example, such data associated with the object 106 can include merchant capabilities, supported networks, country code, billing contact fields, billing contact, shipping contact, application data, coupon codes, line items, currency codes, shipping types, shipping methods, recurring payments, deferred payments, cost of product, and so forth. Thus, the process can obtain some data from the object 106 such as a cost of the item, product description, merchant data, or any other merchant data that might be used for example in an Apple Pay or Payment Request API call that initiates a payment process. From the second buyer device 120, a software module can obtain information about the second buyer 122 such as payment information, name, address, phone number and so forth.

Thus, when the second buyer 122 uses their second buyer device 120 to interact with the object 106, much if not all of the necessary information can be received for generating a one-time use token (such as in Apple Pay) to enable the merchant to submit to a payment processor.

In one example, the second buyer 122 uses their second buyer device 120 to interact with the object to identify the product, the amount, the merchant, and perhaps a necessary URL to enable the second buyer 122 to land on the merchant checkout page ready to “one-click” purchase the second product 128 using their preferred or often used payment method, such as Apple Pay, Google Pay or Samsung Pay. The approach has several benefits. One is that less data needs to be exchanged compared to a normal “payment request” approach for Apple Pay, Google Pay and Samsung Pay. This is because some of the necessary data is obtained from the object 106 and from the second buyer device 120. Next, it is desirable for the second buyer 122 to have a positive experience with the merchant website or back-end server. If the second buyer 122 lands on a convenient checkout page for the product and is in position to simply confirm the payment for the second product 128, the experience will be positive for the second buyer 122. The approach disclosed herein simplifies the process of how the payment enabled by a one-time use token such as in Apple Pay can occur. In another aspect, the second buyer 122 can land on a checkout page of the merchant and the standard Apple Pay, Google Pay, Samsung Pay (or any other payment approach enabled for the second buyer 122) approach including the use of payment requests to obtain data over an application programming interface (API) can be executed.

In one aspect of the disclosure, the registration of the registered payment account 136 is achieved in a number of different ways. For example, when a user purchases a product at a point-of-sale device 112, the user can be presented as part of an Apple Pay or Google Pay process if they want to receive an object 106 which associates them with the purchase and which enables them to receive a benefit if a friend buys the same product through interaction with the object 106. In that case, the user's payment account (VISA, Mastercard, Amex card) can become the registered payment account 136 to which the benefit can be directed if the second buyer 122 purchases a second product 128.

FIG. 6E illustrates a method 694 that include one or more of: receiving, at a buyer device, data associated with a product from an object (696), transitioning a user interface on the buyer device, based on location data received from the object, to a merchant server in a checkout state to purchase the product (697), generating a payment token based at least in part on the data from the object (698) and transmitting the payment token to the merchant server as part of a payment products for the product (699).

FIG. 7A illustrates an example code management ecosystem 700. In this case, as has been noted above, there are many different ways of implementing the basic concept of establishing a connection or relationship between a buyer and a product and generating an object 106 that embodies that relationship. The object 106 can be scanned by a second buyer 122 who then buys a second product 128 thus causes the code management system 700 to grant a benefit to the first buyer 101.

However, there are many different business types and product types from building supplies, to energy food products, to games, to electronics and furniture and virtual products like software services. Implementing the general concepts disclosed herein can vary based on the company or product type. The code management ecosystem 700 can provide services to any company having a particular product type. For example, application programming interfaces (APIs) can be developed for different types of products. As shown in FIG. 7A, a code management server 702 can be used to store or manage multiple different business types such as a first business type 706, a second business type 708, a third business type 710 and a fourth business type 712. These different business types might be divided or characterized as business that sell physical products that can receive or have printed on the product or a box storing the product a graphical object 106. Other products might be best suited for an NFC tag as the object 106 that is configured in clothing or a portion of the product. The third business type 710 might be a service provider such as a doctor, dentist, cleaning company, yard care company and so forth. The fourth business type 712 might sell software or virtual products such that purchasers of their products at best can receive a digital copy of a graphical object 106 that can be stored in a virtual wallet 502. In some cases, the code management system 702 might transmit electronically an object 106 for each product made in a factory that is then used by the business to make the products. Other companies might provide a product catalogue and access to point-of-sale data and receive a dynamically-generated object 106 to print on a receipt at the point-of-sale. Later, when the first buyer 101 scans the object 106 on the receipt using a first buyer device 114, the code management system 702 registers the user and records the connection of the first buyer 101 with the particular product. The object 106 is then ready for scanning by a friend.

The code management system 702 then can manage multiple different verticals or business types and provide services related to the generation of the proper object 106 on a product by product basis. The code management server 702 can manage the relationship with social media platforms 714 for the users of the system and provide the back-end support for the entire ecosystem much like payment management platforms 718 like Shopify or BigCommerce manages payments for companies.

Another service can be a communication platform 716 which can enable any type of communication such as texts, email, social media messaging, telephone calls, video calls and so forth. An object 106 associated with a first buyer device 114 can be shared via any kind of communication via the Communication platform 716 with a second buyer device 120.

As noted above with respect to the purchasing service 117, the code management server 702 can include many if not all of the same features such as a registration of a registered payment account 136 of a user for access.

In one example, the business could be a restaurant. Here, the first buyer 101 might be someone who ate at the restaurant and desires to recommend the restaurant to a friend. One approach can be to enable the user to scan a barcode on a receipt to obtain an object 106 that they can then share with their friend via text or email. In another aspect, the ability to receive an object 106 can be integrated into an Apple Pay or Google Pay process. For example, when paying with Apple Pay at a point-of-sale 108, the first buyer 101 clicks twice on a side button of the iPhone and then looks at the iPhone for facial recognition (or other confirmation procedure) to confirm the payment. Another interaction could be built into this process in which the user clicks on an object that says, “generate and store in a wallet an object to share with a friend”. When the payment is confirmed or completed, the first buyer 101 can receive an object 106 in their virtual wallet 502 that associates the person with having purchased a meal at the restaurant. The interaction may include an option to pick a contact or enter an email address or phone number of their friend such that the object 106 can be generated and sent to the second buyer device 120 ready to use. The purchasing service 117 at this stage can set up a policy that governs or stores data about the second buyer 122 and their payment account and the restaurant such that when the second buyer 122 uses their payment account to buy a meal at the restaurant, then the first buyer 101 gets the discount or benefit activated. In other words, the system can monitor purchases using the second buyer payment account and when a qualifying purchase is made by the second buyer 122 according to the policy, then the benefit is provided to the first buyer 101. When that benefit is affirmed, the purchasing service 117 may create another policy for the first buyer 101 such that the purchases of the first buyer 101 using the first buyer payment account 121 are monitored for a qualifying purchase (at the right restaurant) using the first buyer payment account 121, that the discount is applied to that transaction.

The first buyer 101 may also have a visual or other object on their mobile device that the second buyer 122 can scan. The first buyer 101 may recommend a certain restaurant like Mod Pizza and say, “here, scan this code to get a discount and I'll get some points at the restaurant as well”. The second buyer 122 can scan the code and get perhaps set up with the application for the store (i.e., the process can include checking on whether they have downloaded the app or whether they need to download the app), or may register or ask the second buyer to register with the purchasing service. Then, the second buyer may have a “reward” in their app or may automatically be tracked for a purchase at the restaurant based on tracking or automatic monitoring of the payments using their credit or debit card (or other payment mechanism) and receive the reward, while the first buyer 101 can also, based on the transaction, get their benefit for the referral. Again, the second buyer 122 may get a benefit merely by making the purchase via the monitoring system tracking their credit card/debit card purchases for a triggering purchase according to a policy set up when they scanned the object on the phone of the first buyer 101. The policy identifies the first buyer 101 as the referring person, the second buyer 122 as the person who may buy the second product, the benefit to be provided to the first buyer 101 and any discount or other benefit to the second buyer 122 when they complete a purchase.

Note that there are several layers of policies that can be established for monitoring purchases using specific payment accounts. The first policy can apply for the second buyer 122 to enable the knowledge of the second purchase to be obtained to grant the benefit to the first buyer 101. Then, another policy can be established to enable the granting of the benefit to the first buyer 101. This process of course can work for any business model and not just restaurants.

Another aspect of using a code management server 702 can be where a company might provide a product catalogue to the code management server 702 such that unique codes can be generated in advance or dynamically for individual purchases of the products in the catalogue. Furthermore, the catalogue may identify which products need objects generated and which do not. Not every product will be desirable to have an object created. For example, a candy bar or a Matchbox car may not need codes generated, but other products are more likely to be admired by friends where they might desire the product for themselves.

Furthermore, the code management server 702 or the merchant might also generate objects 106 for products during a window of time. A new product launch might include the advertisement that friend codes or object 106 will be printed on the first 200 purses or bicycles to urge the first group of buyers in that if their friends buy off of them, they get some benefit. Or, merchants may desire objects 106 to be generated during the holidays or as part of a surplus of products or for some other reason. Thus, the timing of when objects 106 are available to consumers can be controlled and limited. The objects 106 may also grant different benefits such as higher benefits for the earlier purchased items versus lower benefits for a later batch or for products purchased a month after the launch. In this manner, merchants can select or control when the objects are created to push timings of when friends share or urge their friends to purchase the same product.

The principles disclosed herein can also be integrated into a payment management platform 718 like Shopify and BigCommerce that manage payment solutions for small businesses. For example, the code management server 702 can coordinate with Shopify each sale and generate an object 106 that is transmitted to the first buyer 101. Product catalogues, pictures, product descriptions, product categories or types, and so forth can be shared such that Shopify or a similar service can modify its services to add the option to associated buyers and specific purchased products as disclosed herein. APIs could be developed with syntax or structures for providing the information. For example, the API could receive information associated with a product and the person buying the product at the code management server 702 and the code management server 702 can generate an object 106, return the object 106 and store the data for later processing.

With respect to social media platforms 714, for example, for Facebook Shops, merchants share their product catalogue with the social media platform 714 and are able to advertise on the social media platforms 714. Under one framework, when buyers want to purchase a product on a social media platform 714, the buyer stays on the platform to make the purchase rather than transitioning to the merchant site to make the purchase. This is generally called “social media commerce” and works for many social media platforms 714 such as Facebook, Instagram, TikTok, etc. One adjustment to the process of purchasing products on social media platforms could be the integration of the process with the code management server 702 in which products that are tagged virtually for having an object 106 created for that instance of the product can be sold in such a way that the product and the buyer can be associated and their data stored for further processing when friends when to buy the same product. The checkout experience on a social media platform 714 can include an option for the buyer to register with the code management server 702 and to set up a wallet or receive an object 106 for the product which they can then use to share the product with friends who want to buy one for themselves. If the user is already registered, the checkout experience might include just a confirmation that an object 106 should be generated for the user. If the product is made with a physical object (like a visual code on a Monopoly game box) already, the checkout experience might just notify the user that the object 106 is printed on the box for showing to their friends if they want to buy a second product 128.

In one aspect, the ability of the first buyer 101 to register a payment account with the purchasing service 117 or the code management server 702, the ability to confirm the creation of an object 106 for the first product 102, the ability even to make notes or other instructions with respect to the data associating the first buyer 101 with the first product 102, can all be integrated into the payment process on a site, through Apple Pay, Google Pay, and other payment services, through payment management platforms 718, through social media platforms 714, through search engine payment services such as Buy on Google or other google advertisement processes such as where clicking on a Google advertisement lands the user in a checkout page of the merchant website, ready to buy. In one example, a search platform 720 like Google can coordinate with the code management server 702. In this scenario, Google could pass information about an identity of the searcher or person clicking on the advertisement using an API or other means that enables the identity to be connected to the product (which Google has through linking a product catalogue from the merchant) as part of the purchasing process at the merchant website. the coordination to enable the underlying association between the buyer and the product can occur a variety of different purchasing contexts.

Some users may not want an object 106 created for each product that qualifies or is tagged or identified as being available for an object 106. Otherwise, the user's product wallet 510 might get too full. Thus, part of this disclosure is the ability or option at a point-of-sale or other user interaction to select which product purchases will generate objects 106.

Whether a social media platform 714, a search platform 720, a communication platform 716 or a payment management platform 718, the approach can include linking or communicating from a business a product catalogue similar to what occurs with Google, Shopify, Facebook, Instagram, Amazon.com, etc. The product catalogue can be communicated to the code management server 702 or just to the other entity. The data communicated can include a flag or metadata identifying an individual product as one that should offer a “friend code” or object 106 in connection with the sale. The data could indicate that the product has an object 106 printed and available for scan at a checkout. in this scenario, a clerk or the person could be prompted to scan the object 106 at the checkout and a confirmation of the registration or storage of that data associated with the product is received at the code management server 702. Identifying the first product 102 could be done through one device at a point-of-sale which scans a UPC symbol 104 while a scan of the object 106 might occur by a second device at the point-of-sale 108.

Claims with respect to a catalogue use can cover the process from both a merchant server 126 and the search platform 720 or social media platform 714 or other platform such as the code management server 702. For example, from the merchant server 126, a method can include transmitting a product catalogue to another platform that includes identification data of which products either need an object 106 generated for their sale or which products will need to have an object 106 shipped with the product physically. The merchant server 126 may receive digital objects 106 electronically for electronic use or for printing an individual unique object 106 on a unique product or the merchant may receive a shipment of physical objects 106 like NFC chips or tags to integrate into the products. Then, the merchant server 126 may transmit or receive information associated with the processes described herein to enable the association of the first buyer 101 with the first product 102 to be established and recorded or stored (e.g., in memory or on the blockchain network 314) through use of the object and then later enable the second buyer 122 to buy the second product 128 based on an interaction with the object 106.

From the platform side, claims can cover the processes from that standpoint where the platform may receive a product catalogue that includes a listing of products and individual products that are identified as needing an object 106 or having an object 106 associated with each product. The information may cause adjustments with respect to how advertisements are presented (i.e., with a notice that this product has a “friend code” available), how checkout flows are implemented (e.g., such as where a user lands on a merchant checkout page from a google advertisement with instructions or the ability to manage the use of the object 106 disclosed herein), and/or how the product is sold at a point-of-sale 108 such as where additional user interactions may be used to confirm the use of the object 106, confirm the desire to implement the processes disclosed herein, register a user with the purchasing service 117 or the code management server 702, and so forth. Thus, steps or operations related to generating objects 106, scanning objects 106, transmitting data, receiving data, storing data in a database 118, presenting a user interface, receiving interactions with selectable objects on a user interface, registering users, accessing payment accounts, delivering benefits or discounts, and so forth can be claimed from the standpoint of individual players or entities in the ecosystem disclosed herein. This includes platforms like a search platform 720, a social media platform 714, sales platforms like Amazon.com, merchant servers 126, the purchasing service 117, the code management server 702, communication platforms 716 or any combination of these platforms. Each of these platforms may play a separate role in enabling the ecosystem disclosed herein and thus each can be separately covered in a patent claim reciting just the operations from the standpoint of the respective platform.

In another aspect, such as sales online via Amazon.com, or via a Google search or social media commerce purchase, the data can identify that the product sold has an object 106 associated with the sale and that the first buyer 101 will or can choose to have the purchase data stored for them or received as an object 106 in a wallet. Or, the first buyer 101 can be notified that the first product 102 has a graphical object 106 printed on a tag, or a box or some other location so that the user knows how to share the product with a friend.

One aspect of this disclosure includes listening to discussions between people through one or more of a device, the first buyer device 114 and/or the second buyer device 120. If through automatic speech recognition it is determined that there is a discussion about the first product 102, then the code management server 702 can provide a text or reminder to the first buyer 101 or the second buyer 122 that indicates that the product can be purchased easily by the second buyer 122 by scanning the object 106 located under the lamp or on the tag of the shoes or via an NFC tag in the tag of the shirt, etc. Such notices or reminders can also be triggered to be provided to a social media feed or other communication avenues.

The data about which products are available for use of an object 106 can thus be promulgated through any selling platform whether virtual or physical thus enabling friends to share products more easily that they like and receive a benefit for being a product champion which currently does not exist. The payment processes or advertising processes can be adjusted to provide a graphical object on an ad or on a checkout screen identifying that the product is available for a friend code or an object 106 that enables the buyer to receive a benefit when a second buyer 122 purchases the product through the object 106. The concepts disclosed herein can then be integrated into many sales of products that lend themselves to being shared with friends who might also want to purchase the same or similar product.

The code management server 702 (or the purchasing service 117) can provide a purchaser dashboard. The user can have their experience tracked and the user can get aggregated data and gamification experiences can be provided in a user dashboard. The user who has multiple products and who might be an influencer might want to see an overall picture of how their various products are doing, which ones have led to one or more generations of purchases, and so forth. The user can see all of their data across multiple products and can see aggregations of benefits or offers from merchants for example if a friend buys a lamp in the next two weeks, what the additional benefit will be to the first buyer 101. Thus, there can be a merchant dashboard and a user dashboard as well that is provided or offered by the code management server 702.

In yet another example, some people who are buyers have much more influence than others. One person who buys a lamp may have a very low likelihood of sharing or having a friend buy another lamp from the first lamp. The code management server 702 can obtain or use personal data about the first buyer 101 to determine whether to provide the first product 102 with the object 106. In other words, the merchant may have a batch of products without objects 106 but then for certain buyers (mostly online), where the buyer is identified as an influencer, then the first product 102 can be chosen from a group of object-connected products or can be made with the object for that first buyer 101. The data about the user might be income, past history, social media followers, social media history, pervious object-based purchases by friends, personal request from the buyer, and so forth. In this way, since it is more complicated to sell the first buyer 101 with the object 106, this approach can only sell products with objects 106 when there are certain characteristics of the user that may be of interest. The creation or sale of the first product 102 can be triggered based on one or more characteristics of the user. For example, the system receives a request to buy a product from the first buyer 101 and determines that the first buyer 101 meets a certain criterion associated with a likelihood of their friends also buying their own product from the first product 102, then selling the first product 102 with an associated object 106 and recording the association in the system. Thus, products can be sold to various people with only those who meet the criterion getting objects registered in the code management server 702 or purchasing service 117 for more beneficial buyers.

FIG. 7B illustrates a method 750 related to the code management ecosystem 700 described above. The method 750 can include establishing, by a code management ecosystem 700, a plurality of different code management models associated with how to store first data that connects a first buyer 101 to a first product 102 on a product by product basis for use in enabling a second buyer 122 to buy a second product 128 based on the data (752), offering a respective code management model to a merchant based on a type of product or service offered by the merchant (754), coordinating a merchant sales system with the code management ecosystem 700 (756), generating graphical codes for use in the sale of products by the merchant (758), providing the graphical codes to the merchant in connection with the sale of products (760), storing the first data that connects the first buyer 101 of the first product 102, the first data being associated with a graphical code (762), receiving second data that a second buyer 122 has interacted with the graphical code to buy a second product 128 (764), enabling a purchase of the second product 128 (766) and providing, based on the purchase of the second product 128, a benefit to the first buyer 101 (768).

The merchant depending on their type can simply sign up for the use of the particular API that is needed to enable the code management ecosystem 700 to assist them in joining the ecosystem described herein.

FIG. 7C illustrates another example method 770 for operating the code management ecosystem 700. The method 770 includes providing a code management service in which multiple different business models are capable of each having graphical codes generated for a plurality of products in which each graphical code can e associated with a single product and a single buyer (772), enabling individual merchants access to an associated business model via the code management ecosystem 700 (774), registering user payment accounts at the code management ecosystem 700 to yield registered user payment accounts (776), managing, at the code management ecosystem 700, the generation and distribution of graphical codes such that a first graphical code is associated with a first product and associated with a first buyer of the first product (778) and managing the granting of a benefit to the first buyer of the first product when a second buyer buys a second product based on an interaction with the first graphical code associated with the first product (780).

FIG. 7D illustrates a method 782 related to the integration of a social media platform 714 and the code management server 702. Social media commerce is known as the process of merchants providing a product catalogue to a social media platform 714 like Instagram and Facebook and then enabling advertisements on the social media platform 714 where users can purchase products while staying on the social media platform 714. In other words, users don't transition to the merchant server 126 to purchase products. This way, the user can purchase a product and continue to scan through a news feed, for example.

The new structure that relates to this disclosure with respect to social media is that when a purchase is made by a user on a social media platform of a product, the social media platform 714 or the code management server 702 can store data about the association of the first buyer 101 and the first product 102 purchased on the social media platform 714. The first buyer 101 in that case can be given the option to do a personal posting on their stories, news feed, messaging or any other communication channel or type of posting on the social media platform 714. The posting can be about how they purchased this lamp, or this pair of shoes and they love them. Right now, social influencers make money based on how many followers they have. The more followers, the more money they make when they make a posting about a product. However, under this approach, if the social influencer has purchased the product (and in some cases even if they have not), the posting has the stored data about the posting person who is the first buyer 101. Then, every other person that purchases the product from that posting causes a separate benefit to be provided to the first buyer 101 who made the posting. In this regard, users may click on an item in the posting or a buy button associated with the posting and be able to make social media commerce purchase by remaining on the social media platform 714 to complete the purchase, and the social media platform 714 and/or the code management server 702 can cause the benefit to be provided to the social influencer and first buyer 101 for each individual sale.

The method 782 can include receiving data that a first buyer 101 has purchased a first buyer 101 on a social media platform 714 (784), storing data associating the first buyer 101 with the first product 102 (786), posting a personal post from the first buyer 101 featuring the first product 102 (788), receiving a purchase of a second product 128 from a second buyer 122 who interacted with the personal post from the first buyer 101 (790), and granting a benefit to the first buyer 101 based on the second buyer buying the second product 128 based on an iteration with the personal post featuring the first product 102 (792).

This approach can easily integrate into existing social media commerce processes while enhancing the incentives of individuals who perhaps are not formal social media influencers to purchase products on social media platforms 714 and share their experience because they may be able to benefit from individual sales rather than being paid to have a million followers. The disclosed approach encourages the billions of regular social media users to purchase products using Facebook Shops or Instagram Checkout and then share their purchases without the need of having huge followings or arranging or contracting with merchants for payments per post based on how many followers they have. Users just need to register a payment account to obtain benefits for second buyers 122 purchasing second products 128 off of the first buyer 101 personal post.

From the merchant server 126 standpoint, the merchant server 126 can provide a product catalogue to a social media platform 714 and receive data regarding the first purchase of the first product 102 by the first buyer 101. The merchant server 126 or merchant can be registered with the code management server 702. The merchant server 126 through the advertising process on the social media platform 714 may provide a suggestion or opportunity for the first buyer 101 to register their payment account on the code management server 702 to take advantage of the ability to benefit from later purchases through their influence. The first buyer 101 then posts a personal posting on the social media platform 714 or sends a communication to the second buyer 122 who purchases the second product 128. The merchant receives the order for the second product 128 from the second buyer 122 and enables or through the user of the code management server 702 offers the benefit to the first buyer 101 as a reward for promoting the product or being a salesman or promotor of the merchant products. The first buyer 101 can redeem the benefit by using the registered payment account 136 at the merchant server 126 or point-of-sale 108 where a discount or other benefit can be provided.

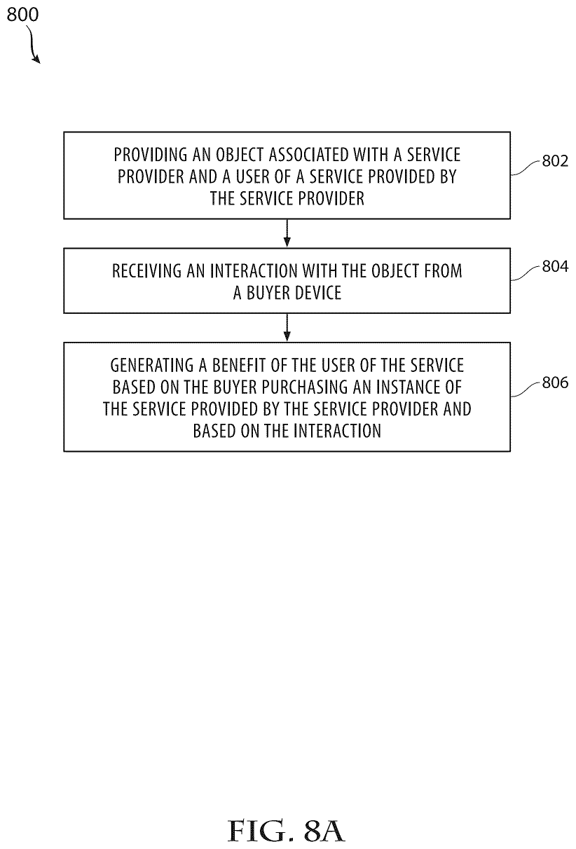

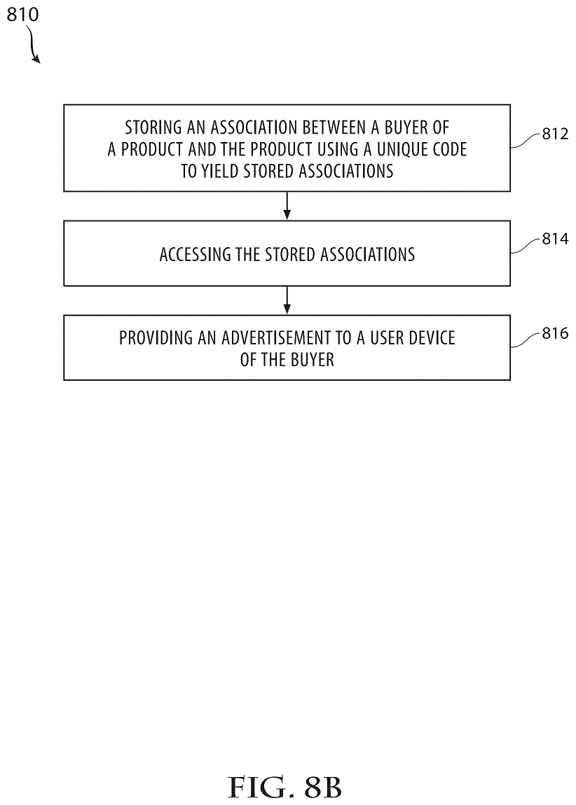

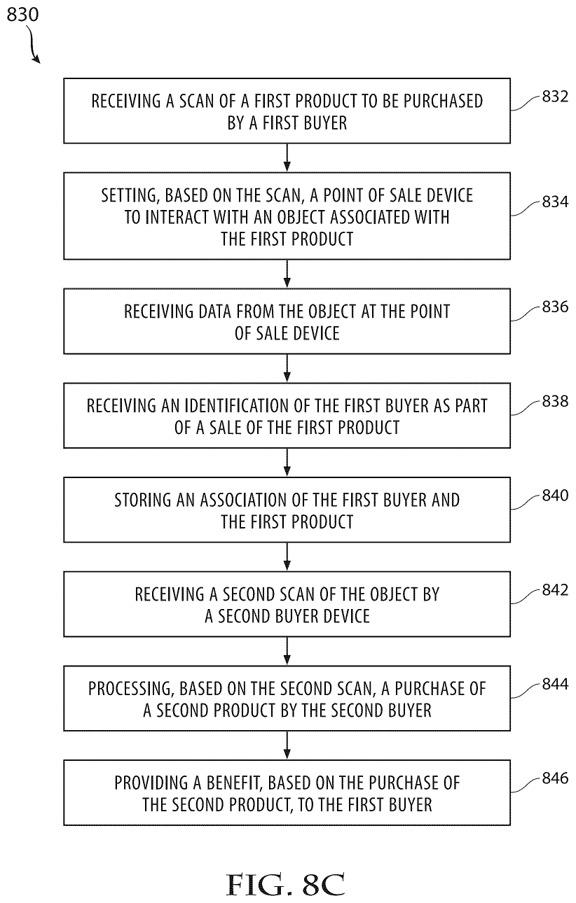

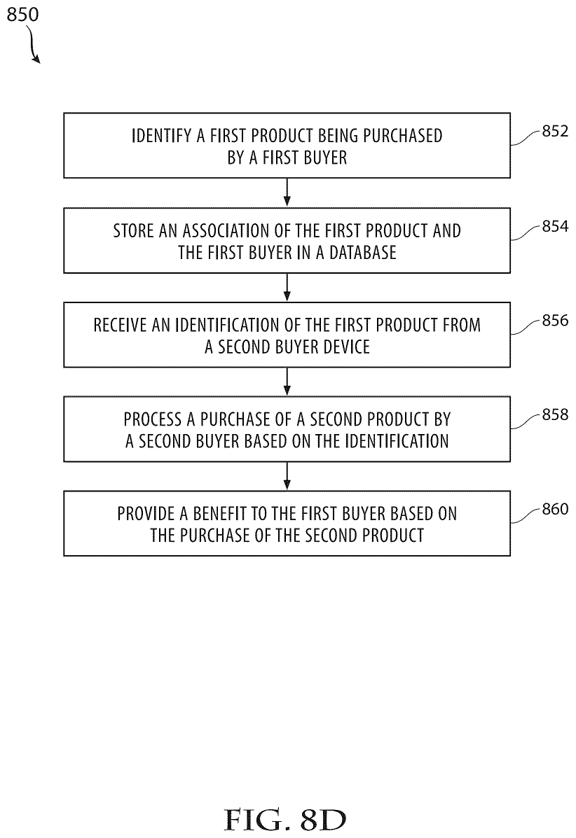

FIG. 8A illustrates another aspect of this disclosure related to referrals. In this example, the first buyer 101 is one who is not specifically purchasing a product but perhaps uses a product or service of a merchant. For example, a handyman, or a dentist or doctor might desire to take advantage of this disclosed system but they don't necessarily have product that an object 106 can be attached to. This disclosure includes the idea of enabling a website or application of a service provider to have a referral object included that is clickable. The first buyer 101 in this case uses the services of a dentist and desires to refer the dentist to the second buyer 122. The first buyer 101 can go to the dentist website and click on the referral object. What happens in that case is that an object 106 is generated such as a graphical code that includes information about the service provider (dentist) and the referring person (the first buyer 101). The object 106 can be delivered to a virtual wallet 502 of the first buyer 101 for storage. Then, when the first buyer 101 desires to refer the dentist to their friends, the second buyer 122 who is the friend only needs to scan the referral object in the virtual wallet 502. Then, the first buyer 101 can receive a benefit such as a free cleaning for the referral or some other benefit.

The code management ecosystem 700 can manage the process for the service provider as one of the potential business models.

FIG. 8A illustrates this approach. A method 800 can include providing an object associated with a service provider and a user of a service provided by the service provider (802), receiving an interaction with the object from a buyer device (804), generating a benefit of the user of the service based on the buyer purchasing an instance of the service provided by the service provider and based on the interaction (806). The object can be a graphical object presented on an application or website of the service provider that user of the service can interact with to receive in a virtual wallet 502 or otherwise a graphical object which can then be scanned by a buyer of the service (e.g., a friend of the user of the services of a dentist or builder). The user of the service can also receive in another case an NFC tag that they can use to share referrals of the service to family and friends.

Another aspect of this disclosure relates to advertisements and notices sent to people registered in the purchasing service 117 or the code management server 702. For example, benefits provided to the first buyer 101 may have a timed component. The first buyer 101 may can get a benefit for a year if a second buyer 122 purchases a second product 128. The first buyer 101 may get a notice that the first product 102 is on sale thus if they share with a friend, the first buyer 101 can be an extra benefit which is available for two weeks. The benefits may go up or down and the first buyer 101 can get notices to be aware of the deals and their benefit status. For example, a notice might be: “You can get an extra 5% if you share with a friend now-we are trying to move our backpack and camping supply inventory this weekend”.

In another aspect, the benefit as noted above may change to a different product. If the first buyer 101 is no longer available, the purchasing service 117 or the code management server 702 can simply adjust what the second product 128 is. The second buyer 122 may be brought to a checkout page when they use their phone to scan the object 106 with a next generation device or an updated product or even a different product depending on the desires of the merchant.

Advertisements to users can become much more tailor using the business data gathered through the disclosed principles. For example, an advertising service may provide ads based on one or more of a location of the first buyer device 114, data in the product wallet 520, a location of the second buyer device 120, a location of the first product 102 or the second product 128 and so forth. An ad could be individual such as: “You bought a lamp, now a couch is on sale from the merchant this weekend that will match that lamp”. There is business intelligence available which can help determine targeted advertising for the first buyer 101 or the second buyer 122. Recall notices can be provided to individuals on recalled products.

FIG. 8B illustrates a method 810 of advertising using the business intelligence data associated with the disclosed ecosystem. The method 810 includes storing an association between a buyer of a product and the product using a unique code to yield stored associations (812), accessing the stored associations (814), and providing an advertisement or a message to a user device of the buyer (816). The advertising can include instructions or data about a sale of the product to encourage the buyer to share or encourage a friend or other person to scan an object 106 configured on the product using a second buyer device 120 to purchase a second product 128. The advertisement may be a message about the product such as warranty information, or information that there is a new version of the product or a software upgrade.

Further, a second buyer 122, who might be connected through the first buyer 101 via a social media platform 714, can receive an advertisement to go to the first buyer 101 and buy the product by scanning the object 106 on the bottom of the lamp. A network might receive data about what the second buyer 122 was talking about to a friend, identify that they are interested in the first product 102, and transmit to the second buyer device 120 an advertisement to go buy the product by scanning the object 106 on the first buyer's backpack or shoes, etc. The advertisement can say that the first buyer 101 gets a benefit if you buy it from them. The message can notify the second buyer 122 that they don't need to go to a store to preview the product, they can just go to their friend. Such advertising or messages can also be sent to both the first buyer 101 and the (potential) second buyer 122. One benefit of this approach is that it can help bring people together around the products they love.

In general, the brick and mortar store has been pushed out into the world and whatever product one might be interested in could be found perhaps at a friend's house and easily bought with a benefit provided to your friend. In another aspect, users could approve of the system sharing their information about the products they have purchased to people who do not know them but who also want to buy their own copy of the product. Such people can be confirmed as safe through a number of approaches such as credit history or other safety mechanisms. But a social media platform 714 could be used to introduce people to each other who share the same interests. The first buyer 101 in this scenario would be motivated to meet new potential second buyers 122 because they get benefits of the second buyer 122 purchases a second product 128 from them.

Amazon search results could change where not only could one buy the product immediately, but Amazon could also let the buyer know that their friend John has these shoes if the first buyer 101 wants to go see them. The first buyer 101 could message John right from the checkout page and go see the product before buying. Then, the second buyer 122 could just buy the shoes direction from the object 106 configured on the product of the first buyer 101. There could be a coordination between the fact that the second buyer 122 searched on Amazon or any merchant and that the second buyer 122 bought the product from their friend who was the first buyer 101. For example, a discount code could be entered and the second buyer 122 could indicate via interacting with a visual object 106 that they are going to buy from the object 106 configured on John's shoes. The discount could then apply without needing to do any other interaction. There could be a tie in with the fact that the second buyer 122 started their search online or in an application and were then directed to the friend (the first buyer 101) with the product so that the second buyer 122 can see the product and then easily buy a second product 128.

In some aspects, the principles disclosed herein can apply to clothes. People may see a shirt, dress, pants or shows on a friend and desire to have the same clothing. To enable a second buyer 122 to buy the same item of clothing from a first buyer 101, the clothing can have an NFC tag sewn into a sleeve, or a pocket, or on a hip of some pants or the knee. A small cavity can be created in the clothing where the NFC tag can be inserted. A logo can be sewn over the cavity to inform the second buyer 122 where to use their phone to scan for the data from the NFC tag. Of course, a visual object 106 can be used as well. In some cases, the first buyer 101 could order the clothing online and choose the location of the object 106. They may desire different locations and when the clothing is made, the object 106 can be placed where they choose.

When buying online, the first buyer 101 can be associated with the object 106 and that data can be stored in the database 118 in order for a second buyer 122 to scan the object 106 and choose their size, color or other characteristics and purchase the clothing.

At a point-of-sale 108, when the clerk or user scans a UPC symbol 104 for the first product 102, the purchase process can adjust. For example, when using Apple Pay, the clerk brings the purchasing process to a state where a point-of-sale device 112 to be ready to receive payment from a mobile phone. The first buyer 101 then brings the first buyer device 114 to the point-of-sale device 112 to pass the payment token to the system. Here, the clerk could bring the purchasing process to a state where the NFC tag on the clothing is scanned or brought close to the point-of-sale device 112 to receive the code or data on the NFC tag which can then be connected to the first buyer 101 in the database 118. A point-of-sale scanner 110 can be used where the object 106 is visual. Thus, the existing devices at many points of sale 108 locations can be reprogrammed to make the connection between the first buyer 101 and the first product 102.

FIG. 8C illustrates a method 830 of selling a product. The method 830 can include receiving a scan of a first product 102 to be purchased by a first buyer 101 (832), setting, based on the scan, a point-of-sale device 112 to interact with an object 106 associated with the first product 102 (834), receiving data from the object 106 at the point-of-sale device 112 (836), receiving an identification of the first buyer 101 as part of a sale of the first product 102 (838) and storing an association of the first buyer 101 and the first product 102 (840). The object 106 can be an NFC tag or a visual code like a QR code 507. The method of FIG. 8C can work for clothing but also is not limited to the first product 102 being clothing.

The method can further include receiving a second scan of the object 106 by a second buyer device 120 (842), processing, based on the second scan, a purchase of a second product 128 by the second buyer 122 (844) and providing a benefit, based on the purchase of the second product 128, to the first buyer 101 (846).

Receiving the identification of the first buyer 101 can occur through a modification of existing payment processes like Apple Pay or Google Pay in which when payment is provided at the point-of-sale or online, data about the person and/or their payment account (if they are registered with the purchasing service 117) can be obtained and associated with the object. The approach turns every first buyer 101 into a salesperson or evangelist for the product.

In some aspects, an article of clothing can be claimed. The article of clothing can be made with an object 106 configured thereon that represents or stores a unique number or code for that particular article of clothing such that in connection with a sale of the article of clothing, the unique number or code is associated with the first buyer 101 of the article of clothing. The association is stored in a database 118 such that as the first buyer 101 is wearing or showing the article of clothing to a friend or other person, the other person can become a second buyer 122 by scanning the object 106 to obtain the data contained within the object 106 which can cause the second buyer 122 to land on a checkout page of a merchant server 126 and tailor the article of clothing to their own needs (size, color, shape, other accessories, etc.) and purchase a second article of clothing. The first buyer 101 then receives a benefit when the second buyer 122 buys the second article of clothing. The object 106 can be an NFC tag configured in a compartment on a sleeve of a shirt or sweatshirt or suit, or a compartment n a belt or dress. The location of the object 106 can also be selected by the first buyer 101. When the second buyer 122 also buys an article of clothing, they can choose the location of the object for their clothing. The object 106 of the second buyer 122 that is configured on the second clothing will also identify the family history in the database 118. A third buyer, in other words, that buys a third article of clothing from the object 106 on the second article of clothing, might trigger a benefit not only to the second buyer 122 but also to the first buyer 101 depending on what the structure is arranged by the merchant.

Some merchants may want to leverage a family tree of purchases to provided multi-level benefits or multi-level social media interactions based on tracking the family history of the purchases.

FIG. 8D illustrates another method 850 according to an aspect of this disclosure. An apparatus can be configured to perform the method 850. The apparatus can be configured to identify a first product being purchased by a first buyer (852); store an association of the first product and the first buyer in a database (854); receive an identification of the first product from a second buyer device (856); process a purchase of a second product by a second buyer based on the identification (858); and provide a benefit to the first buyer based on the purchase of the second product (860). The association of the first product and the first buyer can be performed via use of a graphical object associated with the first product.

In some aspects, the graphical object is transmitted to a first buyer device for storage and later scanning. The method 850 can further include the apparatus being configured to record on a blockchain network data confirming the association of the first product and the first buyer.

In some aspects, the method 850 can further include the apparatus being configured to print, at a point-of-sale, a physical object showing a graphical object that associates the first buyer and the first product. In some aspects, the identification of the first product from the second buyer device occurs via the second buyer device scanning a graphical object on the first product by a camera on the second buyer device.

In some aspects, the method 850 can further include the apparatus being configured to access a purchasing service based on the second buyer has scanning the graphical object onto the second buyer device, wherein a purchasing service retrieves the association of the first product, the first buyer and the graphical object in the database to identify the second product and to identify the first buyer to provide the benefit to the first buyer.

In some aspects, the identification of the first product from the second buyer device occurs via one or more of receiving a scan of the graphical object physically from the first product, receiving a scan of the graphical object from a display of a first buyer device, receiving a communication at the second buyer device from the first buyer device, or receiving a scan of the graphical object from a social media posting of the first buyer.

In some aspects, wherein the communication comprises a message, a voicemail or email.

In some aspects, a system or apparatus is disclosed the system can include a processor; and a computer-readable memory storing instructions which, when executed by the processor, cause the processor to be configured to: identify a first product being purchased by a first buyer; store an association of the first product and the first buyer in a database; receive an identification of the first product from a second buyer device; process a purchase of a second product by a second buyer based on the identification; and provide a benefit to the first buyer based on the purchase of the second product.

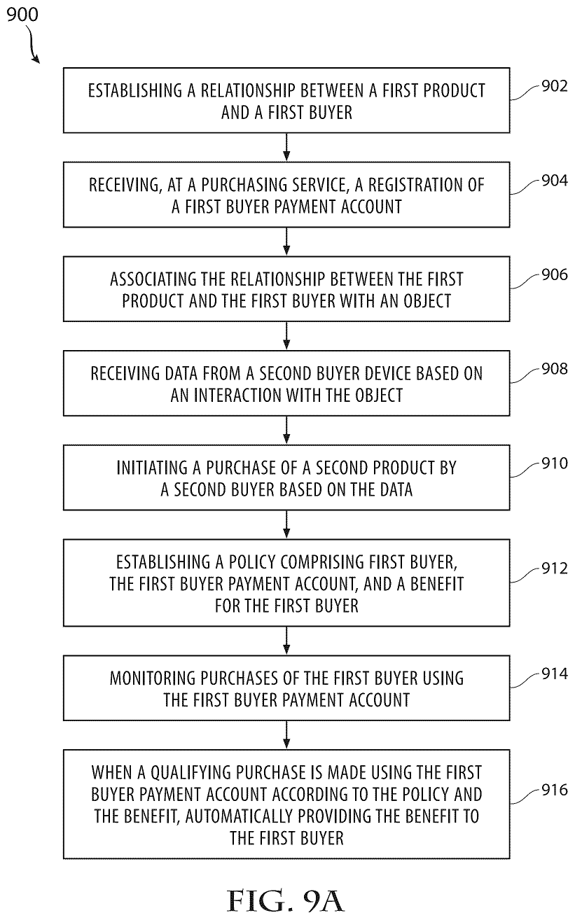

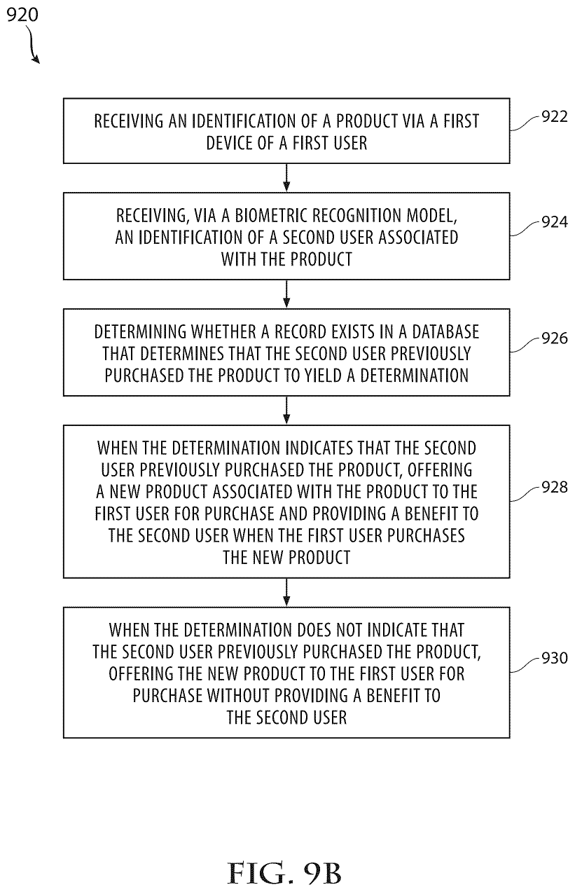

FIG. 9A illustrates a method according to an aspect of this disclosure. The method 900 can include one or more of the following steps in any order: establishing a relationship between a first product and a first buyer (902), receiving, at a purchasing service, a registration of a first buyer payment account 121 (904), associating the relationship between the first product and the first buyer with an object (906), receiving data from a second buyer device based on an interaction with the object (908), initiating a purchase of a second product 128 by a second buyer 122 based on the data (910), establishing a policy 134 comprising first buyer, the first buyer payment account 121, and a benefit for the first buyer 101 (912), monitoring purchases of the first buyer using the first buyer payment account 121 (914), and, when a qualifying purchase is made using the first buyer payment account 121 according to the policy 134 and the benefit, automatically providing the benefit to the first buyer 101 (916).

In one example, the policy 134 might indicate that when the first buyer 101 makes another purchase at the merchant from which they bought the first product 102, the first buyer 101 gets a discount 506 or some other benefit. The approach disclosed herein combines the ability of the second buyer 122 to easily buy a second product 128 from the merchant based on an interaction with the object 106 and to establish automatically the policy 134 and the monitoring of the purchases of the first buyer 101 using the first buyer payment account 121 for a qualifying purchase (i.e., such as a purchase from the same merchant) to then automatically pay a rebate, or cause a price reduction for the second transaction at the merchant by the first buyer 101, or any other benefit.

The monitoring can occur with an association or connection to credit card and debit card companies or other companies that manage payments. The policy 134 can be used to monitor the purchases using the first buyer payment account 121 such that the right purchase at the right merchant can trigger the automatic implementation of the benefit however it is designed. In one example, the benefit might be for a specific product that is purchased at the merchant or another merchant. When that product is purchased, then the benefit is granted (such as a discount or a feature being activated on the product, etc.). The purchasing service 117 or other service can continuously monitor the purchasing activity so as not to miss a qualifying purchase according to the policy 134.

FIG. 9B illustrates another aspect of the idea. Here, the focus is on facial recognition of the first buyer as mentioned above. The present disclosure relates to an improved method of providing a benefit to a person who bought a product when a friend also buys the same product for themself.

There is a challenge in selling products where one can use an artificial intelligence model to analyze an image and can identify a product in that image. Current technology, such as through Amazon, enables a person to purchase that product through Amazon.com as the person can be brought to a one-click purchasing state. There are some unexplored advantages that could be obtained in this process.

The present disclosure addresses weaknesses or unexplored benefits when a user purchases a product that is identified outside of the merchant store and “in the wild.” The unexplored benefit is how can a system be configured to grant a benefit to the first buyer of the product? For example, Joe buys a pair of shoes at the store and wears them to school. Amy sees the shoes and likes them and wants a pair for herself. She can scan the shoes (take a picture with her phone) and an AI model can analyze the image and identify the pair of shoes. This process is problematic. There is no mechanism to tie that purchase to Joe as the context or means by which she makes the purchase. Amy can then interact with a user interface to make some decisions regarding the shoes such as size, color, etc. and can proceed to purchase the shoes and have them delivered to her home.

What is missing is the ability of Joe to get any benefit for being the one to prompt Amy to want to buy the shoes. He is the catalyst for that purchase but gets no benefit. This is a problem rooted in computer technology in that the current payment infrastructure (i.e., credit card payments, Apple Pay, Google Pay, Samsung Pay, Paypal, etc.), payment systems do not provide any mechanism to enable Joe to get a benefit.

However, the present disclosure accomplishes a simplified mechanism and infrastructure to enable Joe to get some kind of benefit. The benefit might be a discount at the merchant or a discount from a manufacturer of the shoes. It may be a coupon or credits, points, miles, or any other benefit. What happens is that when Joe purchases the pair of shoes, in some mechanism, a database record is established which identifies that Joe has purchased the pair of shoes. The data in the database may be general as to the kind of shoes, the color, the size, or any characteristics of the pair of shoes. Joe's identity may come through an application, or may come from a special API that provides Joe's identity in connection with the purchase to a server (with the merchant or third party) based on an electronic payment such as Apple Pay, Google Pay, credit card payment, and so forth. In general, at the time of sale, Joe is associated with that pair of shoes in a database.

With that database set up, as Joe walks around with the shoes, as noted above, Amy can take a picture of the shoes and the AI model can identify the shoes. But that alone does not connect those shoes with Joe. After Amy identifies the shoes, she can also take a picture of Joe's face or can scan his face with her phone or his phone. An AI model can analyze that picture and through that image, can identify Joe. Now the system has both an identification of the shoes and an identification of Joe. An API call or a query can be provided to the server operating the database of people who purchased the products. When a confirmation occurs that Joe had purchased that set of shoes or a similar set of shoes, then the system can not only process the sale of a pair of shoes to Amy but can also provide a discount or benefit to Joe as well to pay him for sharing the shoes. This approach simplifies the process where the point-of-sale connection between Joe and the pair of shoes is more automatic and does not require a separate code or unique individual image for each product.

The approach, for example, could work with a company like Amazon where they have records of all the purchases of its users. Thus, if Amy is using an Amazon application or website, scans or identifies the shoes and then through an image of Joe, identifies Joe, then Amazon can present a graphical user interface in a “one click purchasing scenario” where it states that Amy can purchase the shoes (in her size) and can confirm that she is buying them based on Joe and that Joe will receive a 10% discount on his next Amazon purchase, or a 10% discount on his next pair of shoes from the merchant that sold the first pair of shoes.

Where merchants are not all under the same umbrella company like Amazon, a service organization could store product purchase data for users from various merchants and an application could be used to query that database and manage the process across disparate and unrelated merchants. An API could be set up for each merchant to use to provide data to the database and to receive information regarding discounts to offer to specific users. For example, an application could capture (Via an AI model) an identification of a pair of shoes on a person and then identify the person who is wearing the shoes. An API call to a service at Amazon.com or another service could be made by the application to determine if that person owns or previously purchased those shoes. If yes, the API could return a confirmation that yes the person did buy the shoes. Then, if the Amy also buys a pair of those shoes, then a benefit can be presented to Joe because the transaction arose based on a connection with Joe to the shoes. The solution is rooted in computer technology and is grounded in a weakness in current sales systems where any known connection between a user and the products they purchase is not leveraged for additional value. The current electrical systems that process payments do not provide this kind of service to enable the first buyer to get a benefit when a second buyer buys the same (or similar or related) product.

Amy could also identify the product from a UPC symbol or any graphical object such as a QR (quick read) code that can be used to identify the product. However, to simplify the process, identifying Joe is preferably done via a facial scan (or other biometric or password or passcode procedure of identification) but could also be done through a user interaction in which Amy, for example, could scan the shoes and then input into a data input field or in any unimodal or multimodal interface information to identify Joe. Autocomplete or suggestions for Amy could be provided (i.e., to narrow down searches for her) based on her social media village (her social media friends), the identification of the shoes (which could be dynamically compared to a database of her friends for which friends bought those kinds of shoes). In this manner, the system can easily get a confirmation of Joe as the first buyer of the shoes so that can get the discount.

In another aspect, a user could scan for a product through AI or a UPC symbol or even simply searching for jeans or the product on a service like Amazon. Then, the user Amy could pull up via an application or App Clip or other means the name of their friend Joe who bought the jeans and a confirmation email or text could be sent to Joe to confirm that they purchased the product before and are the connection to this current purchase by Amy. Thus, the connection could be made dynamically. AI in this case could be used to confirm that an image was taken with Joe's face and with the product as well. Thus, if a confirmation could exist that the two items (Joe and the product) are in the same image, then a separate database of purchasers and products may not need to be created. Fraud could be an issue in this case and so other fraud-detection approaches could be added such as a confirmation that Joe made a purchase at a store that sells the type of product in the picture.

As noted in the referenced patent application incorporated above, the benefit can be redeemed through a process run by a company called “Giftya” (see giftya.com) and those processes of setting up a policy connected to Joe's existing payment account (i.e., Visa, Mastercard, Debit, etc.). The policy can identify the benefit (10% discount, $5 off a pair of Shoes, etc.) and/or the merchant (Target) or a manufacturer (i.e., Nike) and when Joe uses his existing payment account to make a purchase according to the policy, a monitoring service or monitoring engine can capture that qualifying purchase and cause the benefit (i.e., a payment credit) to be applied to that purchase or provided to his payment account and so forth.

Therefore, the system that implements these principles can coordinate with existing payment rails and/or benefit structures to provide a payment credit or benefit to Joe for sharing his shoes with Amy. The approach can cause individuals like Joe to be more likely to share products they like with their friends.

In some cases, a buyer (Joe) might authorize the use of his purchasing history for the limited use or accessibility by the merchant, or a service, such that queries can be made against a merchant database of purchases by individual people. Then, a service entity can enable users to access via a browser, an App Clip, or a downloaded application the camera to take images of products and people and to combine that two pieces of information, facial data and/or product data and either user an internal database or an external third party database to query product/purchaser records to see if a benefit should be provided to Joe (the first buyer) when Amy (the second buyer) buys a product based on a personal interaction with the first buyer. No entity or network infrastructure currently exists that enables this functionality and possible capability.

In some aspects, an application or app clip or website accessed via a browser can manage the user interactions to take one image using the camera of a mobile device. Data from the image can include one or more of facial data, any biometric data such as a fingerprint, product data, or a combination of both. A user may confirm that the proper product is highlighted and/or the right face has been recognized. The application may use data or an AI model on the mobile phone or on a remote server to identify a product and/or a person. The application may guide the user to take two pictures-one of the product (such as pair of shoes or a lamp) and then a photo of the user or the owner of the product. The application can again either use an AI model to identify the product and/or the person or may send the image to a remote AI model that is more powerful to identify the product and the user from one or more pictures.

‘The application, once the product and the person are identified, can enable the person taking the picture to purchase their own product (their own pair of shoes or lamp, etc.). The user interface can have graphical information identifying the first buyer as getting a benefit for being the means or the catalyst for the second buyer to buy the product. The second buyer can purchase their own copy or version of the product (which might include them also choosing a proper size, color, shape, or other related parameters associated with what they want to buy that is related to the product) and confirm that a benefit should be provided to the first buyer.

The process may also include the first buyer on their mobile phone getting a notification of the benefit or a confirmation that they did in fact purchase the product (or were given the product as a gift in some cases and thus are associated with the product) and that they are the proper person to receive a benefit.

Embodiments of this invention can be claimed from the standpoint of an application on a mobile device, a remote or network-based server, an AI model configured on any device or a combination of devices that perform different operations such as presenting a graphical user interface and managing the user input and data input (i.e., from the camera of a mobile device) and another device operating a powerful AI model that can be used to identify products and/or people from one or more images.

In another aspect, Amy may scan or take an image of the shoes and have them identified for her to make the purchase. As her identity would be known because she is scanning from her phone, a database can be accessed which includes data about her social media circles, friends, family, etc. That database may determine which of her friends (which can include Joe) has purchased these shoes and ask her to simply confirm that she is with Joe. Joe's phone location can also be used to determine proximity. An application or service can infer based on one or more of the database, Joe's phone location as a friend of hers, and/or other data, that she is with Joe and that the shoes she is looking at are Joe's shoes. In that case, she may simply look at her checkout flow on her phone and with that data accessed, the checkout flow may include a box to check that asks-did you buy these because of Joe? The connection is inferred but then confirmed through a simple checkout flow with Amy. In this simplified process, Joe only needs to buy the shoes from a company that can connect him directly with those shoes and include that connection in a database that can be accessed directly, or included to a service that identifies people's social media circles (like Facebook) so that when the identification from Amy occurs of the product, one or more databases can be accessed to identify to a certain level of probability who Amy is with and who had purchased the product previously. Then, the new purchase by Amy can proceed with a benefit being provided to Joe as the mechanism by which Amy made the purchase herself.

In FIG. 9B, a method 920 can be performed by a server, computing device, mobile device, point-of-sale device, or any combination of these components and/or any computing component disclosed herein. The method 920 can include receiving an identification of a product via a first device of a first user (922). Receiving an identification of the product can occur from a scan via the first device of a visual object attached to or associated with the product or an artificial intelligence model analyzing an image of the product.

Method 920 can further include receiving, via a biometric recognition model, an identification of a second user associated with the product (924). The biometric recognition model can include one of a facial recognition model and a fingerprint recognition model. Other models such as eye recognition can be used as well.

Method 920 can further include determining whether a record exists in a database that determines that the second user previously purchased the product to yield a determination (926). The database stores data identifying that the second user purchased the product at a time the second user purchased the product. In some aspects, the database stores data identifying that the second user purchased the product by, when the product is purchased by the second user, a scan of a visual object on the product and an identification of the second user is stored in the database. In some cases, the visual object can include one of a QR code or a UPC code.

Method 920 can further include, when the determination indicates that the second user previously purchased the product, then: offering a new product associated with the product to the first user for purchase and providing a benefit to the second user when the first user purchases the new product (928). In some aspects, the benefit to the second user can include a credit redeemable by the second user by using an existing, open-loop, payment card of the second user at a merchant that sold the product to the second user. In other aspects, the benefit to the second user is redeemable via an establishment of a policy associated with an existing, open-loop payment card of the second user, wherein the policy defines one or more of an amount of a redemption credit, a manufacturer, a type of product, a merchant, a time frame, and product information and that defines how the second user redeems the redemption credit by making a purchase using their existing, open-loop payment card in connection with making a second purchase after making a first purchase of the product. The redemption credit can be offered by one or more of a manufacturer of the product or a retail merchant who sells the product.

Method 920 can further include, when the determination does not indicate that the second user previously purchased the product, then: offering the new product to the first user for purchase without providing a benefit to the second user (930).

The method 920 can further include transmitting an electronic notice of a device of the second user notifying the second user of the benefit and how to redeem the benefit.

A system can include at least one processor; and a computer-readable storage device storing instructions which, when executed by the at least one processor, cause the system to be configured to: receive an identification of a product via a first device of a first user; receive, via a biometric recognition model, an identification of a second user associated with the product; determine whether a record exists in a database that determines that the second user previously purchased the product to yield a determination. The system, when the determination indicates that the second user previously purchased the product, can then: offer a new product associated with the product to the first user for purchase; provide a benefit to the second user when the first user purchases the new product. When the determination does not indicate that the second user previously purchased the product, then the system can offer the new product to the first user for purchase without providing a benefit to the second user.

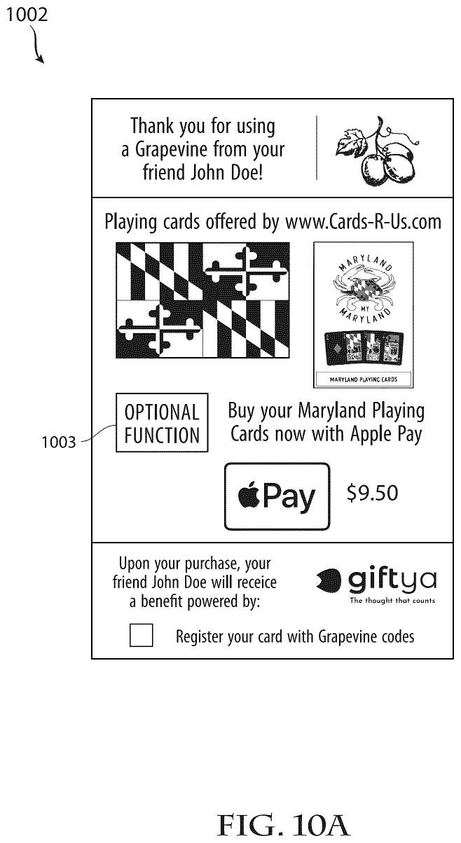

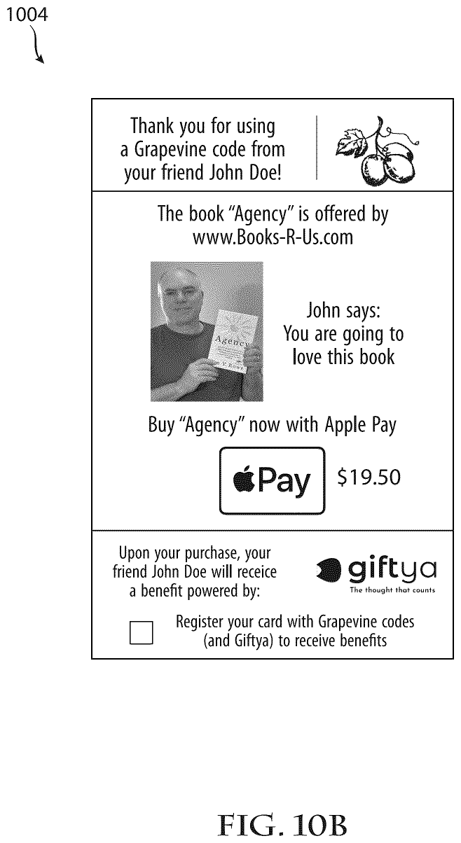

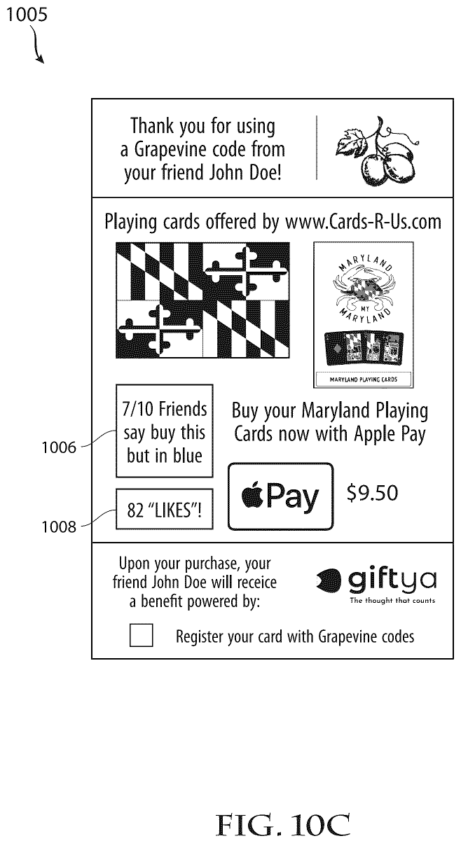

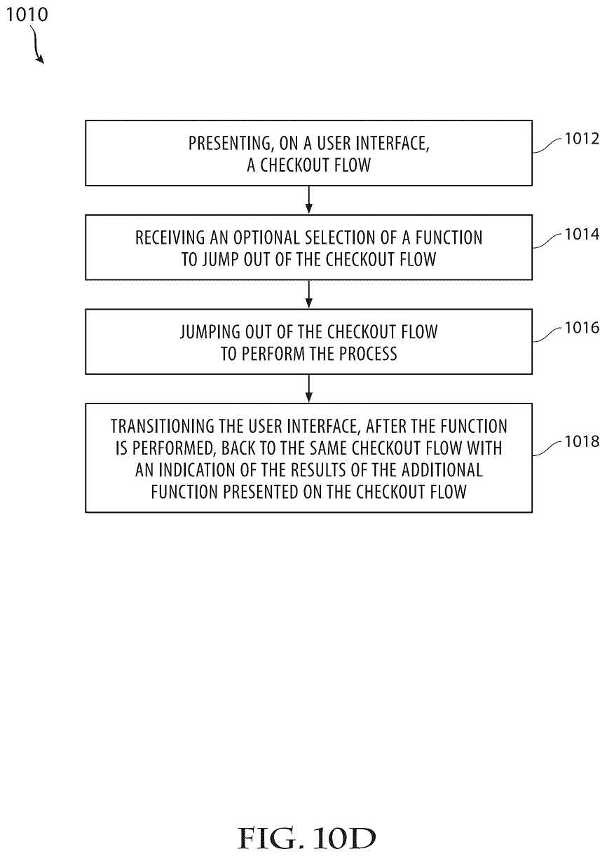

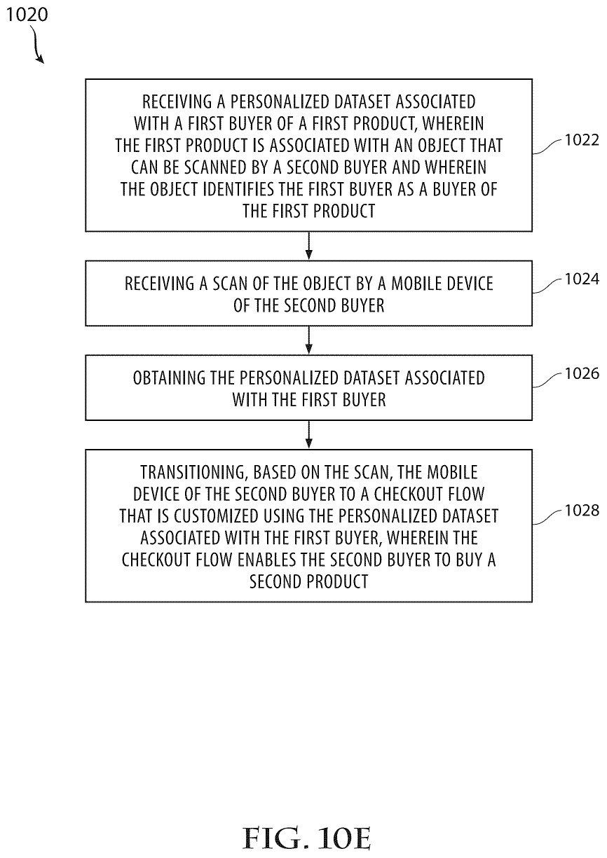

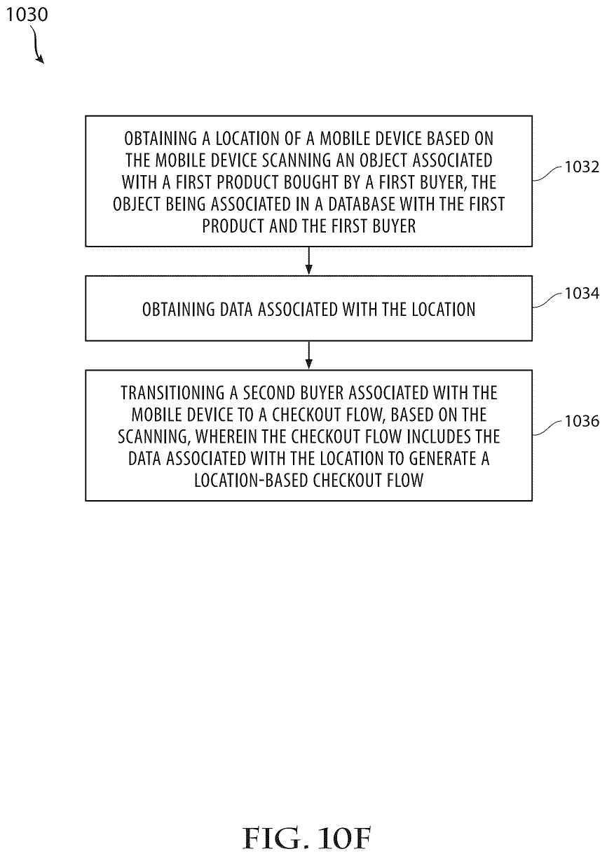

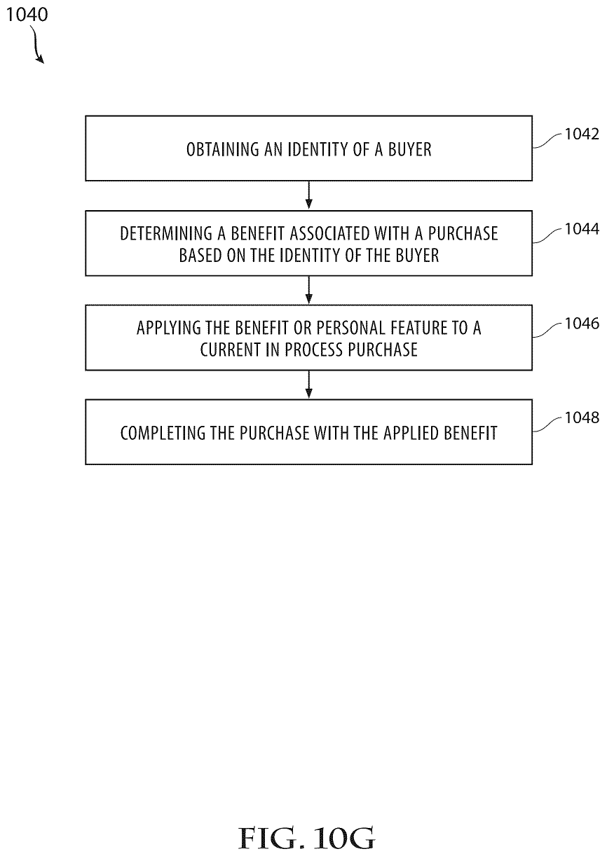

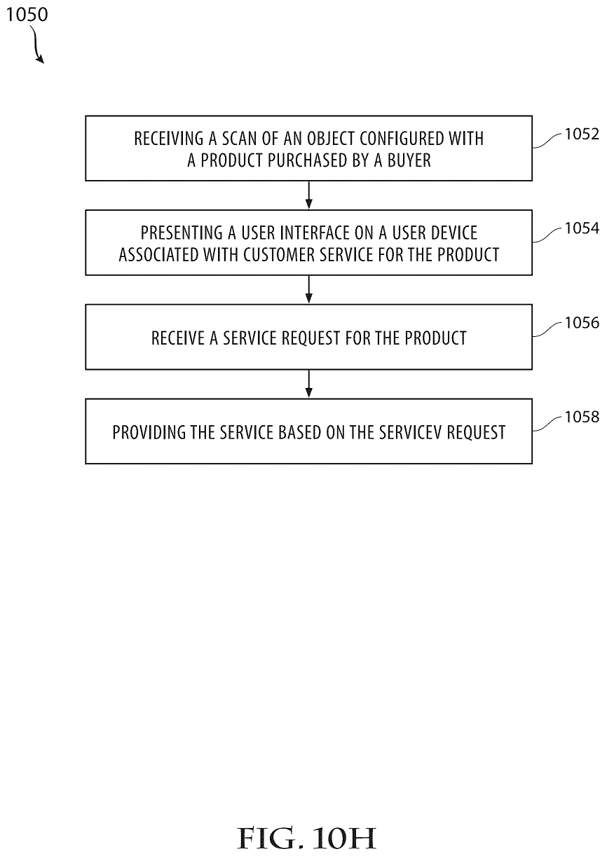

FIG. 10A shows a checkout flow or checkout page 1002 which is generated according to a certain process. As disclosed in the incorporated application, a first buyer buys a product that is associated with or physically includes an object like a QR (quick reference) code or a near-field communication (NFC) chip or tag. The data in the object is connected to or associated with the first buyer buying the first product. Assume the first product is a deck of cards featuring the state flag of Maryland. The first buyer is John Doe. At a point-of-sale or from a purchase online, the QR code (which can be unique for the specific first product or deck of cards) is scanned or identified and associated with John Doe as the first buyer. On the deck of cards is a QR code that, when later scanned by a friend John Doe using a mobile device like an iPhone, causes John Doe to be transitioned into a checkout page from the merchant who sold John Doe the first product. The checkout page can be customized. Note that the name John Doe is integrated into the checkout page 102 that is shown on the mobile device of John Doe.

The object on the deck of cards that is scanned can access a program flow on a network server that not only directs the user directly into a checkout flow, but can configure a personalized checkout flow for the second buyer of a second product (a second deck of Maryland cards). For example, the object can send the mobile device to a network server operating a service that provides the functionality disclosed herein. The network server can access data about John Doe, data about the product, obtain a universal resource locater (URL) provided by the merchant, construct or insert data such as the name John Doe, or provide data values to the merchant, and then redirect the flow to the merchant checkout flow as shown in FIG. 1A with a configured checkout that features the product, the name of John Doe as the known friend from whom John Doe is purchasing the product, an ability to pay using payment mechanisms like Apple Pay or any other mechanism, as well as an option to register a credit or debit card with the service to be able to participate as well.

An optional function 1003 is shown as a selectable object. The optional function configured within the checkout flow enables a system to offer jump-out options for other functionality. For example, the user may desire to get some feedback from friends before buying the set of cards, or the style of shirt or the color of the coat. Here, the optional function could be to survey on social media the purchase before completing it. In this scenario, if the user desires to get some feedback before the purchase, they can interact with the optional function 1003 which can cause a posting to be made on social media configured to obtain feedback on the purchase. A posting could say, for example, should I buy this shirt, which of these two shirts should I buy, etc. The optional function 1003, can be configured based on the product. If there are different colors for the product, the optional function 1003 can cause a user interface to be presented in which the user could configure the survey on social media so that opinions of friends can be obtained and other options (different sizes, different colors, etc.) can be offered as part of the survey. The user may not know which color of shirt to buy. After configuring the posting, the user may be able to select post to all, or they may have in a user profile certain friend groups that help with clothing decisions, interior design decisions, and so forth. The posting can then go out, the user may be able to transition out of the checkout flow, and back to normal usage of their mobile device.

After their friends have provided their feedback, the user may get a notice, text or some other notification that the results of the survey are in. In one example, the user may get a text or email indicating that a sufficient number of friends have provided input. A link can be configured in the text that enables the user to transition directly back into the checkout flow.

The optional function 1003 may, when selected, include a number of optional operations which the buyer can implement. One may be an offer to buy the actual product they just scanned rather than a new product to be shipped to the buyer. In this case, the system may implement a process of seeking approval from the first buyer of a price for the product. Once a price is agreed upon, the checkout flow can be updated to reflect the price, and the fact that the second buyer is actually buying the very product in front of them. Any licensing or registration needs can be handled by the system as well for vehicle, boat, firearm, or other purchases that might require government notification of a transfer of ownership. For example, registration or license forms can be presented to the seller and/or the buyer for electronic signature and approval for proper transfer of ownership.

FIG. 10B shows a checkout flow 104 which includes a further customization of a checkout flow for a second buyer. Assume John Doe bought a first product, a book called “Agency”. After purchasing the book, and based on what type of product is purchased, there may be an opportunity to further personalize the checkout page for the second buyer who scans an object on the book Agency which is associated with the first buyer John Doe. After buying the book and returning home, John Doe may receive a message, communication, calendar invite, or some type of notice from an application or website associated with a network service that suggests that he takes a picture of himself with the book (the first product) and if desired can provide a comment like “You are going to love this book”. Receiving such personalized data can occur at the time of sale, after reading the book, after using the product, location-based with respect to a location of the first buyer or the first product (which can be identified by the first buyer scanning the object), and so forth. There are a number of ways and timing that personalized data around the first product can be obtained.

The first buyer can provide the first data to a network service that stores that data in connection with the object configured on the first product. Then, upon the second buyer scanning the object, the data can be accessed from memory or a profile associated with the first buyer and a checkout flow can be constructed which can include one or more of the personal data items. FIG. 10B shows a picture of John Doe with the book and a comment for the second buyer. The personal data could even be obtained at the time the second buyer buys the book. For example, if John is telling Dan about the book and Dan wants one for himself, John can use his mobile device to take a picture of the two of them with the book and transmit the picture to the network service. This can be done by Dan opening up an application associated with the service or texting or emailing the picture with an identification of the product. The network service could also perform an object scan of the image to identify the object of interest. For example, if Dan has ten items with objects configured on them, and one of them is the book Agency, then as the photo was received by the network service, the service can identify that the Agency book is in the image and then associate the image with that purchase. The point here is that when Dan buys the book himself, the checkout flow like as is shown in FIG. 10B can then be populated with an image of him and John and the book for an even more personalized checkout experience.

In one example, the way of connecting a personalized picture, video, sound or other object with the particular QR code on the product or on an NFC chip configured with a product can vary. For example, the first buyer may select from a wallet or application from a group of products that they have purchased and that have codes associated with the products. The products may include a book, a backpack and a lamp in the wallet or application. The user may be hiking with the backpack and want to record a picture of the user on a mountain peak with the product. The user may have an option (like a selectable object or button) to take a picture associated with the product which can transition the mobile device to an application or a functionality of opening the camera application, to enable the person to take one or more pictures, and then save or send those pictures to a network service for storage. Later, when the second buyer scans the QR code or object on the first product, the second buyer can be transitioned to a customized checkout flow with the personalized picture of the first buyer with the first product so that the second buyer is likely to convert and buy a second product based on a more comfortable and personalized checkout flow.

In another aspect related to social media input, the checkout flow could also include a selectable object which enables the user to essentially pause the checkout flow while the user gets feedback from friends on social media. The user could be presented with a user interface that allows them to post a question about the product on their social media feed: “Should I buy this shirt?”. Or, the user could select from a subgroup that they ask for input on the type of product. Users can set up groups for clothing purchases, interior decorating purchases, car purchases, etc. The system could coordinate with a social media network like Instagram or Facebook or TikTok and present the request for likes or feedback from a group of friends. The feedback can be set for a period of time by the user or a set period of time. The checkout flow can essentially be placed on “hold” until the feedback or a certain level of feedback is received. Say the threshold is 60% respond from the group. Then, with the data about “likes” or other feedback received, the user could be placed back in the checkout flow with the feedback incorporated into the flow-in which data like 70% of your group like the purchase. The posting to the group could be configured like a survey or limited to a like or dislike option, for example, and could depend or be configured based on the product. A summary or aggregation of the likes or feedback can be incorporated into the updated checkout flow. The updated checkout flow can be presented anywhere the user is interacting. For example, the system could integrate with the social media network such that when a user selects the option (the bell) on Facebook to see what kinds of new notifications or feedback has been received on their postings, one option could be a notice that the feedback on their purchase request has been received. The user could click on the object and be placed back in the checkout flow, with the feedback incorporated therein. The checkout flow would be presented to the user and then they can buy the product. They get the positive feedback (i.e., from “likes”) similar to what users experience on social media, but it is directly found within a checkout flow.

Further, if the user has a social network that responds quickly to a feedback request about a product configured or presented in the checkout flow, then the user could stay within eh checkout flow, wait perhaps a short period of time, be presented with the feedback (perhaps dynamically with hearts graphically presented or likes being added up) and then complete the purchase. Social media images or videos could be presented briefly or persistently in the checkout flow as well. A social media member may record “get this!” and that brief video, audio, text, or other input could be presented as part of the checkout flow. Thus, the user could wait for a period of time while live user feedback is presented while they are still on the checkout flow user interface. Then the user could make the purchase at any time or after the feedback is received or aggregated. The user interface could be the user interface that such social media feedback is presented in thus enabling the user to receive that social media feedback directly in the checkout flow. The approach will make the checkout more personal than previous checkout flows.

FIG. 10C illustrates an example of a user-feedback configured checkout flow. Here, the user feedback 1006 is provided as part of the checkout flow 1005. In this example, 7/10 friends say buy this but in blue. The checkout flow can be accessed from a text, from social media (such as accessible from the bell on Facebook indicating that there is feedback available for the user), or other means.

FIG. 10D illustrates a process 1010 that involves presenting the user with a checkout flow (1012), receiving an optional selection of a function to jump out of the checkout flow (1014), jumping out of the checkout flow to perform the process (get feedback, post on social media, perform a survey, do more research on the product, etc.) (1016), and then transitioning the user interface, after the function is performed, back to the same checkout flow with an indication of the results of the additional function presented on the checkout flow (1018).

Note that this approach gives the user a more personalized checkout flow. Users can jump in and out of a checkout flow over time and it is not just a one-time configuration. The checkout flow may be presented numerous times for users and their experience with the actual checkout flow is more personalized and transitions even from device to device (such as when a user transitions from a mobile device to a desktop device, and then accesses Facebook and retrieves the updated checkout flow from the desktop device). The user feedback may just aggregate the number of like to report, for example, “82 likes!” 1008. Having the user feedback (similar to having “likes” on a social media post) makes the purchase more enjoyable for the user and confirms that they are making a good purchase, while at the same time connecting them more with their friends.

The interactions in FIGS. 10A-10D, such as being able to jump out of a checkout flow, are independent of whether the buyer is the first buyer or the second buyer. These concepts are general checkout flow concepts which may or may not be integrated in with the concepts of a second buyer purchasing a products that inures to the benefit of a first buyer.

FIG. 10E illustrates a method 1020 which can be carried out by one or more components such as a mobile device, a network service, a merchant server and so forth. The method 1020 can include one or more of (in any order), receiving a personalized dataset associated with a first buyer of a first product, wherein the first product is associated with an object that can be scanned by a second buyer and wherein the object identifies the first buyer as a buyer of the first product (1022), receiving a scan of the object by a mobile device of the second buyer (1024), obtaining the personalized dataset associated with the first buyer (1026) and transitioning, based on the scan, the mobile device of the second buyer to a checkout flow that is customized using the personalized dataset associated with the first buyer, wherein the checkout flow enables the second buyer to buy a second product (1028).

The object can include a quick response code or an NFC tag. The personalized dataset can include one or more of an image, a video, a logo, a word or phrase or a sound.

FIG. 10F illustrates another personalization example process 1030. The process 1030 can include one or more step, in any order, of obtaining a location of a mobile device based on the mobile device scanning an object associated with a first product bought by a first buyer, the object being associated in a database with the first product and the first buyer (1032) and obtaining data associated with the location (1034). For example, if the mobile device is used to scan an object on the first product and the mobile device is in the mountains, then a mountain picture can be obtained which may or may not include the first product in the picture. The process 1030 can further include transitioning a second buyer associated with the mobile device to a checkout flow, based on the scanning, wherein the checkout flow includes the data associated with the location to generate a location-based checkout flow (1036). The second buyer can then buy a second product (like another lamp or book or backpack) from the location-based checkout flow. The personalization of the checkout flow can make the experience more personal for the user and thus can lead to more conversions.

The data associated with the location can include other data such as weather conditions. For example, if it is snowing at the location, then a picture of mountains during a snowstorm might be chosen.

Artificial intelligence could also be used with one or more of the location and other input data such as data about the product to generate an artificial intelligence image or overall checkout flow as well. The first buyer or the second buyer might have some input regarding how an artificial intelligence image or video or sound generator might generate a checkout flow for the second buyer. For example, the theme might be a cartoon, or mountains, or speed, or product-based. Then, dynamically, the network system can generate images, video, sound and/or any other characteristic or aspect of the checkout flow by obtaining a stored image, the result of a social media survey or a survey in general, presenting text, creating a collage of images, or generating via AI an AI-generated image or other data to make the checkout experience more in line with the user's desires or which might make the checkout more enjoyable. Color schemes, patterns schemes, fonts, payment types (Apple Pay, Google Pay, etc.) can all be characteristics of the checkout flow that can be dynamically adjusted for an individual user.

The checkout flow can follow the user and be jumped into and out of based on the user's desire. If the user wants to do some research, they can jump out of the checkout flow and research the product via a selection 106. The user may want some feedback or may want to read some product reviews which can be accessible as a function by selection object 103 shown in FIG. 10A.

Using these concepts, the following could occur. A famous Internet influencer may desire to purchase a product and want their 100K followers to “like” if they should buy the product. The influencer could also then buy the product, have an object associated with the product as disclosed herein and in the related application. Then, the influencer could offer one of their (paid) premium followers to be able to buy the product using the object to connect that purchase of the second buyer follower to the first buyer influencer. This would connect the second buyer to the first buyer in a “family tree” of purchases that flow from the influencer purchase. The process creates a whole new marketplace concept where it is not just products that are being purchased, but products that are connected to a particular first buyer through the objects disclosed herein and which enhances or changes the value of each individual product depending on where it is in the family tree. The system that manages the functions disclosed herein can tell the story of each product and how it was purchased based on a human connection with the product or a similar product. Often, such as in historically significant products or events, this information greatly enhances the value of the product because it was connected to a famous person. The approach disclosed herein can cause such change in value and interest in a particular product based on the system tracking the connections between humans as products are sold.

Security and privacy can be an issue with respect to the disclosed concepts. For example, if a person loses a book or a shirt that has a scannable object, an unknown person may scan the object and obtain the name of the first buyer if the first buyer is immediately presented in a checkout flow as shown in the figures. Thus, in some cases, the first buyer might be able to control access to their information. For example, when the second buyer scans the object, an authorization could be provided to the first device of the first buyer identifying generally that a second buyer wants to buy the second product or it might identify the identity of the second buy as well. Then, the first buyer can authorize the second purchase of the second product which can include authorization of identifying the first buyer in a checkout flow to which the second buyer can then be transitioned to.

In some cases, the first buyer may get a batch of potential purchases from a group of second buyers of one or more second products and can authorize a batch for processing. In this case, a second buyer may scan the product and not immediately be transitioned to a checkout flow but might be notified that “first buyer authorization” is in process and that when they are authorized, they will be presented with the chance to buy.

In yet another aspect, a contract to provide services from a network service provider might be at a product (manufacturing) level or at a merchant level. If it is as a merchant level, then the structure might be that the second buyer is transitioned to the same merchant. In some cases, comparative pricing might be provided to help the second buyer know that they are getting a good deal. (The cost of acquisition would be low in this case, which savings could be provided to the second buyer). In another case, a contract can be established with a manufacturer of a product which means that when the second buyer scans the object, the transition can be to a number of different merchants that offer the product. In this case, the second buyer could be presented (like they are upon an Amazon.com search) with a number of different ways (i.e., different merchants or other different ways) to buy the product. The second buyer can then choose based on price or availability or any other factor. The benefit to the first buyer can then be provided either for the merchant that was chosen to sell the second product or through some other agreement with the manufacturer to enable the first buyer to get a benefit.

For example, the first buyer buys the first product at the first merchant. The network service has an agreement with the first product manufacturer to provide the services disclosed herein. The second buyer determines to buy the second product, based on the scan of the object on the first product, from a second merchant. How does the first buyer get a benefit? One way is that the manufacturer may have many different products and if the first buyer buys one of the manufacturer's products at any merchant, a discount or rebate can be provided. The manufacturer can provide a coupon or encourage the first buyer to go to a particular merchant and make a purchase to obtain the benefit. Or a cash or credit account could be established for the first buyer that the manufacturer could provide money directly to.

In some aspects, the first buyer benefit can be an aggregation of multiple benefits. If the benefit for the first buyer is a $5 discount on their next purchase, the first buyer may have 10 friends that bought the same shirt as a second product off a scan of a NFC chip on the first shirt. The benefit can represent a dynamically changing “policy” (as that term is used in the Giftya patents) as the first buyer shares their product with friends. The benefit for example, might aggregate to $50 after the first buyer shares the item 10 times and earns $5 for each purchase of the product by second buyers. Then, when the first buyer goes to the merchant or to any merchant but buys the same product from the manufacturer (depending on how it is set up), then the first buyer may get a $50 discount for the next purchase.

The benefits may also vary in type and can be aggregated by type. For example, after multiple shares of the product with friends that result in purchases, the first buyer may have a total of a 8% discount on a purchase and a rebate of $10, each type of benefit being an aggregation of discount points and/or rebate value from second buyers.

Furthermore, as has been noted above, the benefit structure for the first buyer can be shared with others registered with the service. For example, the first buyer may share a $30 discount or price reduction at a restaurant with a friend through the use of an application user interface in which the first buyer can choose from their benefit(s) and transfer them to another person. They can be received and redeemed via the Giftya-type method in which a policy is established with the friend's credit card such that they simply use their credit card at the proper merchant or to buy the particular product and they get the benefit/discount/rebate, etc.

In some aspects, the first buyer may be able to control how their information is presented in checkout flows from a second buyer or can coordinate second buyers to be authorized second buyers based on the second buyer being part of a contacts list or a friend in social media. This can prevent unknown second buyers from scanning a code or object and buying the product from a person they do not know. The first buyer could also choose a setting in a user profile that does not identify them in the checkout flow or that may request a confirmation via text or email before enabling the second buyer to buy the product and to authorize via any technique the use of their name, likeness, or any other personal information in the checkout flow of the second buyer. Thus, if the first buyer and the second buyer are for example at a park talking about the high tech stroller that the first buyer bought, the second buyer could scan the object with the second buyer device, the first buyer could get a text/notification with a request to simply authorize the sharing of the first buyer information and thus in real time the second buyer can receive a personalized checkout flow that features the first buyer's picture for example.

Furthermore, these settings could also be set by the merchant or the manufacturer of the product. For example, the merchant/manufacturer could control how the checkout flow works such that the first buyer is not identified in the process but just secretly gets the benefit.

It could be a setting in your system where anyone who scans the object gets your information or there can be a privacy setting where only people in your contacts list can get your data. A notice can be provided before a second buyer is able to make a purchase. When a second buyer scans an object, they may get a generic interface to purchase a product with no identification of the first buyer. In some cases, a notification could be sent to the first buyer to authorize the identification to the second buyer and upon authorization, the second buyer can get at the time or later an identification of the first buyer. In other words, the second buyer may quickly buy the product, without knowing who the first buyer is and then later get a notice or thank you from the first buyer when the first buyer authorizes themselves to be identified.

If the first buyer devices and the second buyer devices are close to each other, then the system may consider that the two people are next to each other and know each other and thus may just identify the first buyer to the second buyer. Other information such as audio data received from one or more device may identify that the people are talking each other. The system can use such information to manage the second buyer experience and the exposure of the first buyer information to the second buyer. Again, this can be tailored by settings in a user profile for the first buyer.

In another aspect, the experience of the first buyer can be modified in one or more ways based on their being registered with a service and/or based on their experience with sharing products. For example, if John is registered and has had ten friends buy products from the product that he bought, then he can be identified at the point-of-sale (any number of ways, such as through Apple Pay or providing an email or phone number) and he might be able to get a discount for being registered, for a second buyer making a purchase, for how many times friends have bought products from him, and so forth. The point-of-sale (or online) experience can be tailored to the particular user. The clerk at the POS may be given a script to read saying “welcome John! We are giving you a 10% discount for your great work in helping to share our products.” The analysis can be based on products (independent of a merchant), or may be merchant based or based in general on their experience with the service independent of the merchant or the products. At the sale, the system may identify the user and then implement a personalized experience including one or more of, pricing on one or more products, benefits, refunds, checkout flow experience, images, videos, sounds, etc. For example, this process can give a user at a physical point-of-sale a special different experience that might make them want to come back. As each person will be a “salesman” for the products at different rates and intensity, the approach disclosed herein enables encouragement to buyers to share the products because they get rewarded at the point-of-sale for their efforts. The interest can be similar to the experience on social media which people seek to repeat. Having a positive personalized experience at a point-of-sale, which becomes possible using the concepts disclosed herein, can enhance the desire of a buyer to buy again and to use the objects disclosed herein to share products. The entire process of buying products and sharing products with friends can be enhanced and encouraged.

The live polling process could be used at a point-of-sale or previous. For example, while a user is shopping, they may take pictures of a few products and send the comparison off to their live polling or social media network for feedback. Then, the results may be provided at the point-of-sale to encourage them to buy one or the other.

In another aspect, the payment process can be adjusted from what it currently is to accommodate the features or capabilities of this new system. There are technical issues with the current way it works. For example, with Apple Pay, after the amount of a purchase is identified, the clerk at a point-of-sale initiates the payment process and the user uses their iPhone to generate a one-time use token that is passed for that payment. However, in the scenario disclosed herein, the identity of the person can cause changes or a reduction in the charges made on a purchase or some other benefit. Thus, the process can be adjusted where the NFC component at the point-of-sale can first retrieve from the mobile device the identity of the person, a database check can occur to see what benefits that person might receive, the point-of-sale might first receive the identity of the user, then apply whatever benefit is justified to the purchase based on second buyer purchases, history of the first buyer being a salesman for the product or company, and then can have the single-use token as part of the payment process. The adjustment might cause the process to be slightly longer than normal relative to how long the user needs to hold their mobile device next to the NFC component. Furthermore, this approach can enable a personalized experience at the point-of-sale. For example, on a display screen, a photo of the user, a video, or some personalized content can be provided based on the user identity. The user may be able to interact with a point-of-sale component to answer a question or provide some input or as part of a gamification approach. Currently, the problem with a point-of-sale is that it has no enjoyment and no personalized component to it for individual users. By making the point-of-sale (whether for the first buyer or the second buyer), the experience can trigger the brain's reward center and which can make the experience better and cause users to want to come back. Imagine a brick and mortar store where people love the actual point-of-sale experience and desire to come back to keep buying products. The approach disclosed herein enables a personalized experience. The experience can be presented on one or more of a point-of-sale device or display, a user's mobile device, or may encompass a combination of the two devices. The approach increases customer brand/company loyalty and the customer can become a model for the product.

Note that the enhancement of the point-of-sale experience to be personal can be independent of the broader disclosure herein of providing the first buyer with a benefit for sharing or encouraging a friend (the second buyer) to buy their own product.

Furthermore, the interaction can be related to social media data such as when a product is purchased, the buyer may get data about how many of their friends loved the product, the system can notify their friends that the buyer has just bought the product and they can “like” the purchase. The experience might even be in real time where the user is at the point-of-sale, their name is identified as well as the product (or products) and a quick notice can be sent to a friend group on social media for votes on whether they should complete the purchase. Friends could even be presented for example with two colors of a sweater and vote and the user could be live at a point-of-sale and receive or see the votes (on any device) and then purchase the more popular sweater. A user interface can be configured such that the potential buyer can see the graphical of the two products to choose from and hit “send to friends for a vote” object on any device. A countdown could occur (say 10 seconds for friends to respond) and the results of the voting could be presented on any device where the user could interact with an object to “buy this one”.

FIG. 10G illustrates a method 1040 for some of these features. The method 1040 can include obtaining an identity of a buyer (1042). This can occur as noted above by a buyer providing a phone number, starting a payment process using a mobile device like in Apple/Google/Samsung Pay, or otherwise. The system can then access whether a benefit associated with the purchase can be provided based on the identity of the buyer (1044). In some aspects, the user may be enabled to reach out to their social media network for feedback on the purchase (which of these shirts should I buy?; what color pants look good?) and get instant feedback from the network. Then, the method 402 can include applying the benefit (a discount for being a solid salesman of the product, or sharing it on social media, or making purchases at the merchant) or personal feature (how many likes on the blue shirt, or a picture of a friend with the product, or other personalized feature or object) to the current in process purchase (1046) which can be at a point-of-sale, and completing the purchase with the applied benefit (1048) which can include the personalized feature so that the checkout procedure whether online or at a point-of-sale is more personalized with picture, social media interactions associated with one or more products and the buyer, and so forth.

Another aspect of this disclosure is provided in FIG. 10H and it relates generally to customer service on a product. A method 1050 is provided which can relate to customer service. Having the scannable object configured on a product purchased by a first buyer can not only enable a second buyer to buy their own version of the product but can easily help with service issues. For example, products like LEGO's sell with many parts. On occasion, a part is missing and the user needs to order a replacement part. The user can scan the scannable object on a box or part. Since the object links the first buyer to the product, much information is immediately obtained. In one example, when the first buyer scans the object, the system knows it is not a (potential) second buyer but the first buyer. A customized user interface for the first buyer can be presented in response to the scan. The user may want to order a part or receive service associated with the product. The user interface can be configured for the type of service likely needed. The method can include receiving a scan of an object configured with the product purchased by the buyer (1052). The scan identifies that it is the buyer that is scanning the object and not a second buyer (who, if they scanned the object, would get a different user interface directed towards a purchase and not service).

The method includes presenting a user interface on a user device associated with customer service for the product (1054). For example, the user interface may state “Hi John, do you need to order a part?”. Since the system identifies the user from the scan, there is no need to enter in user information, address, etc. The user is already at that point logged into the user account for that company. The process simplifies for the user the ability to order a part, obtain service, schedule an appointment, etc. for the product. The method includes receiving a service request for the product (1056) and then providing the service based on the service request (1058).

Another aspect could be where the second buyer could scan a product and place it in a “wish list”. Then, the second buyer could buy the product later or could wait until authorizations are in place from the first buyer. Then, the second buyer may be able to confirm that the first buyer is their friend.

In another aspect, this could be used for a market order or a limit order. In some cases, a buyer could place a “market order” for a product at a certain price. Then, the system could monitor the prices of products and then when the price hits the stored price, then the sale is consummated. In this case, a buyer can have a wish list and a product pricing that is placed. Then, if a manufacturer or merchant places that product at the strike price, then the system may implement or proceed with the sale of the product to the buyer. This can be for the second buyer or the first buyer as mentioned here. This could turn the product market into the stock market. The system here could know then that one thousand people would buy a certain YETI cooler at $70 and then could coordinate or share that general data with the manufacturer such that when the volume makes it work, then one thousand coolers are sold at the strike price that makes it worth it because of volume. The system disclosed herein could manage all of the flow of information between the number of users willing to buy a certain product at a certain price and coordinating that data with merchants and manufacturers. Users could be given notice that the price is getting close to their limit order and do they want to go ahead and buy, which could include knowledge of the supply of the product.

Further, the market orders for products could also drive manufacturing where the system could coordinate with manufacturers regarding the number and/or trend of certain product market orders which could cause a manufacturer to go ahead and make a batch of products for the strike price. Further, users may also be given feedback on if they adjust their price at a certain amount, then it will be fulfilled. The consumer can be given more influence over the pricing and manufacturers of the product.

Another aspect of this disclosure relates to a shopping cart. Some shopping carts are being developed with self-checkout features like scales to weigh product, a user interface to enable a user to scan the bar code associated with a product and both add the product (with its weight) to the physical shopping cart and add the product to a virtual shopping cart. The user can then manage the overall costs themselves rather than at a point-of-sale where people might be watching them. They can checkout and pay for everything without a physical point-of-sale but while being in a brick and mortar store.

The principles disclosed herein can be incorporated into a shopping cart. For example, the point-of-sale components described herein can be integrated into a shopping cart such that it includes, for example, an NFC component that can be used to interact with a user mobile device for payment, for initiation of a shopping experience, and/or to obtain the identity of the buyer. For example, at the beginning, the user may use the NFC protocol to identify themselves which can be confirmed through interactions like Apple Pay (two clicks and a facial recognition, for example, or other biometrics or PIN codes). The experience at this point can be even more personal in that the shopping cart can include a wireless communication component and access a server and gather user profile data for that user. The pricing and user experience on a graphical user interface of the shopping cart can be tailored for that user. For example, if the user has an active history of sharing products with friends, then the pricing may be reduced and the user interface may say: We are giving you 10% off because your friend Mary bought one of these shirts from the QR code on your blue shirt you bought last August.

Social media data can be accessed via the server as well. For example, if you scan a product that has been purchased and “liked” by some people in your social media circle, the user interface can respond with data like: “10 of your friends bought the same or similar shoes in the last year”. If there is a QR scannable code as described herein, the user may scan a bar code, which can indicate that there is a QR code that can be scanned to connect the user with that product and that second buyers can use to buy the product as well. The shopping cart can instruct the user to scan the QR code or NFC tag or whatever the object is using a NFC component or a visual scanning component and a confirmation can be provided that the product is registered for that user. The user could pay at the end using Apple Pay or any other payment process.

Thus, note that in this case the NFC component, for example, could be multipurposed. It can be used to initially identify the user, it can be used to scan NFC tags on a product to connect that product uniquely with the user, and it could be used to receive payment through Apple/Google/Samsung Pay. The system adjusts which mode the device is in based on the overall shopping experience. Users are already used to these kinds of technologies and thus this new idea will be easy to implement. A scanning device can also be used in different contexts such as scanning a QR code for a discount, to identify the user, to scan a code on a product to connect that product with the user, and/or for other reasons. Again, this can be placed in different modes to make the proper reading. The shopping cart can include the basic computing components such as a battery, a touch sensitive display, a computer processor, a communication component (cellular/Bluetooth, etc.), computer memory, program modules, a multimodal interaction component, the ability to process speech, a biometrics component, and so forth.

The interface can thus include the specific types of options for that product, such as to buy it again, or to go through a parts list, or to request some type of service. For security, in some cases, before the service interface is presented, the system may do a facial/biometrics/fingerprint recognition like in Apple Pay before presenting the interface to ensure that the proper user is making the service request.

In another aspect, where the second buyer is specifically buying the product from the first buyer, which is referenced in the incorporated application, the second buyer may not want to buy a new product but to literally take possession of the first buyer's product. In this case, the system can present an option on the checkout page 1002 where a negotiation can take place in which the system managers user interfaces on the mobile devices of the first buyer and the second buyer. The optional function 1003 in FIG. 10A might be to buy that very same first product. If the second buyer chooses that option, then the system can present to the user an offer from the second buyer (which could be placed in a field of a user interface obtained when the function of buying the actual object is chosen from object 1003's functions), and a negotiation can take place where the first buyer adjusts the price and present a counter offer. If the users are simply standing next to each other, the first buyer can simply set the agreed-upon price on their mobile device, and the second buyer can then receive a text or an updated checkout flow with the approved price (the first buyer may confirm the price like they confirm a purchase on Apple Pay with two clicks and a facial recognition). The ease of the approach is that it all takes place essentially on the context of the second buyer checkout flow which is easy to manage and contemplate for the second buyer. The use of the checkout flow here is updated to be much more flexible to enable the second buyer to offer to buy the very product that had the object that was scanned.

Yet another aspect of the optional function 1003 can relate to enabling the second buyer to view material prepared by the first buyer about the product. For example, through an application, social media network, or via the web, the first buyer could take pictures and video associated with the product and easily connect that content to the product by scanning the object on the product. For example, a backpack having the object contained thereon could be used in photos, stories, videos of hikes and the first buyer could take the content, and the application, camera, etc. could include an option to associate or transfer that content to a storage location associated with the object. The first buyer could compile or make a video or configure the personal content and review the content such that when the selectable object 1003 is chosen after the second buyer scans the object on the product, that personal content is presented. It could be a demonstration about how to use the content, it could be a Youtube video or a social media posting on the product. In general, the first buyer can tailor the experience of the second buyer when they scan the object on the product. The process could include receiving personal content from the first user, receiving data from the first buyer scanning the object on the product and storing the content in connection with the first product based on the scan. Then, when a second buyer scans the object, the personal content is delivered or transmitted to the second buyer device either directly or in a selectable manner from a menu, or is selectable from a checkout flow.

Further, the seller of the product could also present content based on a second buyer scanning the object. The experience or user interface seen when the second buyer scans the object can include one or more of a menu of options, content from the seller of the product or a merchant that sells the product or the manufacturer, personal content from the first buyer, a checkout flow to buy the product, or any combination of these options. The content presented could also be dependent or chosen based on factors such as the second buyer location, a time of day or time of year, a season (during Christmas time, a different content is presented), and so forth. An advertisement could also be presented which is tailored an accessory product or any product. The advertisement could feature the product with the scanned code with an accessory product (which could be added to selected to be purchased as well in the checkout flow).

The principles disclosed herein can also be incorporated into other existing payment flows, such as Apple Pay, Google Pay, Samsung Pay, or PayPal. In many cases, these new generation payment flows have a design of being more like a “single click” experience for the user. However, given the simplicity of these flows (which may require different interactions than a simple click on a button), one could integrate into the flow some kind of interaction (single click, biometric identification, multimodal interaction, or other forms of interaction) to confirm that the user's name should be provided to a database in connection with a product or service being purchased via the current payment flow. When the user approves, a database record is established which includes one or more of the user name, an identification of the product in general (such as a Yeti water bottle version X), an identification of the specific product purchased (Yeti water bottle number 1,234,123, identified from a code such as a QR code), and/or metadata such as date, time, store location, promotional associated with the purchase, etc.

The following are some examples of how a connection of a user to a product at the time of purchase can occur. Apple Pay has become ubiquitous in society and is used as a simplified way of making payments online, at a point-of-sale, and in applications. The focus has been on security and the simplified user experience for making payments. For example, at a point-of-sale in a brick and mortar store, a user may double-click a side button on an iPhone and then have their face recognized to place the iPhone in a state of being able to connect via a wireless link to a point-of-sale device and transmit a one-time use token for a payment for an item. Usually, a clerk at the store completes via a cash register or other device the purchase data and causes a signal to be sent to the point-of-sale device to be activated to exchange the necessary data to cause the iPhone to generate the token and transmit it to the point-of-sale device. Back-end processing can include confirming with Apple Servers that the user is authorized and proper for making the payment. The token may go to the merchant or a payment processor for making the payment using the credit card or payment card of the user.

What is needed in the art is a new mechanism of authorizing other applications or transactions as part of an Apple Pay (or other payment mechanism) payment flow. For example, a buyer may be at a point-of-sale to buy a Yeti thermos that has a unique QR code configured on the bottom. The QR code may be used like a UPC symbol to identify the product for purchase at the point-of-sale. However, when the user, say her name is Mary, buys the Yeti Thermos, the QR code could be stored in a database that identifies Mary as the buyer of that particular Yeti thermos. Then, when a friend of Mary's, named John, sees the Yeti thermos and wants one for himself, he can simply scan the QR code. A database can be accessed to confirm that Mary is the owner of this Yeti and is therefore the means by which John is able to buy his own. John can have his Yeti delivered him and Mary can get a benefit such as a 10% discount on her next purchase, or any other benefit. The overall ecosystem can be called a “benefit process” or “benefit system” which typically involves three transactions. The first is Mary purchasing the product. The second is John purchasing his own version of the product, and the third transaction is Mary making another purchase to redeem the benefit granted based on John's purchase through an interaction with Mary or the product that Mary purchased.

However, there needs to be a simple mechanism where Mary can provide her name to the merchant so that the database record connecting Mary, to the Yeti and the unique QR code. This is where a modification of Apple Pay will come into play. Normally, the cash register or similar system of a merchant is used to list the product or products being purchased and identify the total amount for the sale. When that is complete a signal is sent from the cash register to a POS device for interacting with the iPhone to actually make the purchase. The user double clicks the side button and has their face recognized either before connecting wirelessly to the POS device or in another aspect the POS device transmits a signal that “wakes up” the iPhone and automatically places it in a state of being able to make a purchase or confirm the purchase with two clicks and a facial recognition. Or the user confirms the purchase before connecting with the POS device and the payment data, upon connection, is automatically sent with no more user interaction.

The new approach will be to transmit data regarding the product and/or the QR code to the POS device. The signal basically indicates to the POS that the merchant for this transaction is going to request the name of the buyer and/or some identification information. The POS device can adjust the user interface as part of the Apple Pay transaction as follows.

The POS may access a database to determine if Mary is already registered with a service for managing the purchase by John and the benefit provided to Mary. If Mary is not registered, the user interface may present information on the display of the iPhone saying “Mary, the Yeti thermos is eligible for purchase by your friends via the QR code on the bottom. You will get a benefit for each Yeti thermos your friends buy. Please confirm registration for this program as you authorize this purchase.” Whether through a separate approval (i.e., a separate two clicks and a facial recognition, approval via a text or email, or other mechanism), Mary can be registered with the service to enable the process.

For example, if the user has not double-clicked and done facial recognition before the wireless connection is made to the POS, the POS, when connected, can automatically launch Apple Pay and present the above information indicating that the approval of this purchase will include an approval to register for the QR code program such that benefits can be provided. Then one approval is only needed. As an alternative, after the payment is approved in the normal way, the user interface can present the information about the program to the user and they can confirm again and separately that they want to register and store their purchase of the Yeti thermos in the database. The second confirmation to use their name can be the same or different than the first confirmation for the purchase.

If the user is already registered, which can include approvals of providing their name to the merchant for the Yet thermos being included in the QR code program, then a notice in connection with the purchase may simply state that “The Yeti thermos you just bought is included in the QR code program. Please share it with your friends!”.

Then, Apple Pay can provide via an API or some other communication channel the basic information to the merchant or to a separate service provider that simply stores the data about Mary and the identification of the Yeti thermos.

Then, when John sees Mary and decides he wants a Yeti thermos as well, he simply scans the QR code which accesses the database to identify Mary. John can then simply be placed in a payment flow to buy his Yeti. The payment flow may or may not include information such as “Your friend Mary will get a 10% discount on her next purchase”. Then, the service provider stores or creates a “policy” that indicates that the next time Mary makes a purchase at the merchant, she gets a 10% discount. The policy can connect Mary, with the benefit, and her credit card or debit card or other payment mechanism such that all she needs to do is shop using her existing payment mechanism and the service provider tracks or detects those transactions and automatically applies the benefit.

The service provider here could be Apple as they operate Apple Pay or they could communicate with the service provider or merchant through an API or other communication channel. The benefit here is that the information provided to the merchant or the service provider is typically only the user name or other identifying information. Only one time would the user's credit card be shared with the service provider for being able to process the benefit on a later transaction.

In another aspect, Apple Pay, because they only use a one-time use token for making a specific payment, can notify the user's bank or credit card company that the user has authorized the sharing of their credit card number to the service provider to enable them to redeem the benefit. Here, the bank could then use two-factor authentication such as by sending a text or email to their customer confirming that they are to share the credit card data to the service provider. This way, privacy and security are properly handled and the person gets registered with the service provider and is easily thereafter able to have other products that they purchase connected to them in the service provider database.

The approach may include registering the user the first time with the service via a second mode of communication such as a text or an email where the user confirms that the service can store their credit card number for purposes of enabling the registered user to receive or redeem benefits when a person buys a product from the product they purchased.

The process may be similar for web-based or application-based purchases. Whether on the web or in an application, when a user purchases a product that will be part of the benefit program, whether before, during or after a payment, the user can be presented with a confirmation that the service provider will store their name as having purchased the product. For example, when a user clicks on “Apple Pay” to make the payment, the website or application may determine that the product is to be part of the benefit program, the user may be presented with a selectable object to “confirm that the Yeti thermos will be stored in our database for use in the benefit program.” Then the regular payment process can proceed. Or, the user may be presented with the data regarding the product purchased but also may be told that by confirming the payment they will confirm or authorize the storage at the service provider of the product connected to their name and thus entered into the benefit program.

If the user via Apple Pay has confirmed the purchase with two clicks and a facial recognition, before connecting to the POS device, the normal process is that once the POS device connection is made with an iPhone, the user provides no additional data and the payment data (token) is automatically transferred to the POS device for further processing. In this case, however, if there is a product to be purchased that is to be connected to the user as the purchaser, then since the user has already provided the confirmation and biometrics to confirm their identity, the system can safely present a notification or request on the user interface saying “confirm your connection to the Yeti water bottle and the QR code on the bottom”. The user may click on an object, or click on the physical button or perhaps have another biometric confirmation, but at that point, the identity is already confirm and just any kind of input to confirm that the system can register the person's name in connection with the Yeti water bottle (or any product). Thus, the approach in general as described herein inserts an additional confirmation to provide the user's name in connection with the purchase of the product to set the person up for receiving a benefit of a later purchase of that same product occurs through the first product purchased by the user. The flow of Apple Pay whether in-app, online or at a POS can be adjusted similarly to insert in a confirmation of connecting the user to that very product.

Other confirmations can also be provided in an Apple Pay, Google Pay, Samsung Pay, PayPal pay or any other payment flow as well. The only variations might be dependent upon the different specific details of a respective payment flow.

When no QR code is used to identify the product for the second purchaser, the system can utilize a scan of the product by a camera to identify the product, an application, facial recognition, text, user input, or other mechanism can be used to identify the first purchaser. The system can ping the database of names/products to confirm that the first purchaser did indeed purchase the product identified from the picture (through an AI model) and can then proceed to process both the purchase of a product for the second purchaser and the benefit provided to the first purchaser.

In some cases, as noted above, the interaction with the POS device in a payment flow can also cause information to be provided back to a merchant device which can include a printer that prints at the point-of-sale a QR code or other code that can be placed on the product for later scanning by the second buyer. A processing service or entity that stores the data regarding the product and the user can generate the QR code and send it back to the POS device or a merchant device based on the approval from the user of the connection. Thus, through the flow of, for example, Apple Pay, a user can authorize or confirm the connection of the user and the product in a database and have a sticker printed for later scanning by a second buyer.

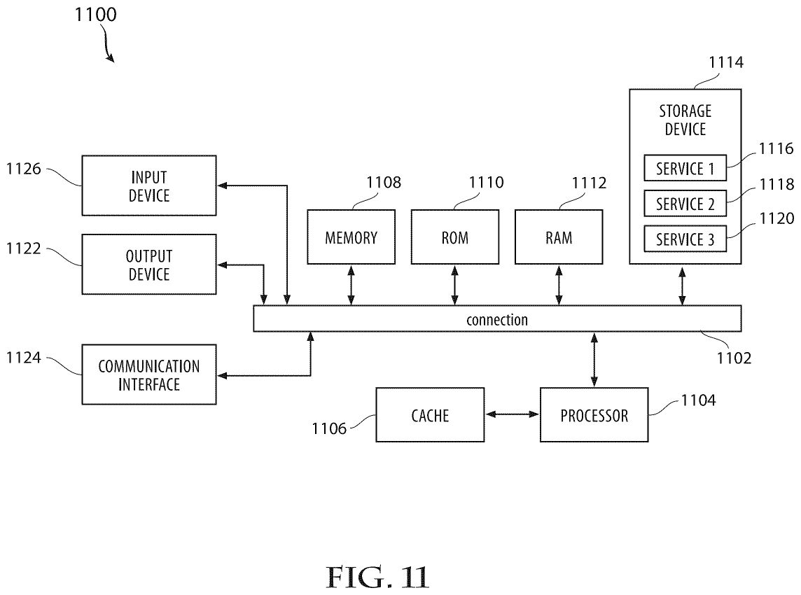

FIG. 11 shows an example of computing system 1100, which can be for example any computing device making up any mobile device, computer server, point-of-sale device 112, or any component thereof in which the components of the system are in communication with each other using connection 1102. Connection 1102 can be a physical connection via a bus, or a direct connection into processor 1104, such as in a chipset architecture. Connection 1102 can also be a virtual connection, networked connection, or logical connection.

In some embodiments, computing system 1100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1100 includes at least one processing unit (CPU or processor) 1104 and connection 1102 that couples various system components including system memory 1108, such as read-only memory (ROM) 1110 and random access memory (RAM) 1112 to processor 1104. Computing system 1100 can include a cache of high-speed memory 1106 connected directly with, in close proximity to, or integrated as part of processor 1104.

Processor 1104 can include any general purpose processor and a hardware service or software service, such as services 1116, 1118, and 1120 stored in storage device 1114, configured to control processor 1104 as well as a special-purpose processor where software instructions are incorporated into the actual processor design. Processor 1104 may essentially be a completely self-contained computing system, containing multiple cores or processors, a bus, memory controller, cache, etc. A multi-core processor may be symmetric or asymmetric.

To enable user interaction, computing system 1100 includes an input device 1126, which can represent any number of input mechanisms, such as a microphone for speech, a touch-sensitive screen for gesture or graphical input, keyboard, mouse, motion input, speech, etc. Computing system 1100 can also include output device 1122, which can be one or more of a number of output mechanisms known to those of skill in the art. In some instances, multimodal systems can enable a user to provide multiple types of input/output to communicate with computing system 1100. Computing system 1100 can include communication interface 1124, which can generally govern and manage the user input and system output. There is no restriction on operating on any particular hardware arrangement, and therefore the basic features here may easily be substituted for improved hardware or firmware arrangements as they are developed.

Storage device 1114 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1114 can include software services, servers, services, etc., that when the code that defines such software is executed by the processor 1104, it causes the system to perform a function. In some embodiments, a hardware service that performs a particular function can include the software component stored in a computer-readable medium in connection with the necessary hardware components, such as processor 1104, connection 1102, output device 1122, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

A communication interface associated with any system may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/long term evolution (LTE) cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

A communications interface may also include one or more GNSS (global navigation satellite system) receivers or transceivers that are used to determine a location of a computing system based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

A storage device can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a Europay, Mastercard and Visa (EMV) chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/ L2/ L3/ L4/ L5/ L #), resistive random-access memory (RRAM/ReRAM), phase change memory (PCM), spin transfer torque RAM (STT-RAM), another memory chip or cartridge, and/or a combination thereof.

The storage device can include software services, servers, services, etc., that when the code that defines such software is executed by a processor, it causes the system to perform a function. In some aspects, a hardware service that performs a particular function can include the software component stored in a computer-readable medium in connection with the necessary hardware components, such as the processor, a connection, an output device, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

Aspects of this disclosure can include any feature such as a step or operation described in connection with any aspect which can be combined with any individual feature or operation of another aspect. There is no requirement of individual “embodiments” that are separate from each other conceptually. Claims can be directed to processes from the standpoint of a point-of-sale device, a mobile device, a product itself, a software package or module, an application or “app”, a payment or benefits system as described herein, with all the associated processes such as generating data, transmitting data, receiving data, handling a benefit, making a payment, receiving a payment and so forth being potentially recited for a claim from the standpoint of the respective entity that is being claimed. This disclosure introduces an entire ecosystem that can change the way products are sold and purchased throughout the economy in a way that enhances friendships and relationship between people around the products people love.

Clauses of this application include:

### Clause Set 1

Clause 1. A method comprising: identifying a first product being purchased by a first buyer; identifying a graphical object specific to the first product; storing an association of the first product, the first buyer and the graphical object in a database; receiving an indication that a second buyer has received the graphical object onto a second buyer device; processing a purchase of a second product by the second buyer based on the indication; and providing a benefit to the first buyer based on the purchase of the second product.

Clause 2. The method of clause 1, wherein the graphical object is printed on the first product.

Clause 3. The method of clause 2 or any previous clause, wherein the graphical object is transmitted to a first buyer device for storage and later scanning.

Clause 4. The method of clause 1 or any previous clause, further comprising: recording on a blockchain network data confirming the association of the first product, the first buyer and the graphical object.

Clause 5. The method of clause 1 or any previous clause, further comprising: printing, at a point-of-sale, a physical object showing the graphical object.

Clause 6. The method of clause 1 or any previous clause, wherein receiving the indication that the second buyer has received the graphical object onto the second buyer device further comprises receiving a scan of the graphical object by a camera on the second buyer device.

Clause 7. The method of clause 6 or any previous clause, further comprising: accessing a purchasing service based on the indication that the second buyer has received the graphical object onto the second buyer device, wherein the purchasing service retrieves the association of the first product, the first buyer and the graphical object in the database to identify the second product and to identify the first buyer to provide the benefit to the first buyer.

Clause 8. The method of clause 6 or any previous clause, wherein receiving the indication that the second buyer has received the graphical object onto the second buyer device comprises one or more of receiving a scan of the graphical object physically from the first product, receiving a scan of the graphical object from a display of a first buyer device, receiving a communication at the second buyer device from the first buyer device, or receiving a scan of the graphical object from a social media posting of the first buyer.

Clause 9. The method of clause 8 or any previous clause, wherein the communication comprises a message, a voicemail or email.

Clause 10. A method comprising: generating a group of products wherein a respective product in the group of products is made with a respective graphical object unique to the respective product; at a purchase of the respective product, identifying a first buyer and the respective graphical object and storing data in a database associating the first buyer and the respective graphical object; receiving an identification of the respective graphical object from a second buyer device associated with a second buyer; accessing, based on the identification of the respective graphical object from the second buyer device, the data to identify the respective product and the first buyer; processing a sale of a second product associated with the respective product to the second buyer; and automatically providing a benefit to the first buyer based on the sale of the second product.

Clause 11. The method of clause 10, wherein the respective product is a respective physical product and wherein the respective graphical object is a respective physical graphical object either on the respective physical product or on a packaging or box associated with the respective physical product.

Clause 12. The method of any of clauses 10-11, wherein the benefit comprises one or more of money, a discount, a coupon, a gift, a registration, access to a venue.

Clause 13. The method of any of clauses 10-12, wherein receiving the identification of the respective graphical object from the second buyer device associated with the second buyer comprises receiving a scan of the respective graphical object from the second buyer device.

Clause 14. The method of any of clauses 10-13, wherein the respective graphical object includes information enabling the second buyer device to access a network-based purchasing service to enable the sale of the second product.

Clause 15. A point-of-sale device comprising: a storage compartment for a set of stickers; a dispensing mechanism for dispensing stickers from the set of stickers; a printer; a processor; a computer-readable memory storing instructions which, when executed by the processor, cause the processor to perform operations comprising: receiving information about graphical object to be printed, the graphical object comprising data about a product being purchased, a buyer of the product, and data to enable automatic access to a purchasing service; printing, via the printer, the graphical object on a sticker from the set of stickers to generate a printed sticker; and dispensing, via the dispensing mechanism, the printed sticker.

Clause 16. A system comprising: a processor; and a computer-readable memory storing instructions which, when executed by the processor, cause the processor to perform operations comprising: identifying a first product being purchased by a first buyer; identifying an object specific to the first product; storing an association of the first product, the first buyer and the object in a database; receiving an indication that a second buyer has received the object onto a second buyer device; processing a purchase of a second product by the second buyer based on the indication; and providing a benefit to the first buyer based on the purchase of the second product.

Clause 17. The system of clause 16 or any previous clause, wherein the object comprises one of a near field communication tag and a graphical object.

Clause 18. The system of clause 16 or any previous clause, wherein the second buyer receives the object onto the second buyer device by optically scanning the object, receiving a communication having the object, or receiving stored data from the object when the object comprises a near field communication tag.

Clause 19. A point-of-sale system comprising: a processor; a computer-readable memory storing instructions which, when executed by the processor, cause the processor to perform operations comprising: identifying a first buyer and a first product from a scan of an object associated with the first product to generate first buyer/first product data; transmitting the first buyer/first product data to a purchasing system to store the first buyer/first product data in a database, wherein the purchasing system: receives an identification of the object from a second buyer device associated with a second buyer; accesses, based on the identification of the object from the second buyer device, the first buyer/first product data; processes a sale of a second product associated with the first product to the second buyer; and automatically provides a benefit to the first buyer based on the sale of the second product to the second buyer.

Clause 20. A purchasing system comprising: a processor; and a computer-readable memory storing instructions which, when executed by the processor, cause the processor to perform operations comprising: identifying an object that associates a first buyer and a first product to generate first buyer/first product data; receiving an identification of the object from a second buyer device associated with a second buyer; accessing, based on the identification of the object from the second buyer device, the first buyer/first product data; initiating a sale of a second product associated with the first product to the second buyer; and providing a benefit to the first buyer based on the sale of the second product to the second buyer.

Clause 21. A method comprising: providing via a wireless link, from a point-of-sale device and to a mobile device data identifying a merchant, wherein the data identifying the merchant is associated with an initiation of a payment process for a transaction of purchasing a product; receiving, from the mobile device and over the wireless link, payment data to pay for the product and discount data to be applied to purchasing the product, wherein the payment data and the discount data are both received over the wireless link; and applying the discount data to the transaction to generate a remainder amount for the transaction; and processing a payment of the remainder amount, if any, using the payment data.

Clause 22. A device comprising: a processor; a computer-readable memory storing instructions which, when executed by the processor, cause the processor to perform operations comprising: providing via a wireless link, to a mobile device data identifying a merchant, wherein the data identifying the merchant is associated with an initiation of a payment process for a transaction of purchasing a product; receiving, from the mobile device and over the wireless link, payment data to pay for the product and discount data to be applied to purchasing the product, wherein the payment data and the discount data are both received over the wireless link; and applying the discount data to the transaction to generate a remainder amount for the transaction; and processing a payment of the remainder amount, if any, using the payment data.

Clause 23. A method comprising: receiving, at a user device, an identification of a merchant via a wireless link with a point-of-sale device and in connection with an initiation of a payment over of a wireless link for a product; determining whether a discount is available for the merchant; and when a discount is available, coordinating payment data and discount data in a virtual wallet or between applications on the user device to cause final payment data sent over the wireless link to reflect the discount when paying for the product.

Clause 24. An apparatus including means for performing any of the methods disclosed in the present patent application.

Clause 25. A computer readable computer-readable memory storing instructions which, when executed by a processor, cause the processor to perform any methods or operations disclosed herein.

Clause 26. A method comprising: identifying a first product being purchased by a first buyer; storing an association of the first product and the first buyer in a database; receiving an indication that a second buyer has identified the first product onto a second buyer device; processing a purchase of a second product by the second buyer based on the indication; and providing a benefit to the first buyer based on the purchase of the second product.

### Clause Set 2

Clause 1. A method comprising: receiving an identification of a product via a first device of a first user; receiving, via a biometric recognition model, an identification of a second user associated with the product; determining whether a record exists in a database that determines that the second user previously purchased the product to yield a determination; when the determination indicates that the second user previously purchased the product, then: offering a new product associated with the product to the first user for purchase; providing a benefit to the second user when the first user purchases the new product; when the determination does not indicate that the second user previously purchased the product, then: offering the new product to the first user for purchase without providing a benefit to the second user.

Clause 2. The method of clause 1, wherein receiving an identification of the product occurs from a scan via the first device of a visual object attached to or associated with the product or an artificial intelligence model analyzing an image of the product.

Clause 3. The method of clause 1 or any previous clause, wherein the database stores data identifying that the second user purchased the product at a time the second user purchased the product.

Clause 4. The method of clause 1 or any previous clause, wherein the database stores data identifying that the second user purchased the product by, when the product is purchased by the second user, a scan of a visual object on the product and an identification of the second user is stored in the database.

Clause 5. The method of clause 4 or any previous clause, wherein the visual object comprises one of a QR code or a UPC code.

Clause 6. The method of clause 1 or any previous clause, wherein the benefit to the second user comprises a credit redeemable by the second user by using an existing, open-loop, payment card of the second user at a merchant that sold the product to the second user.

Clause 7. The method of clause 1 or any previous clause, wherein the benefit to the second user is redeemable via an establishment of a policy associated with an existing, open-loop payment card of the second user, wherein the policy defines one or more of an amount of a redemption credit, a manufacturer, a type of product, a merchant, a time frame, and product information and that defines how the second user redeems the redemption credit by making a purchase using their existing, open-loop payment card in connection with making a second purchase after making a first purchase of the product.

Clause 8. The method of clause 7 or any previous clause, wherein the redemption credit is offered by one or more of a manufacturer of the product or a retail merchant who sells the product.

Clause 9. The method of clause 1 or any previous clause, wherein the biometric recognition model comprises one of a facial recognition model and a fingerprint recognition model.

Clause 10. The method of clause 1, further comprising: transmitting an electronic notice of a device of the second user notifying the second user of the benefit and how to redeem the benefit.

Clause 11. A system comprising: at least one processor; and a computer-readable storage device storing instructions which, when executed by the at least one processor, cause the system to be configured to: receive an identification of a product via a first device of a first user; receive, via a biometric recognition model, an identification of a second user associated with the product; determine whether a record exists in a database that determines that the second user previously purchased the product to yield a determination; when the determination indicates that the second user previously purchased the product, then: offer a new product associated with the product to the first user for purchase; provide a benefit to the second user when the first user purchases the new product; when the determination does not indicate that the second user previously purchased the product, then: offer the new product to the first user for purchase without providing a benefit to the second user.

Clause 12. The system of clause 11, wherein receiving an identification of the product occurs from a scan via the first device of a visual object attached to or associated with the product or an artificial intelligence model analyzing an image of the product.

Clause 13. The system of clause 11 or any previous clause, wherein the database stores data identifying that the second user purchased the product at a time the second user purchased the product.

Clause 14. The system of clause 11 or any previous clause, wherein the database stores data identifying that the second user purchased the product by, when the product is purchased by the second user, a scan of a visual object on the product and an identification of the second user is stored in the database.

Clause 15. The system of clause 14 or any previous clause, wherein the visual object comprises one of a QR code or a UPC code.

Clause 16. The system of clause 11 or any previous clause, wherein the benefit to the second user comprises a credit redeemable by the second user by using an existing, open-loop, payment card of the second user at a merchant that sold the product to the second user.

Clause 17. The system of clause 11 or any previous clause, wherein the benefit to the second user is redeemable via an establishment of a policy associated with an existing, open-loop payment card of the second user, wherein the policy defines one or more of an amount of a redemption credit, a manufacturer, a type of product, a merchant, a time frame, and product information and that defines how the second user redeems the redemption credit by making a purchase using their existing, open-loop payment card in connection with making a second purchase after making a first purchase of the product.

Clause 18. The system of clause 17 or any previous clause, wherein the redemption credit is offered by one or more of a manufacturer of the product or a retail merchant who sells the product.

Clause 19. The system of clause 11 or any previous clause, wherein the biometric recognition model comprises one of a facial recognition model and a fingerprint recognition model.

Clause 20. The system of clause 11 or any previous clause, wherein the computer-readable storage device stores instructions which, when executed by the at least one processor, cause the system to be configured to transmit an electronic notice of a device of the second user notifying the second user of the benefit and how to redeem the benefit.

### Clause Set 3

Clause 1. A method comprising: receiving a personalized dataset associated with a first buyer of a first product, wherein the first product is associated with an object that can be scanned by a second buyer and wherein the object identifies the first buyer as a buyer of the first product; receiving a scan of the object by a mobile device of the second buyer; obtaining the personalized dataset associated with the first buyer; and transitioning, based on the scan, the mobile device of the second buyer to a checkout flow that is customized using the personalized dataset associated with the first buyer, wherein the checkout flow enables the second buyer to buy a second product.

Clause 2. The method of clause 1, wherein the object comprises a quick response code or a near-field communication tag.

Clause 3. The method of clause 1, wherein the second product is a same product as the first product.

Clause 4. The method of clause 1, wherein the personalized dataset comprises one or more of an image, a video, a logo, a word or phrase or a sound.

Clause 5. A system comprising: at least one processor; and a computer-readable storage medium storing instructions, which, when executed by the at least one processor, cause the at least one processor to be configured to: receive a personalized dataset associated with a first buyer of a first product, wherein the first product is associated with an object that can be scanned by a second buyer and wherein the object identifies the first buyer as a buyer of the first product; receive a scan of the object by a mobile device of the second buyer; obtain the personalized dataset associated with the first buyer; and transition, based on the scan, the mobile device of the second buyer to a checkout flow that is customized using the personalized dataset associated with the first buyer, wherein the checkout flow enables the second buyer to buy a second product.

Clause 6. The system of clause 5, wherein the object comprises a quick response code or a near-field communication tag.

Clause 7. The system of clause 5 or any previous clause, wherein the second product is a same product as the first product.

Clause 8. The system of clause 5 or any previous clause, wherein the personalized dataset comprises one or more of an image, a video, a logo, a word or phrase or a sound.

Clause 9. A method comprising: obtaining a location of a mobile device based on the mobile device scanning an object associated with a first product bought by a first buyer, the object being associated in a database with the first product and the first buyer; obtaining data associated with the location; and transitioning a second buyer associated with the mobile device to a checkout flow, based on the scanning, wherein the checkout flow includes the data associated with the location to generate a location-based checkout flow.

Clause 10. The method of clause 9 or any previous clause, further comprising receiving a confirmation that the second buyer bought a second product from the location-based checkout flow and providing a benefit to the first buyer.

Clause 11. The method of clause 9 or any previous clause, wherein the data associated with the location can comprise one or more of weather conditions, a location of the mobile device, news data, historical data, personal data for the first buyer or the second buyer, social media data, and predicted data.

Clause 12. The method of clause 9 or any previous clause, wherein the data associated with the location comprises data generated by an artificial intelligence model based on one or more input parameters.

Clause 13. The method of clause 12 or any previous clause, wherein the one or more input parameters comprise one or more of the location of the mobile device, data about the first buyer or the second buyer, weather data, social media data, predicted data, context data, color preferences, pattern preferences and checkout-flow characteristic preferences.

Clause 14. A system comprising: at least one processor; and a computer-readable storage medium storing instructions, which, when executed by the at least one processor, cause the at least one processor to be configured to: obtain a location of a mobile device based on the mobile device scanning an object associated with a first product bought by a first buyer, the object being associated in a database with the first product and the first buyer; obtain data associated with the location; and transition a second buyer associated with the mobile device to a checkout flow, based on the scanning, wherein the checkout flow includes the data associated with the location to generate a location-based checkout flow).

Clause 15. The system of clause 14, the at least one processor is further configured to receive a confirmation that the second buyer bought a second product from the location-based checkout flow and providing a benefit to the first buyer.

Clause 16. The system of clause 14 or any previous clause, wherein the data associated with the location can comprise one or more of weather conditions, a location of the mobile device, news data, historical data, personal data for the first buyer or the second buyer, social media data, and predicted data.

Clause 17. The system of clause 14 or any previous clause, wherein the data associated with the location comprises data generated by an artificial intelligence model based on one or more input parameters.

Clause 18. The system of clause 17 or any previous clause, wherein the one or more input parameters comprise one or more of the location of the mobile device, data about the first buyer or the second buyer, weather data, social media data, predicted data, context data, color preferences, pattern preferences and checkout-flow characteristic preferences.

### Clause Set 4

Clause 1. A method comprising: identifying a first product being purchased by a first buyer; storing an association of the first product and the first buyer in a database; receiving an identification of the first product from a second buyer device; processing a purchase of a second product by a second buyer based on the identification; and providing a benefit to the first buyer based on the purchase of the second product.

Clause 2. The method of clause 1, wherein the association of the first product and the first buyer is performed via use of a graphical object associated with the first product.

Clause 3. The method of clause 2 or any previous clause, wherein the graphical object is transmitted to a first buyer device for storage and later scanning.

Clause 4. The method of clause 1 or any previous clause, further comprising:
recording on a blockchain network data confirming the association of the first product and the first buyer.

Clause 5. The method of clause 1 or any previous clause, further comprising:
printing, at a point-of-sale, a physical object showing a graphical object that associates the first buyer and the first product.

Clause 6. The method of clause 1 or any previous clause, wherein the identification of the first product from the second buyer device occurs via the second buyer device scanning a graphical object on the first product by a camera on the second buyer device.

Clause 7. The method of clause 6 or any previous clause, further comprising: accessing a purchasing service based on the second buyer has scanning the graphical object onto the second buyer device, wherein a purchasing service retrieves the association of the first product, the first buyer and the graphical object in the database to identify the second product and to identify the first buyer to provide the benefit to the first buyer.

Clause 8. The method of clause 6 or any previous clause, wherein the identification of the first product from the second buyer device occurs via one or more of receiving a scan of the graphical object physically from the first product, receiving a scan of the graphical object from a display of a first buyer device, receiving a communication at the second buyer device from the first buyer device, or receiving a scan of the graphical object from a social media posting of the first buyer.

Clause 9. The method of clause 8 or any previous clause, wherein the communication comprises a message, a voicemail or email.

Clause 10. A method comprising: generating a group of products wherein a respective product in the group of products is made with a respective graphical object unique to the respective product; at a purchase of the respective product, identifying a first buyer and the respective graphical object and storing data in a database associating the first buyer and the respective graphical object; receiving an identification of the respective graphical object from a second buyer device associated with a second buyer; accessing, based on the identification of the respective graphical object from the second buyer device, the data to identify the respective product and the first buyer; processing a sale of a second product associated with the respective product to the second buyer; and automatically providing a benefit to the first buyer based on the sale of the second product.

Clause 11. The method of clause 10, wherein the respective product is a respective physical product and wherein the respective graphical object is a respective physical graphical object either on the respective physical product or on a packaging or box associated with the respective physical product.

Clause 12. The method of clause 10 or any previous clause, wherein the benefit comprises one or more of money, a discount, a coupon, a gift, a registration, access to a venue.

Clause 13. The method of clause 10 or any previous clause, wherein receiving the identification of the respective graphical object from the second buyer device associated with the second buyer comprises receiving a scan of the respective graphical object from the second buyer device.

Clause 14. The method of clause 10 or any previous clause, wherein the respective graphical object includes information enabling the second buyer device to access a network-based purchasing service to enable the sale of the second product.

Clause 15. A system comprising: a processor; and a computer-readable memory storing instructions which, when executed by the processor, cause the processor to be configured to: identify a first product being purchased by a first buyer; store an association of the first product and the first buyer in a database; receive an identification of the first product from a second buyer device; process a purchase of a second product by a second buyer based on the identification; and provide a benefit to the first buyer based on the purchase of the second product.

Clause 16. The system of clause 15, wherein an object associated with the first product is used to associate the first product with the first buyer and the object comprises one of a near field communication tag and a graphical object.

Clause 17. The system of clause 16 or any previous clause, wherein the second buyer receives the object onto the second buyer device by optically scanning the object, receives a communication having the object, or receives stored data from the object when the object comprises a near field communication tag.

Clause 18. A method comprising: receiving, from a mobile device and over a wireless link with a point-of-sale device, payment data associated with a transaction for a first buyer to pay for a new product from a merchant; identifying discount data for the transaction, the discount data existing based on the first buyer (1) previously purchasing a first product from the merchant and (2) a second buyer buying a second product based on a connection between the first product and the first buyer being stored in a database; applying the discount data to the transaction to generate a remainder amount for the transaction to purchase the new product; and processing a payment of the remainder amount, if any, using the payment data.

Clause 19. The method of clause 18, wherein a graphical object is configured on the first product to establish the connection between the first product and the first buyer.

Clause 20. The method of clause 19 or any previous clause, wherein the second buyer buys the second product based on scanning the graphical object to purchase the second product and to generate the discount data for the transaction.

What is claimed is:

1. A method comprising:
identifying a first product being purchased by a first buyer;
storing an association of the first product and the first buyer in a database;
receiving an identification of the first product from a second buyer device;
processing a purchase of a second product by a second buyer based on the identification; and
providing a benefit to the first buyer based on the purchase of the second product.

2. The method of claim 1, wherein the association of the first product and the first buyer is performed via use of a graphical object associated with the first product.

3. The method of claim 2, wherein the graphical object is transmitted to a first buyer device for storage and later scanning.

4. The method of claim 1, further comprising:
recording on a blockchain network data confirming the association of the first product and the first buyer.

5. The method of claim 1, further comprising:
printing, at a point-of-sale, a physical object showing a graphical object that associates the first buyer and the first product.

6. The method of claim 1, wherein the identification of the first product from the second buyer device occurs via the second buyer device scanning a graphical object on the first product by a camera on the second buyer device.

7. The method of claim 6, further comprising:
accessing a purchasing service based on the second buyer has scanning the graphical object onto the second buyer device, wherein a purchasing service retrieves the association of the first product, the first buyer and the graphical object in the database to identify the second product and to identify the first buyer to provide the benefit to the first buyer.

8. The method of claim 6, wherein the identification of the first product from the second buyer device occurs via one or more of receiving a scan of the graphical object physically from the first product, receiving a scan of the graphical object from a display of a first buyer device, receiving a communication at the second buyer device from the first buyer device, or receiving a scan of the graphical object from a social media posting of the first buyer.

9. The method of claim 8, wherein the communication comprises a message, a voicemail or email.

10. A method comprising:
generating a group of products wherein a respective product in the group of products is made with a respective graphical object unique to the respective product;
at a purchase of the respective product, identifying a first buyer and the respective graphical object and storing data in a database associating the first buyer and the respective graphical object;
receiving an identification of the respective graphical object from a second buyer device associated with a second buyer;
accessing, based on the identification of the respective graphical object from the second buyer device, the data to identify the respective product and the first buyer;
processing a sale of a second product associated with the respective product to the second buyer; and
automatically providing a benefit to the first buyer based on the sale of the second product.

11. The method of claim 10, wherein the respective product is a respective physical product and wherein the respective graphical object is a respective physical graphical object either on the respective physical product or on a packaging or box associated with the respective physical product.

12. The method of claim 10, wherein the benefit comprises one or more of money, a discount, a coupon, a gift, a registration, access to a venue.

13. The method of claim 10, wherein receiving the identification of the respective graphical object from the second buyer device associated with the second buyer comprises receiving a scan of the respective graphical object from the second buyer device.

14. The method of claim 10, wherein the respective graphical object includes information enabling the second buyer device to access a network-based purchasing service to enable the sale of the second product.

15. A system comprising:
a processor; and
a computer-readable memory storing instructions which, when executed by the processor, cause the processor to be configured to:
identify a first product being purchased by a first buyer;
store an association of the first product and the first buyer in a database;
receive an identification of the first product from a second buyer device;
process a purchase of a second product by a second buyer based on the identification; and
provide a benefit to the first buyer based on the purchase of the second product.

16. The system of claim 15, wherein an object associated with the first product is used to associate the first product with the first buyer and the object comprises one of a near field communication tag and a graphical object.

17. The system of claim 16, wherein the second buyer receives the object onto the second buyer device by optically scanning the object, receives a communication having the object, or receives stored data from the object when the object comprises a near field communication tag.

18. A method comprising:
receiving, from a mobile device and over a wireless link with a point-of-sale device, payment data associated with a transaction for a first buyer to pay for a new product from a merchant;
identifying discount data for the transaction, the discount data existing based on the first buyer (1) previously purchasing a first product from the merchant and (2) a second buyer buying a second product based on a connection between the first product and the first buyer being stored in a database;
applying the discount data to the transaction to generate a remainder amount for the transaction to purchase the new product; and
processing a payment of the remainder amount, if any, using the payment data.

19. The method of claim 18, wherein a graphical object is configured on the first product to establish the connection between the first product and the first buyer.

20. The method of claim 19, wherein the second buyer buys the second product based on scanning the graphical object to purchase the second product and to generate the discount data for the transaction.
